(19) United States
(12) Patent Application Publication
(10) Pub. No.: US 2019/0025656 A1
(43) Pub. Date: Jan. 24, 2019

(54) LIQUID CRYSTAL DISPLAY ELEMENT AND METHOD FOR PRODUCING SAME

(71) Applicant: DIC Corporation, Tokyo (JP)

(72) Inventors: Masanao Hayashi, Kita-adachi-gun (JP); Kenta Shimizu, Kita-adachi-gun (JP); Tetsuo Kusumoto, Kita-adachi-gun (JP); Yasuhiro Kuwana, Kita-adachi-gun (JP)

(73) Assignee: DIC Corporation, Tokyo (JP)

(21) Appl. No.: 16/068,774

(22) PCT Filed: Apr. 12, 2016
(86) PCT No.: PCT/JP2016/061794

§ 371 Date: Jul. 9, 2018

(30) Foreign Application Priority Data
Feb. 2, 2016 (JP) 2016-017949

(51) Int. Cl. G02F 1/1337; C09K 19/56; C09K 19/54; C09K 19/30; C09K 19/32; G02F 1/137; G02F 1/1341

(52) U.S. Cl. CPC G02F 1/133723; G02F 2001/13415; C09K 19/542; C09K 19/3066; C09K 19/322; C09K 19/3003; G02F 1/137; G02F 1/133788; G02F 1/133753; G02F 1/1341; C09K 2019/548; C09K 2019/3004; C09K 2019/3009; C09K 2019/301; C09K 2019/3016; G02F 2001/13775; G02F 2001/133726; G02F 2001/133761; G02F 2001/133742; C09K 19/56

(57) ABSTRACT

The invention provides a liquid crystal display element hardly generating drop marks at the time of producing, and having high reliability and improved properties of a liquid crystal display element such as dielectric anisotropy, viscosity, a nematic phase upper limit temperature, or rotational viscosity (γ₁) without deteriorating the properties of the liquid crystal display element and burn-in properties of the liquid crystal display element, and a method for producing the same. In addition, according to the invention, it is possible to effectively use the liquid crystal display element as a display element of a liquid crystal TV, a monitor, and the like, due to excellent high-response speed, a low frequency of occurrence of burn-in, a low frequency of generation of drop marks at the time of the producing, excellent properties of the liquid crystal display element, and high reliability.

### TECHNICAL FIELD

The present invention relates to a liquid crystal display element useful as a constituent, member of a liquid crystal TV or the like and a method for producing the same.

### BACKGROUND ART

Liquid crystal display elements are generally used in timepieces, calculators, various measurement devices, panels for a vehicle, word processors, electronic notebooks, printers, computers, televisions, timepieces, advertisement display boards, and the like. As representative liquid crystal display systems, a twisted nematic (TN) type liquid crystal display system, a super-twisted nematic (STN) type liquid crystal display system, a vertical alignment (VA) or an in-plane switching (IPS) type liquid crystal display system using a thin-film transistor (TFT) is used. It is necessary that a liquid crystal composition used in these liquid crystal display elements is stable against external reasons such as moisture, air, heat, or light, shows a liquid crystal phase in a wide temperature range as much as, in a case where room temperature is set as a reference, has low viscosity and a low driving voltage. In addition, the liquid crystal composition is configured with several or several tens of kinds of compounds, in order to obtain optimal values of refractive index anisotropy (Δε) and dielectric anisotropy (Δn) for each liquid crystal display element.

A liquid crystal composition having a negative Δε is used in VA type display and is widely used in a liquid crystal TV or the like. Meanwhile, in every driving system, low voltage driving, rapid response, and a wide operation temperature range are required. That is, it is necessary that an absolute value of Δε is great, viscosity (η) is small, and a high nematic phase-isotropic liquid phase transition temperature (Tₙᵢ) are obtained. In addition, it is necessary to adjust Δn of the liquid crystal composition in an optimal range in accordance with a cell gap, based on the setting of Δnxd which is a sum of Δn and a gap (d). Further, in a case of applying the liquid crystal display element to a television or the like, rapid responsibility is considered as an important condition, and thus, a liquid crystal composition having low rotational viscosity (γ₁) is necessary.

Meanwhile, in order to improve viewing angle properties of the VA type display, a multi-domain vertical alignment (MVA) type liquid crystal display element in which the direction of alignment of liquid crystal, molecules in a pixel is divided into plural directions fay providing a projection structure on a substrate is widely used. The MVA type liquid crystal display element has excellent viewing angle properties. But, response speeds of liquid crystal molecules in the vicinity of the projection structure on the substrate and in a portion separated from the vicinity thereof are different from each other, and accordingly, the response speed is generally insufficient due to an effect of a liquid crystal molecule separated from the projection structure having a low response speed. Thus, a problem regarding a decrease in transmittance due to the projection structure has occurred. In order to solve this problem, as a liquid crystal display element which is different from the typical MVA type liquid crystal display element and using a method for applying a uniform pretilt angle to divided pixels, without providing a non-transmitting projection structure in a cell, a PSA liquid crystal display element (polymer sustained alignment: including polymer maintaining alignment and PS liquid crystal display element (a polymer stabilized)) liquid crystal display element has been developed. The PSA liquid crystal display element is manufactured by adding a small amount of reactive monomer to a liquid crystal composition, introducing the liquid crystal composition to a liquid crystal cell, and irradiating the liquid crystal composition with an active energy ray while applying a voltage between electrodes, to polymerize the reactive monomer in the liquid crystal composition. Accordingly, it is possible to apply a suitable pretilt angle to the divided pixels, thereby achieving rapid responsibility due to the improvement of a contrast and applying of a uniform pretilt angle due to improvement of transmittance (for example, see PTL 1). However, in the PSA liquid crystal display element, it is necessary to add the reactive monomer in the liquid crystal composition. Accordingly, a number of problems have occurred in an active matrix liquid crystal display element in which a high voltage holding ratio is necessary, and a display defect such as burn-in also has occurred.

As a method for improving the defects of the PSA liquid crystal display element and applying a uniform pretilt angle to liquid crystal molecules without mixing a foreign material other than liquid crystal materials in the liquid crystal composition, a method for mixing a reactive monomer into an alignment film material, introducing the liquid crystal composition to a liquid crystal cell, and irradiating the liquid crystal composition with an active energy ray while applying a voltage between electrodes, to polymerize the reactive monomer in the alignment film has been developed (for example, see PTLs 2, 3, and 4).

Meanwhile, in accordance with enlargement of a screen of the liquid crystal display element, a great change has been achieved in a method for producing a liquid crystal display element. That is, a vacuum injection method of the related art requires a long period of time in a producing process, in a case of manufacturing a large-sized panel. Accordingly, in the producing of a large-sized panel, a producing method using a one-drop-fill (ODF) method has become the mainstream (for example, see PTL 5). This method can shorten an injection time, compared to that in the vacuum injection method, and thus, the method has become the mainstream method of the method for producing a liquid crystal display element. However, a phenomenon in which drop marks caused due to the drop of the liquid crystal composition remain in the liquid crystal display element in the dropped shape, even after producing the liquid crystal display element has become a new problem. The drop marks are defined as a phenomenon in which marks of the drop of the liquid crystal composition come to the surface in white, in a case of performing display in black. Particularly, in the method for applying the reactive monomer into the alignment film material and applying a pretilt angle to the liquid crystal molecules described above, the reactive monomer which is a foreign material, at the time of dropping the liquid crystal composition to the substrate, is present in the alignment film, and accordingly, the problem regarding the drop marks easily occurs. In addition, the generation of the drop marks generally occurs due to the selection of liquid crystal materials, in many cases, and the reason thereof is not clear.

As a method for preventing the drop marks, a method for polymerizing a polymerizable compound mixed in a liquid crystal composition, and forming a polymer layer in a liquid crystal composition layer, to prevent drop marks generated due to a relationship with an alignment control film has been disclosed (for example, see PTL 6). However, in a case of only using this method, a problem regarding burn-in of display due to the reactive monomer added into the liquid crystal composition occurs, in the same manner as in the PSA method or the like, and an effect of preventing the drop marks is also insufficient. Thus, it has been demanded to develop a liquid crystal display element which hardly causes occurrence of burn-in or drop marks while maintaining basic properties of the liquid crystal display element. In addition, the liquid crystal display element is exposed to a UV light during the producing or usage thereof, and thus, it is important not to cause a deterioration or the like or affect the display, even in a case where a deterioration has occurred, due to the UV irradiation.

Therefore, the inventors have proposed a liquid crystal display element obtained by combining specific liquid crystal compositions, in a method for causing a vertical alignment film to include a reactive monomer, introducing a liquid crystal composition to a liquid crystal cell, and irradiating the liquid crystal composition with an active energy ray while applying a voltage between electrodes, to polymerize the reactive monomer in the alignment film, in PTL 12 or the like. By using this liquid crystal display element, it is possible to provide a liquid crystal display element which hardly causes drop marks at the time of the producing, without deteriorating various properties of the liquid crystal display element such as refractive index anisotropy, viscosity, a nematic phase upper limit, temperature, and rotational viscosity (γ₁), and burn-in properties of the liquid crystal display element, and a method for producing the same. However, due to the advancement of the requirements with respect, to the liquid crystal display element, further improvement of the properties of the liquid crystal display element, particularly, development of a liquid crystal composition and a liquid crystal display element, having higher reliability has been required.

### CITATION LIST

### Patent Literature

[PTL 1] JP-A-2002-357830

[PTL 2] JP-A-2010-107536

[PTL 3] US2011/261295

[PTL 4] JP-A-2011-227284

[PTL 5] JP-A-H6-235925

[PTL 6] JP-A-2006-58755

[PTL 7] JP-A-2011-95696

[PTL 8] JP-A-2011-95697

[PTL 9] JP-A-2009-139455

[PTL 10] JP-A-2010-32860

[PTL 11] JP-A-2010-107537

[PTL 12] Japanese Patent No. 05299595

### SUMMARY OF INVENTION

### Technical Problem

The invention is made in consideration of the above-mentioned circumstances and an object thereof is to provide a liquid crystal display element which does not deteriorate various properties of a liquid crystal display element such as refractive index anisotropy, viscosity, a nematic phase upper limit temperature, and rotational viscosity (γ₁), and burn-in properties of the liquid crystal display element, hardly causes drop marks generated at the time of the producing, and has high values of the properties of the liquid crystal display element and high reliability, and a method for producing the same.

### Solution to Problem

In order to solve the problems described above, the inventors have made studies regarding various liquid crystal compositions, found that the problems can be solved by including a specific polymerizable compound, and completed the invention.

That is, according to an aspect of the invention, there is provided a liquid crystal display element including: a first substrate; a second substrate; and a liquid crystal composition layer sandwiched between the first substrate and the second substrate, in which at least one of the first substrate and the second substrate is provided with an electrode, at least one of the first substrate and the second substrate is provided with an alignment film including a polymer of a compound having a polymerizable group which controls a direction of alignment of a liquid crystal molecule in the liquid crystal composition layer, a liquid crystal composition constituting the liquid crystal composition layer includes one or more compounds selected from a group of compounds represented by General Formula (N-1), General Formula (N-2), and General Formula (N-3),

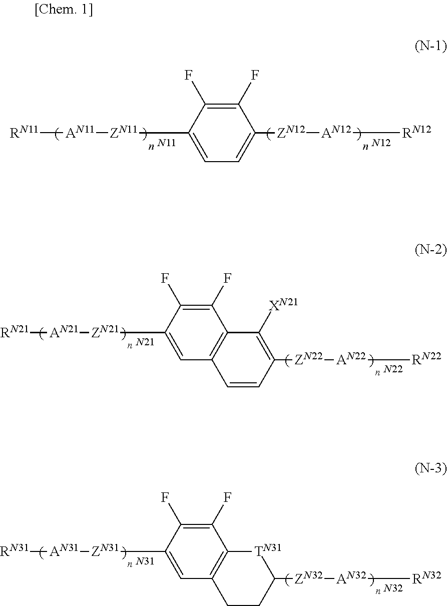

(In the formulae, R^{N11}, R^{N12}, R^{N21}, R^{N22}, R^{N31}, and R^{N32} each independently represent an alkyl group having 1 to 8 carbon atoms, one —CH₂— or two or more —CH₂—'s not adjacent to each other in the alkyl group each may be independently substituted with —CH═CH—, —C≡C—, —O—, —CO—, —COO—, or —OCO—, A^{N11}, A^{N12}, A^{N21}, A^{N22}, A^{N31} and A^{N32} each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), the group (a), the group (b), and the group (c) each may be independently substituted with a cyano group, a fluorine atom, or a chlorine atom, Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—, X^{N21} represents a hydrogen atom or a fluorine atom, T^{N31} represents —CH₂— or —O—, n^{N11}, n^{N12}, n^{N21}, n^{N22}, n^{N31}, and n^{N32} each independently represent an integer of 0 to 3 , n^{N11}+n^{N12}, n^{N21}+n^{N22}, and n^{N31}+n^{N32} are each independently 1, 2, or 3, and, in a case where a plurality of A^{N11}'s to A^{N32}'s and Z^{N11}'s to Z^{N32}'s are present, these may be the same or different), and the compound having the polymerizable group includes one or more compounds represented by General Formula (I),

[Chem. 2]

P¹-Sp¹B¹—Z¹ᵣ₁B²—Z²—B³Sp²-P²)ₙ₁ (I)

(In the formula, P¹ and P² each independently represent, a polymerizable functional group, Sp¹ and Sp² each independently represent a single bond or an alkylene group having 1 to 18 carbon atoms, a hydrogen atom in the alkylene group may be substituted with one or more halogen atoms or a CN group, one —CH₂— or two or more —CH₂—'s not adjacent to each other present in the alkylene group each may be independently substituted with —O—, —COO—, —OCO—, or —OCO—O—, P¹-Sp¹ and Sp²-P² do not include a —O—O— group, n1 represents 1, 2, or 3, in a case where a plurality of Sp²'s and P²'s are present, these may be the same or different, B¹, B², and B³ each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), hydrogen atoms present in the group (a), the group (b), and the group (c) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or Sp²-P², Z¹ and Z² each independently represent —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, —O(CH₂)ₘO—, an alkylene group having 2 to 10 carbon atoms which may include a halogen atom, or a single bond, m represents an integer of 1 to 8, r1 represents 1, 2, or 3, and in a case where a plurality of B¹'s and Z¹'s are present, these may be the same or different).

According to another aspect of the invention, there is provided a method for producing a liquid crystal display element, the method including: applying an alignment material to at least one of a first substrate and a second substrate to form an alignment film material; then sandwiching a liquid crystal composition between the first substrate and the second substrate, at least one of which is provided with an electrode; and applying an active energy ray with a voltage being applied to the electrode to polymerize a polymerizable group of a compound having a polymerizable group contained in the alignment film material so that an alignment film which controls a direction of alignment of a liquid crystal molecule in a layer of the liquid crystal composition is obtained, in which the liquid crystal composition includes one or more compounds selected from a group of compounds represented by General Formula (N-1), General Formula (N-2), and General Formula (N-3), and the compound having the polymerizable group includes one or more compounds represented by General Formula (I).

### Advantageous Effects of Invention

According to the invention, it is possible to effectively use the liquid crystal display element, as a display element of a liquid crystal TV, a monitor, or the like, due to excellent rapid response of a liquid crystal display element, a low occurrence frequency of burn-in, a low occurrence frequency of drop marks at the time of producing thereof, excellent properties of a liquid crystal display element, and reliability.

In addition, according to the invention, it is possible to produce an efficient liquid crystal display element in which drop marks are hardly generated.

### BRIEF DESCRIPTION OF DRAWINGS

FIG. 1 is a schematic perspective view showing one embodiment of a liquid crystal display element of the invention.

FIG. 2 is a schematic plan view showing an example of a slit electrode (comb-shaped electrode) used in the liquid crystal display element of the invention.

FIG. 3 is a view showing a definition of a pretilt angle of the liquid crystal display element of the invention.

### DESCRIPTION OF EMBODIMENTS

Embodiments of a liquid crystal display element and a method for producing the same of the invention will be described.

The embodiments are specifically described for easier understanding of a gist of the invention and the invention is not limited thereto, unless otherwise noted.

[Liquid Crystal Display Element]

A liquid crystal display element of the invention is a liquid crystal display element including a liquid crystal composition layer sandwiched between one pair of substrates, and is operated based on a principle of applying a voltage to a liquid crystal composition layer to cause Freedericksz transition or liquid crystal molecules in the liquid crystal composition layer and using the liquid crystal display element as an optical switch. In this viewpoint, a well-known typical technology can be used.

In a normal vertical alignment liquid crystal display element in which two substrates have an electrode for Freedericksz transition of the liquid crystal molecules, a method for vertically applying a charge between the two substrates is generally used. In this case, one electrode is a common electrode and the other electrode is a pixel electrode. Hereinafter, the most typical embodiment of this method is shown.

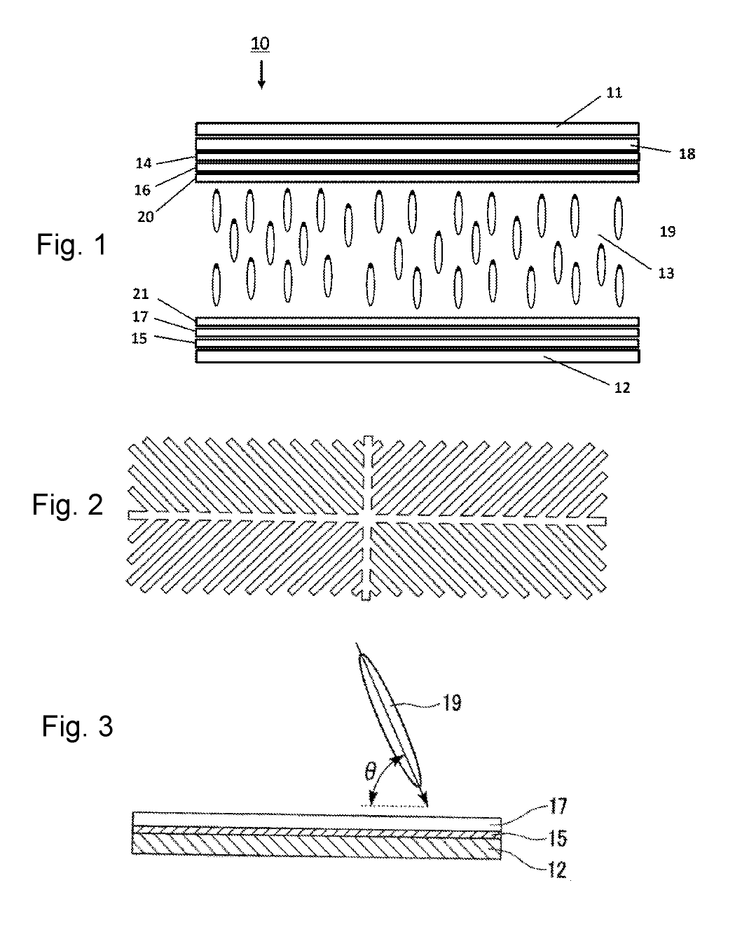

FIG. 1 is a schematic perspective view showing one embodiment of a liquid crystal display element of the invention.

A liquid crystal display element 10 of the embodiment is schematically configured with, a first substrate 11, a second substrate 12, a liquid crystal composition layer 13 which is sandwiched between the first substrate 11 and the second substrate 12, a common electrode 14 which is provided on a surface of the first substrate 11 facing the liquid crystal composition layer 13, a pixel electrode 15 which is provided on a surface of the second substrate 12 facing the liquid crystal composition layer 13, a vertical alignment film 16 which is provided on a surface of the common electrode 14 facing the liquid crystal composition layer 13, a vertical alignment film 17 which is provided on a surface of the pixel electrode 15 facing the liquid crystal composition layer 13, and, if necessary, a polymer layer 20 which is formed on the vertical alignment film 16, a polymer layer 21 which is formed on the vertical alignment film 17, and a color filter 18 which is provided between the first substrate 11 and the common electrode 14.

As the first substrate 11 and the second substrate 12, a glass substrate or a plastic substrate is used.

As a plastic substrate, a substrate formed of a resin such as an acrylic resin, a methacryl resin, polyethylene terephthalate, polycarbonate, or a cyclic olefin resin is used.

The common electrode 14 is generally configured with a material having transparency such as indium-doped tin oxide (ITO).

The pixel electrode 15 is generally configured with a material having transparency such as indium-doped tin oxide (ITO).

The pixel electrode 15 is arranged on the second substrates 12 in matrix. The pixel electrode 15 is controlled by a drain electrode of an active element represented by a TFT switching element, and the TFT switching element includes a gate line which is an address signal line and a source line which is a data line in matrix. Here, the configuration of the TFT switching element is not shown in the drawing.

In a case of performing the pixel dividing of dividing directions of tilt of a liquid crystal molecule in a pixel into several regions, in order to improve viewing angle properties, a pixel electrode including slits (portion where the electrode is not formed) having a stripe-shaped or V-shaped pattern may be provided in each pixel.

FIG. 2 is a schematic plan view showing a typical aspect of a slit electrode (comb-shaped electrode) used in a case of dividing the pixel into four regions. This slit electrode includes slits in a shape of a teeth of comb in four directions from the center of a pixel, and accordingly, the liquid crystal molecule in each pixel approximately vertically aligned with respect to the substrate, in a case where a voltage is not applied, faces a director of the liquid crystal molecule in four different directions in accordance with the applying of a voltage and approaches to homogeneous alignment. As a result, the direction of alignment of the liquid crystal in the pixel can be divided into a plurality of directions, and thus, wide viewing angle properties are obtained.

As a method for performing the pixel dividing, a method for providing a structure such as a linear protrusion in a pixel, a method for providing an electrode other than the pixel electrode or the common electrode, or the like is used, in addition to the method for providing slits in the pixel electrode. With these methods, it is possible to divide the direction of alignment, of the liquid crystal molecule, and it is also preferable to use the configuration using the slit electrode, from viewpoints of transmittance and ease of producing. The pixel electrode provided with the slits does not have a driving force with respect to the liquid crystal molecule, in a state where a voltage is not applied, and thus, it is not possible to apply a pretilt angle to the liquid crystal molecule. However, by using the alignment film material used in the invention in combination, it is possible to apply a pretilt angle and to configure a wide viewing angle due to the pixel dividing, by combining with the pixel-divided slit electrode.

In the invention, to have a pretilt angle is referred to as a state where a director of the liquid crystal molecule is slightly different from the vertical direction with respect to substrate surfaces (surfaces of the first substrate 11 and the second substrate 12 adjacent to the liquid crystal composition layer 13), in a state where a voltage is not applied.

(Alignment Film)

The liquid crystal display element of the invention is a vertical alignment (VA) type liquid crystal display element, and thus, a director of the liquid crystal molecule is approximately vertically aligned with respect to the substrate surfaces, in a case where a voltage is not applied. For the vertical alignment of the liquid crystal molecule, a (vertical) alignment film is generally used. As a material forming the vertical alignment film (vertical alignment film material), polyimide, polyamide, polysiloxane, a cured material of a polymerizable liquid crystal compound, or the like is used.

In a case of using polyimide as the alignment film material forming the vertical alignment film, a polyimide solution obtained by dissolving or dispersing a mixture of tetracarboxylic acid dianhydride and diisocyanate, polyamic acid, or a polyimide in a solvent is preferably used, and in this case, a content of polyimide in the polyimide solution is preferably 1% by mass to 10% by mass, more preferably 3% by mass to 5% by mass, and even more preferably equal to or smaller than 10% by mass.

In a case of using a polysiloxane-based material as the alignment film material forming the vertical alignment film, a polysiloxane solution obtained by dissolving polysiloxane prepared by mixing a silicon compound having an alkoxy group, an alcohol derivative, and an oxalic acid derivative with each other at a predetermined blending amount ratio and heating the mixture, can be used.

In the liquid crystal display element of the invention, the vertical alignment films 16 and 17 formed of polyimide and the like include a polymer formed by polymerization of a polymerizable compound having a polymerizable group. This polymerizable compound applies a function of fixing a pretilt angle of the liquid crystal molecule. That is, it is possible to tilt a director of the liquid crystal molecule in a pixel in a different direction at the time of applying a voltage, by using the slit electrode or the like. However, even with the configuration using the slit electrode, in a case where a voltage is not applied, the liquid crystal molecule is substantially vertically aligned with respect to the substrate surface and a pretilt angle is not generated, but in a state where a voltage is applied bet: ween the electrodes and the liquid crystal molecule is slightly tilted, a suitable pretilt angle is applied, by applying an ultraviolet light or the like and polymerizing a reactive monomer in the liquid crystal composition.

In addition, if necessary, the polymer layers 20 and 21 can be formed as polymers on the surfaces of the vertical alignment films 16 and 17, by sandwiching the polymerizable compound included in the liquid crystal composition between the substrates, curing the polymerizable compound while applying a voltage thereto, and causing phase separation of the polymerizable compound.

Due to the polymer included in the vertical alignment films 16 and 17 and the polymer layers 20 and 21 formed on the surfaces of the vertical alignment films 16 and 17, formed if necessary, alignment properties of the liquid crystal molecule are increased, a frequency of occurrence of burn-in is decreased, and a frequency of generation of drop marks at the time of the producing is decreased.

In the invention, the expression “approximately vertical” means a state where a director of a liquid crystal molecule, which is vertically aligned, is slightly tilted from the Vertical direction and a pretilt angle is applied. In a case of complete vertical alignment, the pretilt angle is 90°, and in a case of homogeneous alignment (horizontally aligned to the substrate surface), the pretilt angle is 0°, the pretilt angle in the approximately vertical state is preferably 89.5° to 85° and more preferably 89.5° to 87°.

The vertical alignment films 16 and 17 including a polymer of a polymerizable compound having a polymerizable group are formed due to an effect of the polymerizable compound mixed with the vertical alignment film material. Accordingly, it is assumed that the vertical alignment film and the polymerizable compound are complexly intertwined to form one kind of a polymer alloy, but an accurate structure thereof cannot be shown.

In addition, the polymer layers 20 and 21 formed, if necessary, are formed on the surface of the vertical alignment films 16 and 17, with the phase separation from the liquid crystal composition, in a case of the polymerization of the polymerizable compound included in the liquid crystal composition. It is thought that whether the polymer layer is evenly formed on the entire surface of the vertical alignment film or formed with an uneven sea-island structure depends on conditions for the producing, and an accurate structure thereof cannot, be shown. A case where the polymer layer is evenly formed is shown in FIG. 1.

It is necessary that the alignment film used in the invention has a vertical alignment section to align the liquid crystal molecule in the liquid crystal composition layer in a vertical direction to the surface substrate and an alignment control section to control the direction of alignment of the liquid crystal molecule. As a method of obtaining the alignment film having two functions of the vertical alignment section and the alignment control section, a method of mixing a polymerizable compound having a polymerizable group into an alignment film material normally used, a method of using a polymer of a polymerizable compound having a crosslinking functional group at a side chain portion as the alignment film material, or a method of using a cured material of a polymerizable liquid crystal compound is used. Hereinafter, each method will be described.

(Method of Mixing Polymerizable Compound Having a Polymerizable Group into Alignment Film Material)

As a method of mixing a polymerizable compound having a polymerizable group into an alignment film material, a method of mixing a polymerizable compound having a polymerizable group into the alignment film material described above is used.

The polymerizable compound having a polymerizable group included in the alignment film material may or may not include a mesogenic site, but it is necessary to include a compound represented by General Formula (I) as the compound having a polymerizable group. It is important to include one or more compound represented by

[Chem. 3]

P¹-Sp¹B¹—Z¹ᵣ₁B²—Z²—B³Sp²-P²)ₙ₁ (I)

(In the formula, P¹ and P² each independently represent a polymerizable functional group, Sp¹ and Sp² each independently represent a single bond or an alkylene group having 1 to 18 carbon atoms, a hydrogen atom in the alkylene group may be substituted with one or more halogen atoms or a CN group, one —CH₂— or two or more —CH₂—'s not adjacent to each other present in the alkylene group each may be independently substituted with —O—, —COO—, —OCO—, or —OCO—O—, P¹-Sp¹ and Sp²-P² do not include a —O—O— group, n1 represents 1, 2, or 3, in a case where a plurality of Sp²'s and P²'s are present, these may be the same or different, B¹, B², and B³ each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), hydrogen atoms present in the group (a), the group (b), and the group (c) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy having 2 to 8 carbon atoms, or Sp¹-P², Z¹ and Z² each independently represent —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, —O(CH₂)ₘO—, an alkylene group having 2 to 10 carbon atoms which may include a halogen atom, or a single bond, m represents an integer of 1 to 8, r1 represents 1, 2, or 3, and in a case where a plurality of B¹'s and Z¹'s are present, these may be the same or different).

In General Formula (1), P¹ and P² each independently represent a polymerizable functional group, and each preferably independently represent a substituent selected from polymerizable groups represented by Formula (P-2-1) to Formula (P-2-20).

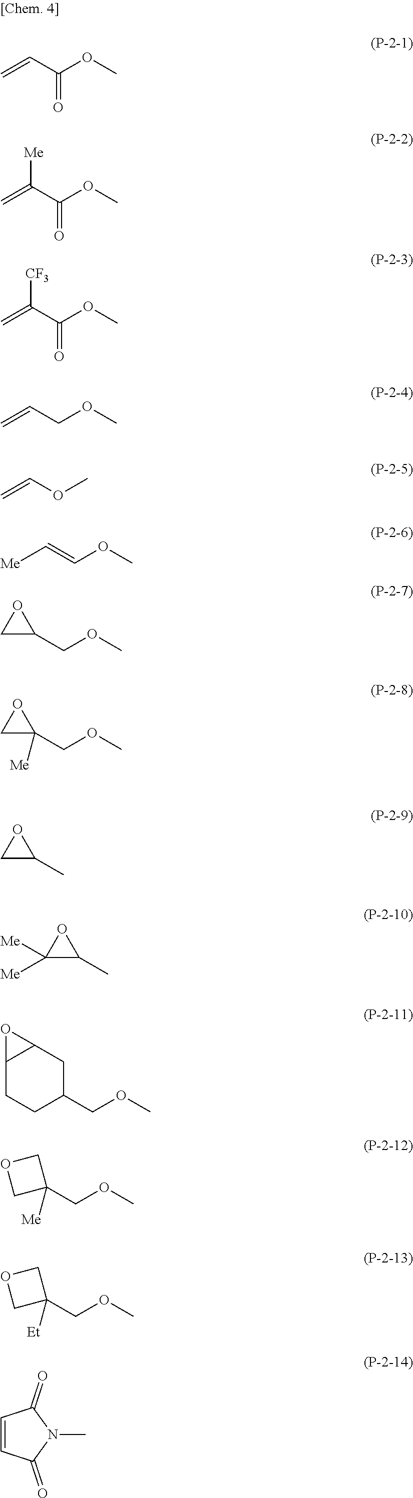

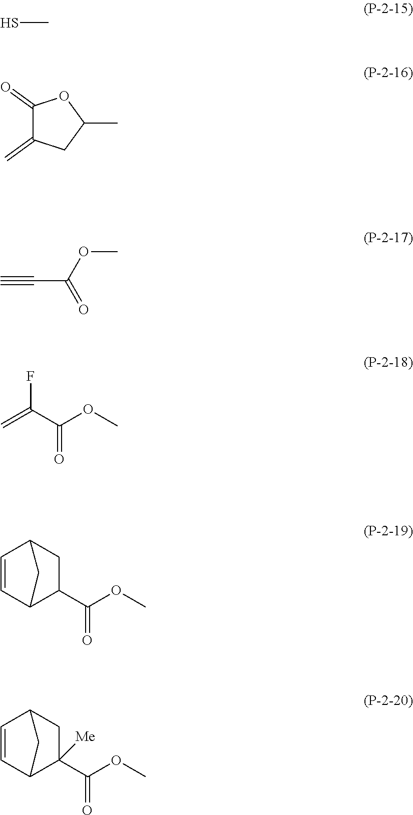

Among these polymerizable functional groups, from a viewpoint of increasing polymerization properties, Formulae (P-2-1), (P-2-2), (P-2-7), (P-2-12), and (P-2-13) are preferable, and Formulae (P-2-1) and (P-2-2) are more preferable.

In General Formula (I), Sp¹ and Sp² each independently represent a single bond or an alkylene group having 1 to 18 carbon atoms. A hydrogen atom in the alkylene group may be substituted with one or more halogen atoms or a CN group, and one —CH₂— or two or more —CH₂—'s not adjacent to each other present, in the alkylene group each may be independently substituted with —O—, —COO—, —OCO—, or —OCO—O—. Among these, Sp¹ and Sp² each are independently preferably a single bond or an alkylene group having 1 to 12 carbon atoms, in which one —CH₂— or two or more —CH₂—'s, not adjacent to each other, each may be independently substituted with —O—, —COO—, —OCO—, or —OCO—O—, more preferably a single bond or an alkylene group having 1 to 8 carbon atoms, in which one —CH₂— or two or more —CH₂—'s, not adjacent to each other, each may be independently substituted with —O—, —COO—, —OCO—, or —OCO—O—, and particularly preferably a single bond or an alkylene group having 1 to 6 carbon atoms, in which one —CH₂— or two or more —CH₂—'s, not adjacent to each other, each may be independently substituted with —O—, —COO—, or —OCO—.

In General Formula (I), n1 represents 1, 2, or 3. In a case where n1 represents 2 or 3 and a plurality of Sp²'s and P²'s are present, these may be the same or different. From a viewpoint of polymerization properties of the compound, n1 preferably represents 1 or 2 and n1 is particularly preferably 1.

In General Formula (I), P¹-Sp¹ and Sp²-P² do not include a —O—O— group.

In General Formula (I), B^{1,} B^{2,} and B³ each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), hydrogen atoms present in the group (a), the group (b), and the group (c) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or Sp²-P². From a viewpoint of heat resistance, a 1,4-phenylene group (wherein one-CH₂— or two or more —CH₂—'s not adjacent to each other present in this group may be substituted with —O—) and a naphthalene-2,6-diyl group are preferable, and from a viewpoint of solubility, it is preferable that B¹ and B² each independently are non-substitution or substituted with a fluorine atom, a chlorine atom, an alkyl group having 1 to 8 carbon atoms, and an alkoxy group having 1 to 8 carbon atoms, and it is more preferable that B³ is non-substitution or represents a 1,4-phenylene group (wherein one-CH═ or two or more —CH═'s not adjacent to each other present in this group may be substituted with —N═) in which a random hydrogen atom present is substituted with a fluorine atom or an alkoxy group having 1 to 8 carbon atoms, a 1,3,4-benzenetriyl group, a 1,3,5-benzenetriyl group, a 1,3,4,5-benzenetetrayl group, or a naphthalene-2,6-diyl group.

In General Formula (I), Z¹ and Z² each independently represent —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, —O(CH₂)ₘO—, an alkylene group having 2 to 10 carbon atoms which may include a halogen atom, or a single bond, and m represents an integer of 1 to 8. Among these, Z¹ and Z² each preferably independently represent —COO—, —OCO—, —OCH₂—, —O(CH₂)ₘO—, an alkylene group having 2 to 10 carbon atoms, or a single bond, more preferably independently represent —COO—, —OCO—, —O(CH₂)ₘ₁O—, an alkylene group having 2 to 10 carbon atoms, or a single bond. Here, m1 preferably represents an integer of 1 to 6 and m1 more preferably represents an integer of 1 to 4.

In General Formula (I), r1 represents 1, 2, or 3. In a case where r1 represents 2 or 3 and a plurality of B¹'s and Z¹'s are present, these may be the same or different. From viewpoints of reactivity or solubility with liquid crystals in a case of preparing a polymer and a viewpoint of heat resistance in a case of polyimide firing, r1 preferably represents 1 or 2, and a compound, in which r1 represents 1, is particularly preferably a compound represented by General Formula (I-A), from viewpoints of excellent solubility with a polyimide solution, alignment stability in a case of aligning liquid crystals, and reliability of a liquid crystal panel.

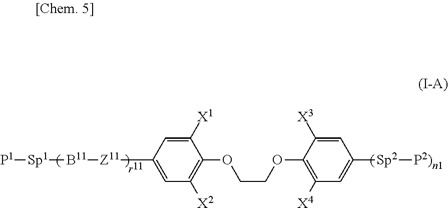

(In the formula, P¹ and P² each independently represent a polymerizable functional group, Sp¹ and Sp² each independently represent a single bond or an alkylene group having 1 to 18 carbon atoms, a hydrogen atom in the alkylene group may be substituted with one or more halogen atoms or a CN group, one —CH₂— group or two or more —CH₂—'s groups not adjacent to each other present in the alkylene group each may be independently substituted with —O—, —COO—, —OCO—, or —OCO—O—, P¹-Sp¹ and Sp²-P² do not include a —O—O— group, n1 represents 1, 2, or 3, in a case where a plurality of Sp²'s and P²'s are present, these may be the same or different, B¹¹ represents a group selected from the group consisting of (b1) a 1,4-phenylene group (wherein one-CH═ or two or more —CH═'s not adjacent to each other present in this group may be substituted with —N═) and (c1) a naphthalene-2,6-diyl group, hydrogen atoms present in the group (b1) and the group (c1) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or Sp²-P², X¹, X², X³, and X⁴ each independently represent a hydrogen atom, a fluorine atom, or a chlorine atom, at least two or more of X¹, X², X³, and X⁴ represent a component other than a hydrogen atom, Z¹¹ represents —COO—, —OCO—, —OCH₂—, —CH₂O—, —CH═CH—, —CH₂CH₂—, —C≡C—, —CH═CHCOO—, —OCOCH═CH—, —CH₂CH₂COO—, —CH₂CH₂OCO—, —COOCH₂CH₂—, —OCOCH₂CH₂—, —C(CF₃)₂—, —O(CH₂)ₘO—, an alkylene group having 2 to 10 carbon atoms which may include a halogen atom, or a single bond, m represents an integer of 1 to 8, r¹¹ represents 1, 2, or 3, and in a case where a plurality of B¹¹'s and Z¹¹'s are present, these may be the same or different.)

In General Formula (I-A), P¹ and P² each independently represent a polymerizable functional group, preferably a substituent selected from polymerizable groups represented by Formula (P-2-1) to Formula (P-2-20) shown in General Formula (I), and, from a viewpoint of increasing polymerization properties, Formulae (P-2-1), (P-2-2), (P-2-7), (P-2-12), and (P-2-13) are more preferable, and Formulae (P-2-1) and (P-2-2) are particularly preferable.

In General Formula (I-A), Sp¹ and Sp² each are preferably a single bond or an alkylene group having 1 to 12 carbon atoms, in which one —CH₂— or two or more —CH₂'s not adjacent to each other, each may be independently substituted with —O—, —COO—, —OCO—, or —OCO—O—, more preferably a single bond or an alkylene group having 1 to 8 carbon atoms, in which one —CH₂— or two or more —CH₂—'s not adjacent to each other may each be independently substituted with —O—, —COO—, —OCO—, or —OCO—O—, and particularly preferably a single bond or an alkylene group having 1 to 6 carbon atoms, in which one —CH₂— or two or more —CH₂—'s not adjacent to each other may each be independently substituted with —O—, —COO—, or —OCO—.

In General Formula (I-A), X¹, X², X³, and X⁴ each independently represent a hydrogen atom, a fluorine atom, or a chlorine atom, and at least two or more of X¹, X², X³, and X⁴ represent a component other than a hydrogen atom. Among these, it is preferable that both of X¹ and X² represent a fluorine atom and both of X³ and X⁴ represent a hydrogen atom, or both of X¹ and X² represent a hydrogen atom and both of X³ and X⁴ represent a fluorine atom.

In General Formula (I-A), Z¹¹ preferably represents —COO—, —OCO—, —OCH₂—, —CH₂O—, or a single bond, and Z¹¹ more preferably represents —COO—, —OCO—, or a single bond.

In General Formula (I-A), r¹¹ represents 1, 2, or 3, and r¹¹ preferably represents 1 or 2 and r¹¹ is more preferably 1.

Specifically, a compound represented by General Formula (I) is preferably compounds represented by General Formulae (I-1) to (I-29).

r n r> 1

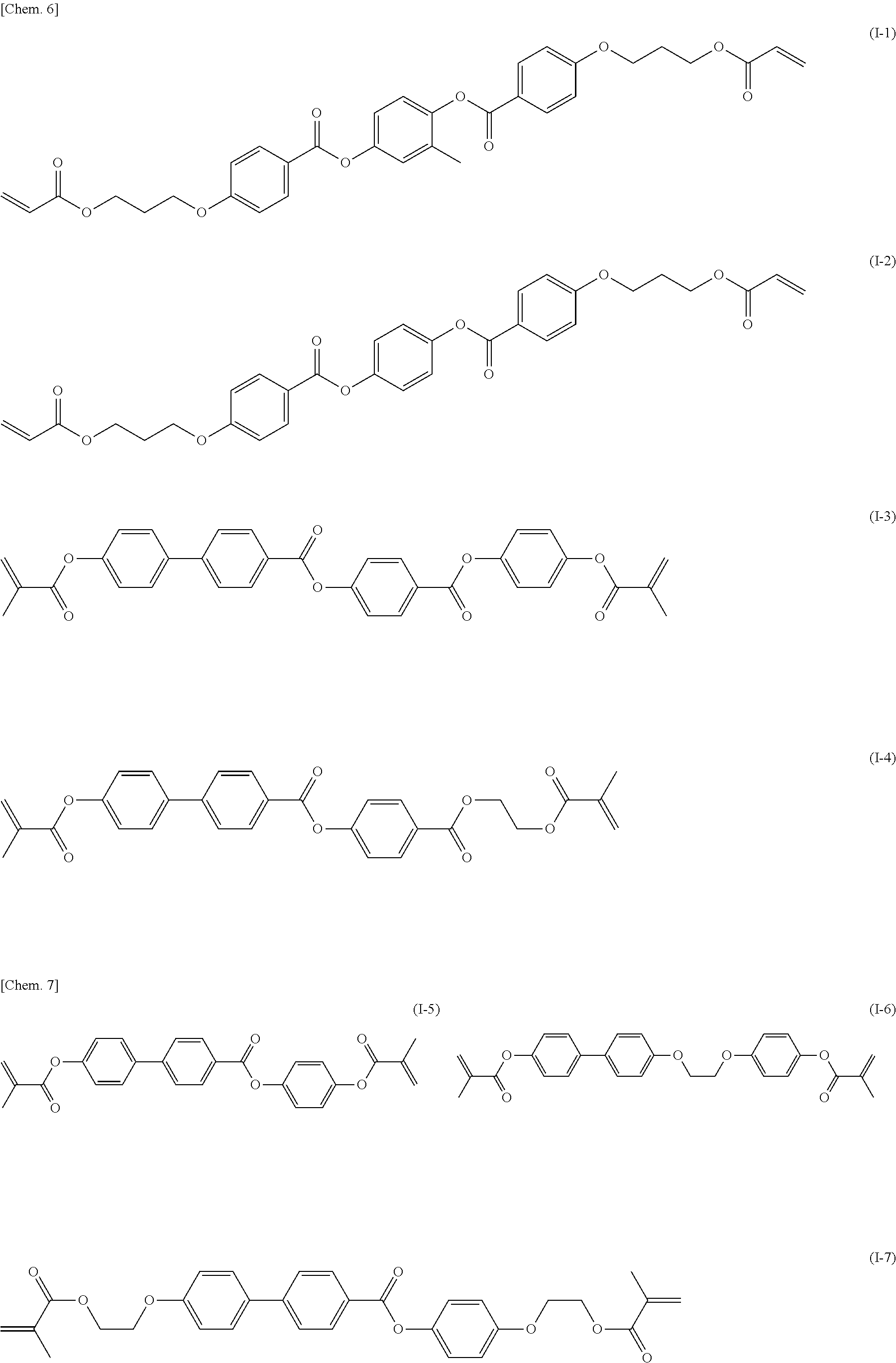

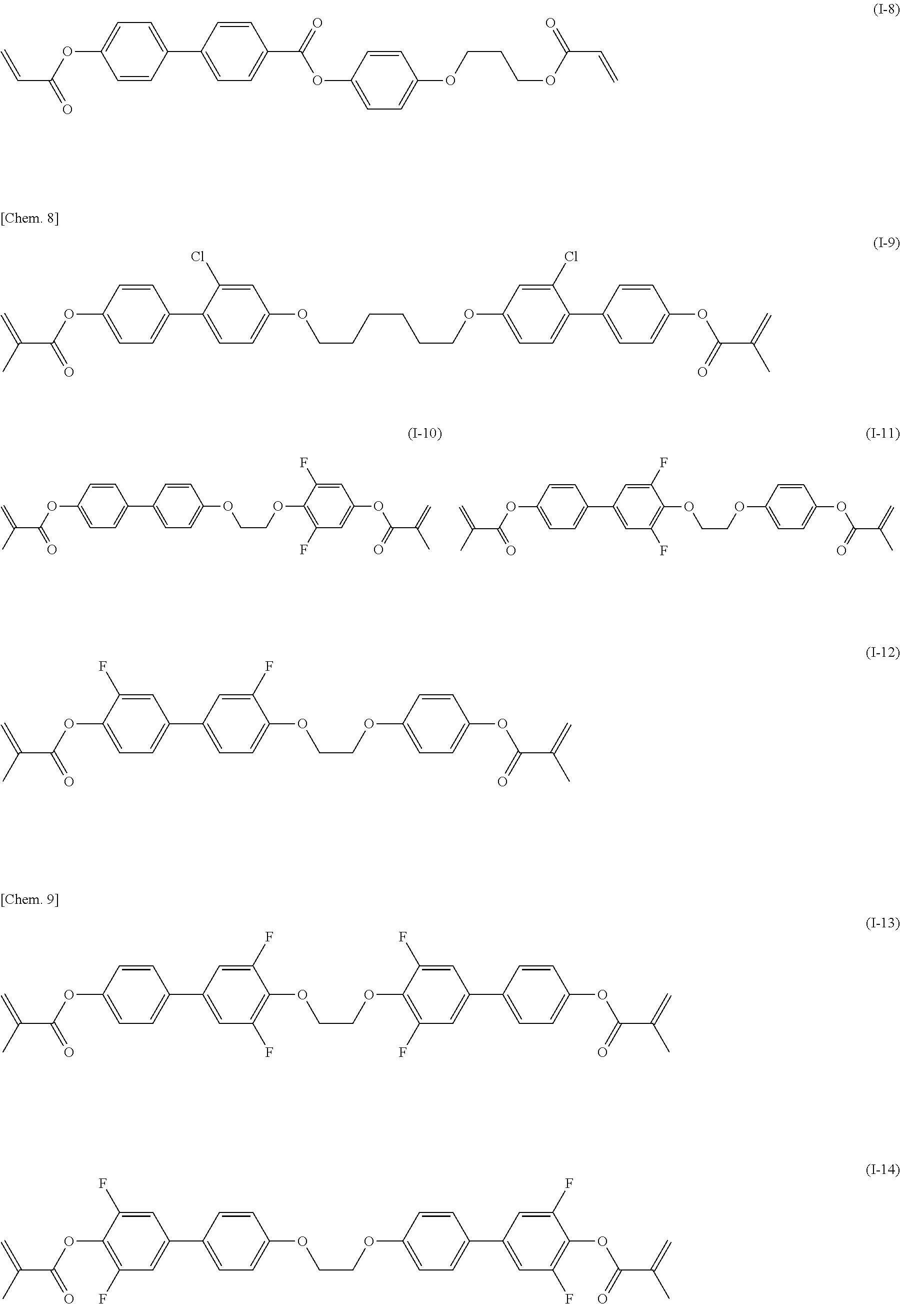

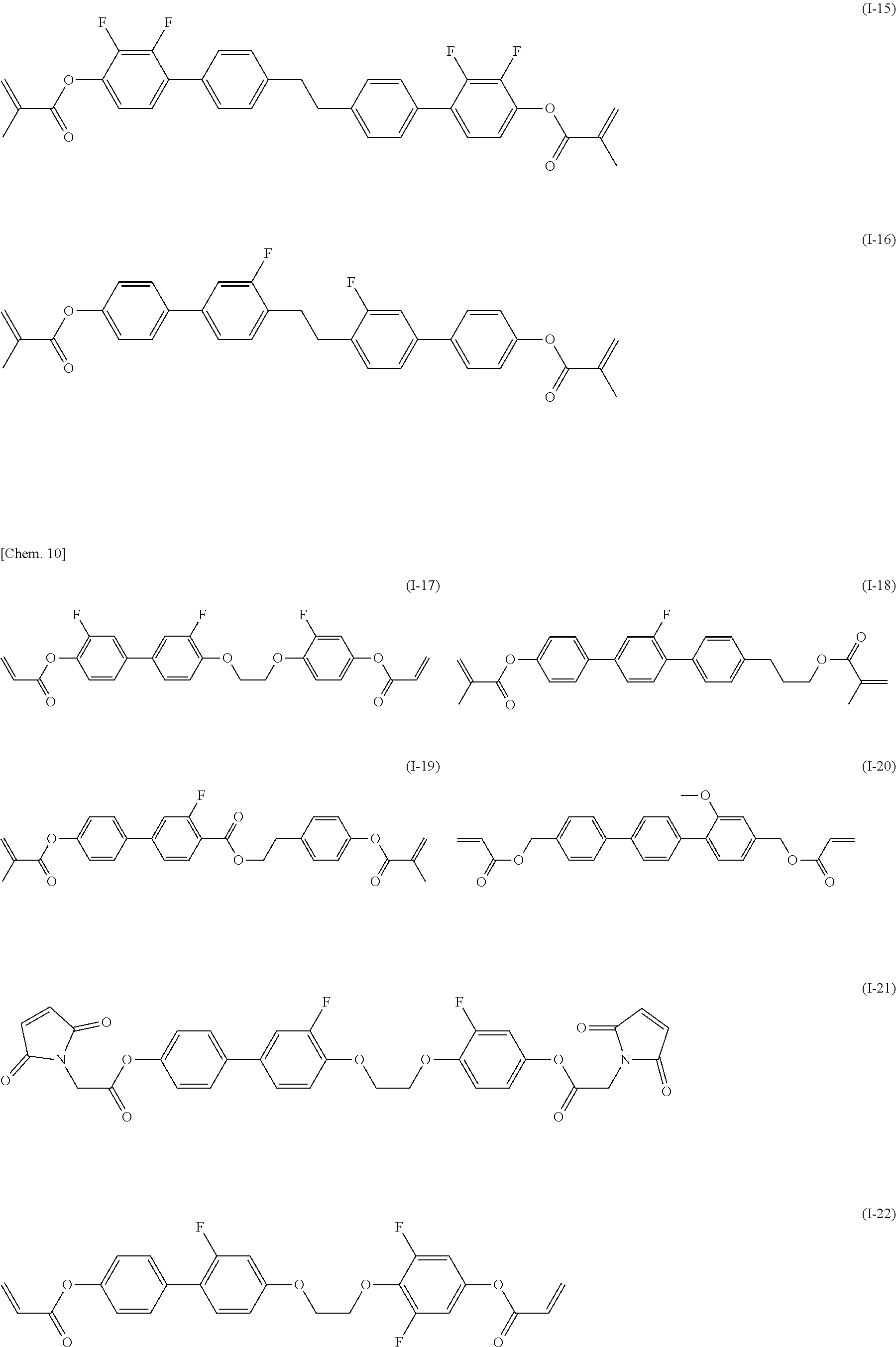

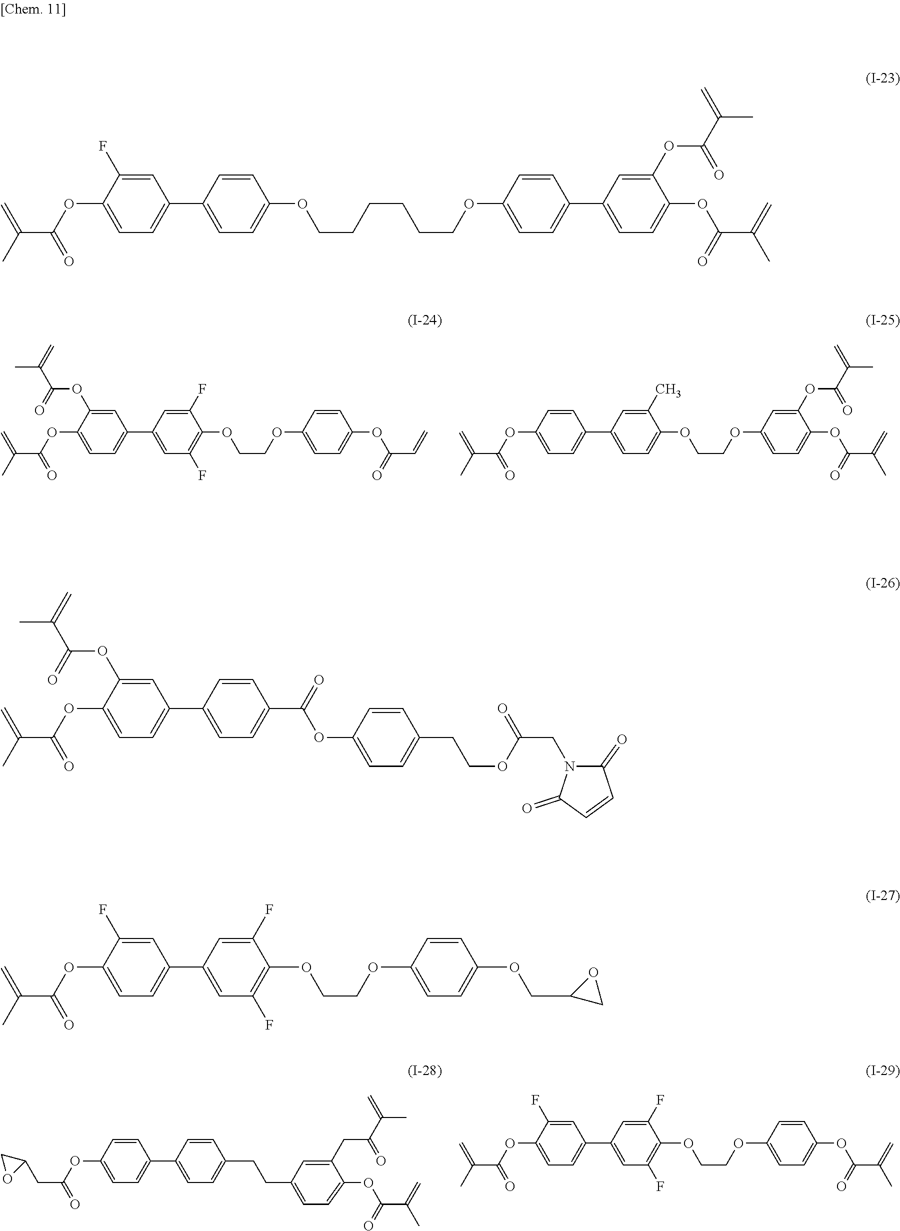

A content of the compound represented by General Formula (I) in a polymer compound precursor for forming the alignment film is preferably 0.1% to 25% by mass, more preferably 0.3% to 20% by mass, and even more preferably 1% to 4% by mass.

As the polymerizable compound having a polymerizable group included in the alignment film material, a polymerizable compound represented by General Formula (V-1) may be included, in addition to the compound represented by General Formula (I).

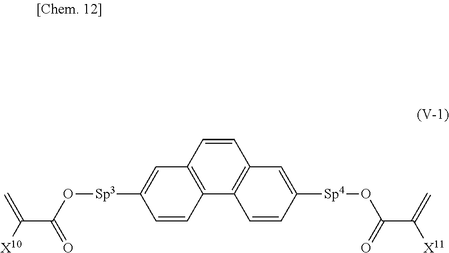

(In the formula, X¹⁰ and X¹¹ each independently represent a hydrogen atom or a methyl group, Sp³ and Sp⁴ each independently represent a single bond, an alkylene group having 1 to 8 carbon atoms, or —X—(CH₂)ₜ— (in the formula, t represents an integer of 2 to 7, X represents —O—, —OCOO—, —OCO—, or —COO—, and X is bonded to a phenanthrene ring), and a random hydrogen atom in a phenanthrene ring in the formula may be substituted with a fluorine atom.)

In General Formula (V-1), X¹⁰ and X¹¹ each independently represent a hydrogen atom or a methyl group. A hydrogen atom is preferable, in a case where a reaction speed is important, and a methyl group is preferable, in a case where a decrease in amount of reaction residues is important.

In General Formula (V-1) Sp³ and Sp⁴ each independently represent a single bond, an alkylene group having 1 to 8 carbon atoms, or —X—(CH₂)ₜ— (in the formula, t represents an integer of 2 to 7, X represents —O—, —OCOO—, or —COO—, and X is bonded to a phenanthrene ring). It is preferable that a carbon chain is not excessively long. A single bond or an alkylene group having 1 to 5 carbon atoms is preferable, and a single bond or an alkylene group having 1 to 3 carbon atoms is more preferable. In addition, even in a case where Sp³ and Sp⁴ represent —X—(CH₂)ₜ—, t is preferably 1 to 5 and more preferably 1 to 3. It is preferable that at least one of Sp³ and Sp⁴ is a single bond and it is particularly preferable that both thereof are single bonds.

Specifically, the compound represented by General. Formula (V-1) is preferably compounds represented by General Formulae (V-1-1) to (V-1-52).

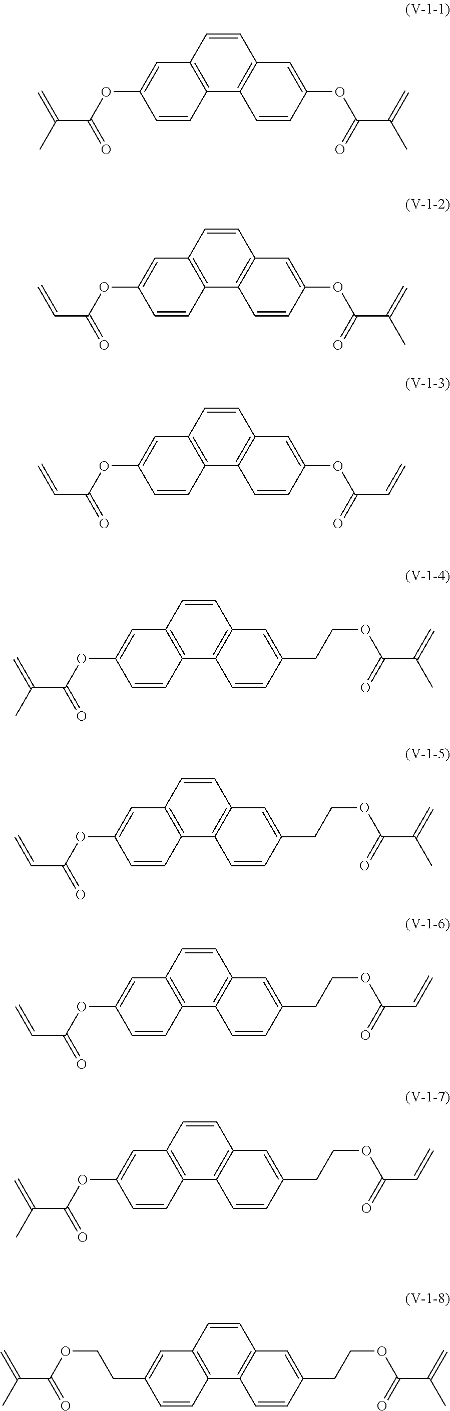

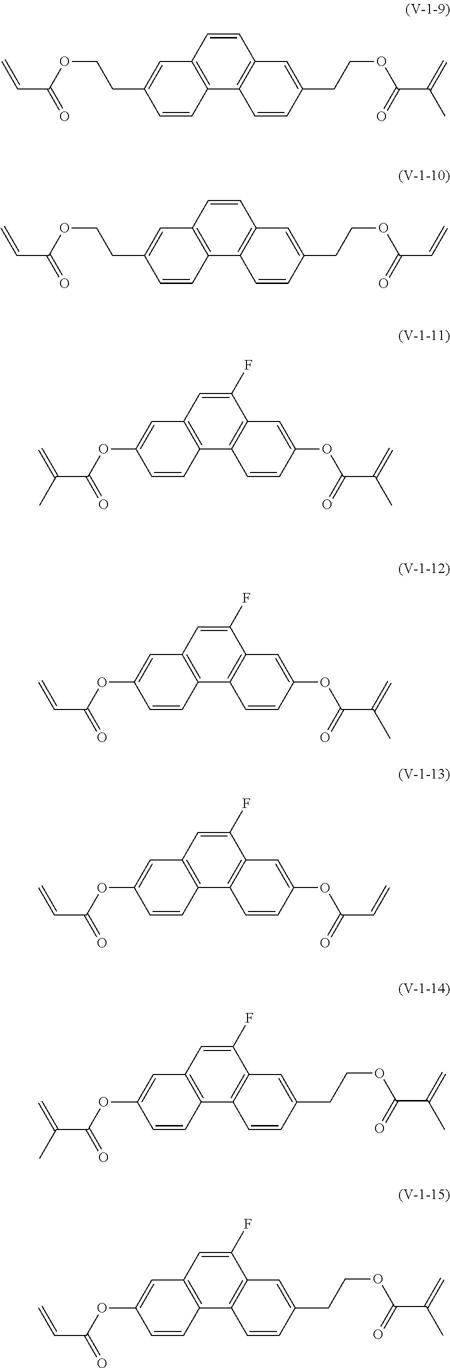

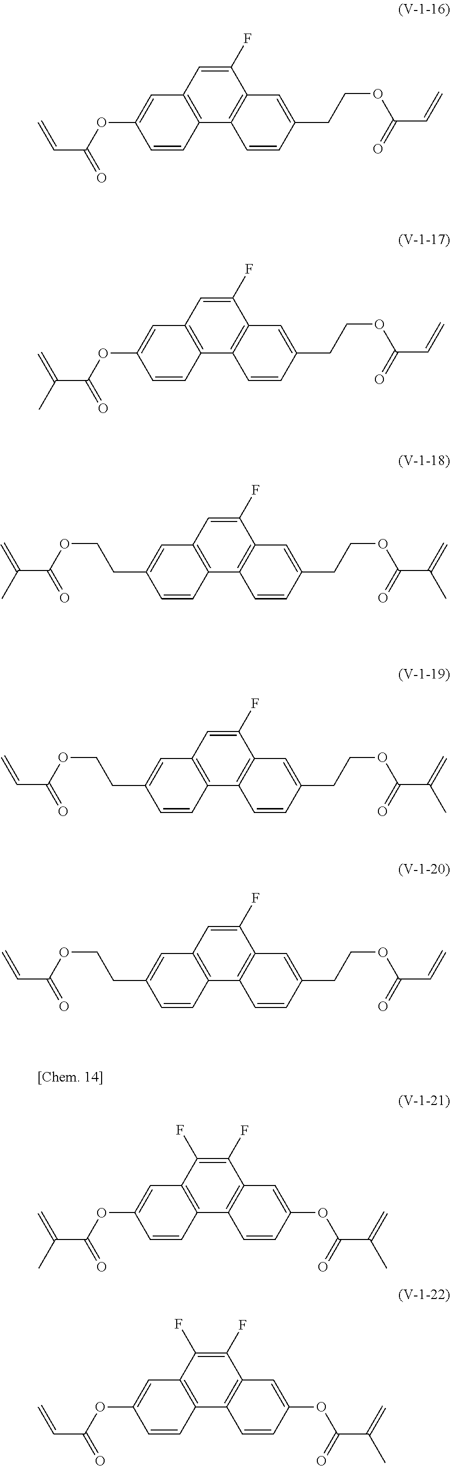

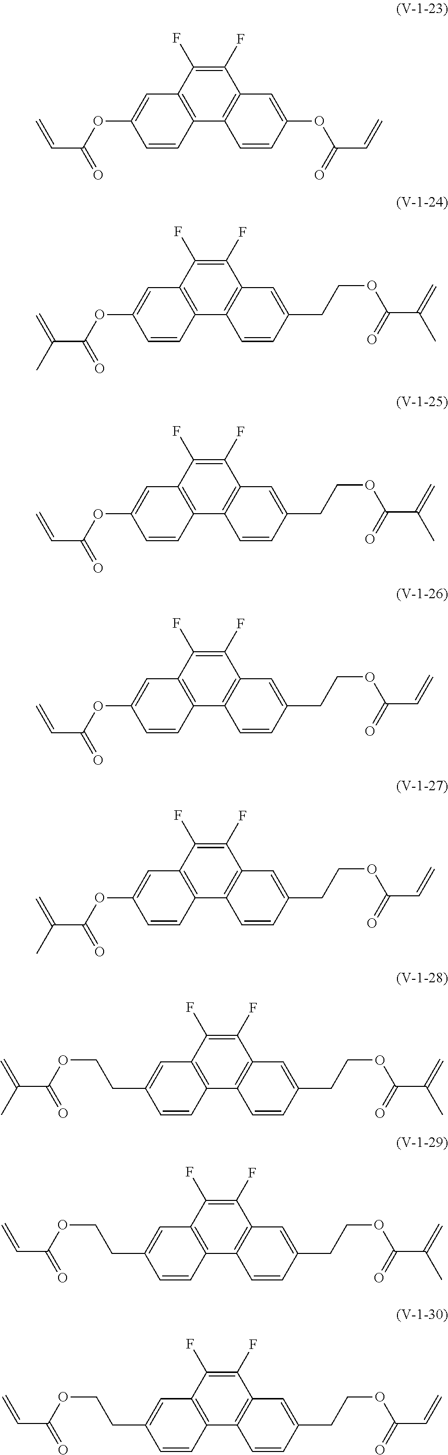

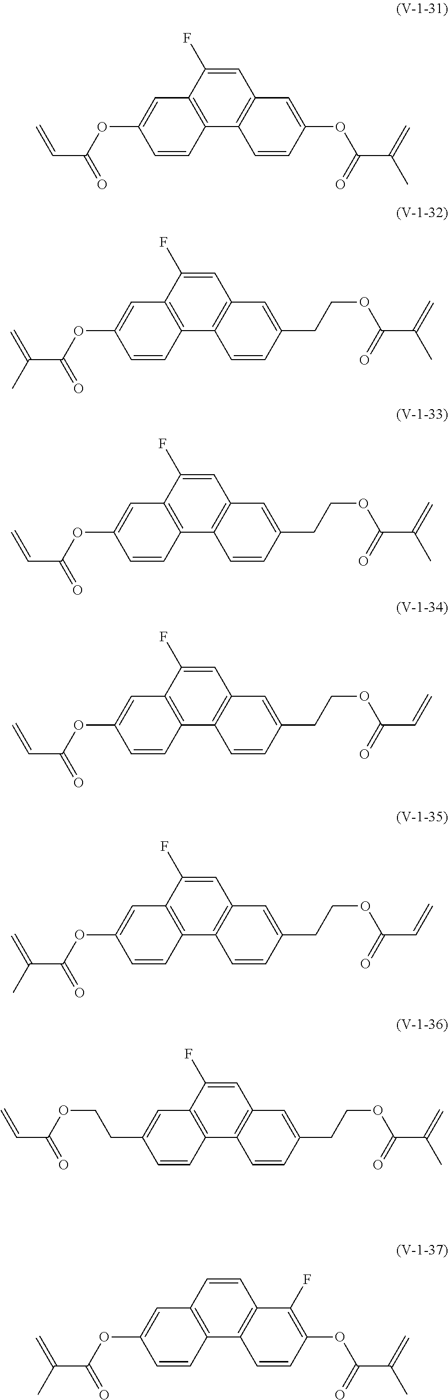

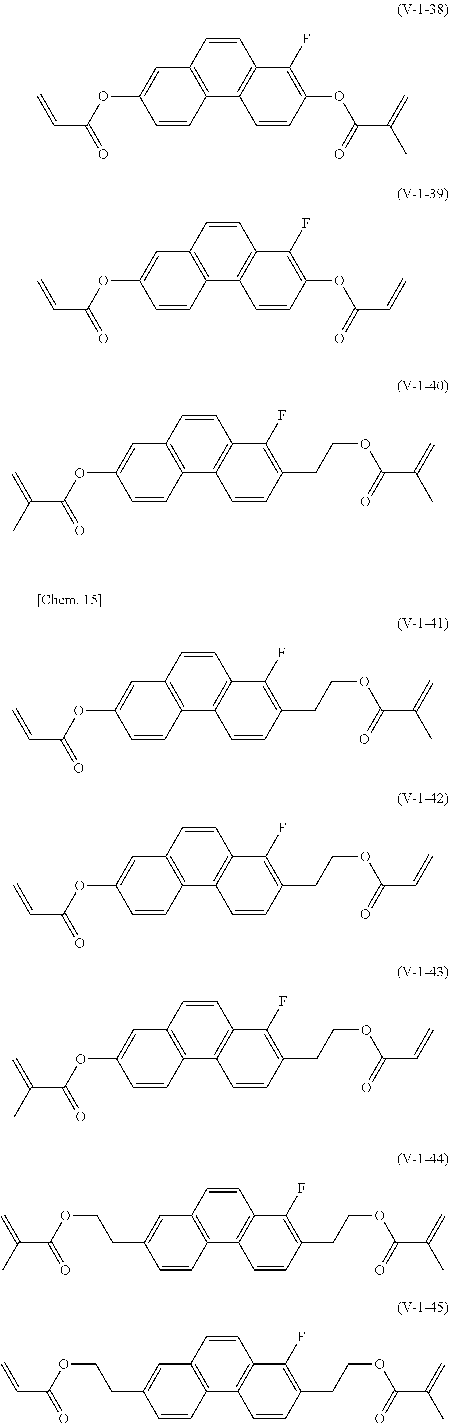

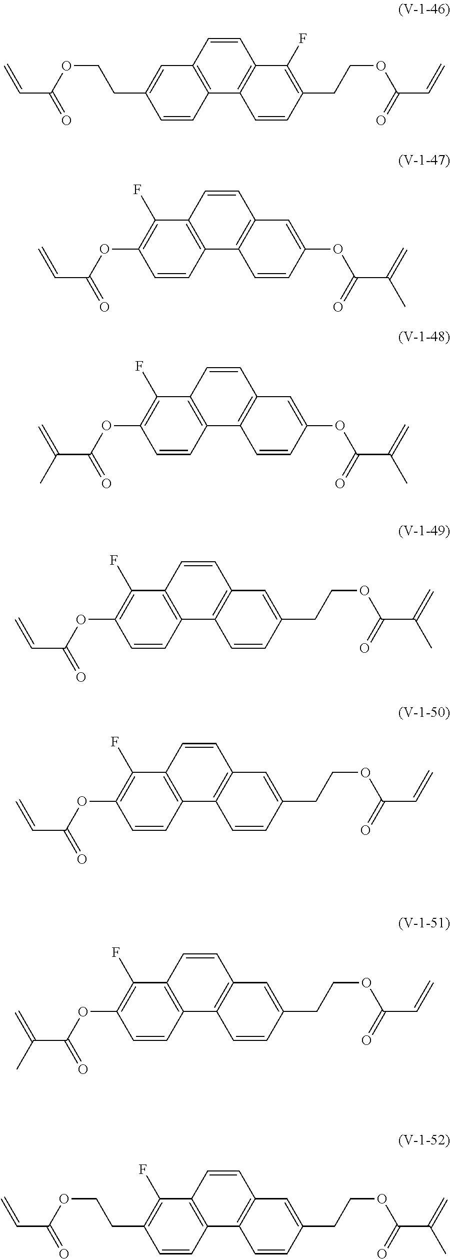

As the polymerizable compound having a polymerizable group included in the alignment film material, a polymerizable compound represented by General Formula (V-2) may be included, in addition to the compound represented by General Formula (I).

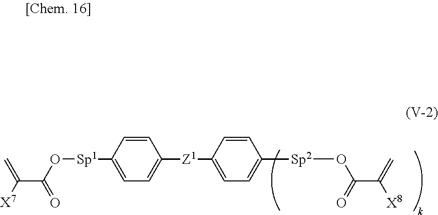

(In the formula, X⁷ and X⁸ each independently represent, a hydrogen atom or a methyl group, Sp¹ and Sp² each independently represent a single bond, an alkylene group having 1 to 8 carbon atoms, or —X—(CH₂)ₛ— (in the formula, s represents an integer of 2 to 7, X represents O, OCOO, OCO, or COO, and X is bonded to an aromatic ring), z¹ each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, or a single bond, a random hydrogen atom in all of the aromatic ring in the formula may be substituted with a fluorine atom or an alkoxy group, and k represents an integer of 0 to 5.)

In General Formula (V-2), X⁷ and X⁸ each independently represent a hydrogen atom or a methyl group. A hydrogen atom is preferable, in a case where a reaction speed is important, and a methyl group is preferable, in a case where a decrease in amount of reaction residues is important.

In General Formula (V-2), Sp¹ and Sp² each independently represent a single bond, an alkylene group having 1 to 8 carbon atoms, or —X—(CH₂)ₛ— (in the formula, s represents an integer of 2 to 7, X represents O, OCOO, or COO, and X is bonded to an aromatic ring). It is preferable that a carbon chain is not excessively long. A single bond or an alkylene group having 1 to 5 carbon atoms is preferable, and a single bond or an alkylene group having 1 to 3 carbon atoms is more preferable. In addition, even in a case where Sp¹ and Sp² represent —X—(CH₂)ₛ—, s is preferably 1 to 5 and more preferably 1 to 3. It is preferable that at least one of Sp¹ and Sp² is a single bond and it is particularly preferable that both thereof are single bonds.

In General Formula (V-2), k represents an integer of 0 to 5. In a case where controlling properties of the direction of alignment of the liquid crystal molecule in the liquid crystal composition layer are important, k preferably represents an integer of 1 to 5, more preferably represents an integer of 1 to 3, a bifunctional compound, in which k is 1, or a trifunctional compound, in which k is 2, is even more preferable, and bifunctional compound, in which k is 1 is particularly preferable.

Specifically, the compound represented by General Formula (V-2) is preferably compounds represented by General Formulae (V-2-1) to (V-2-39).

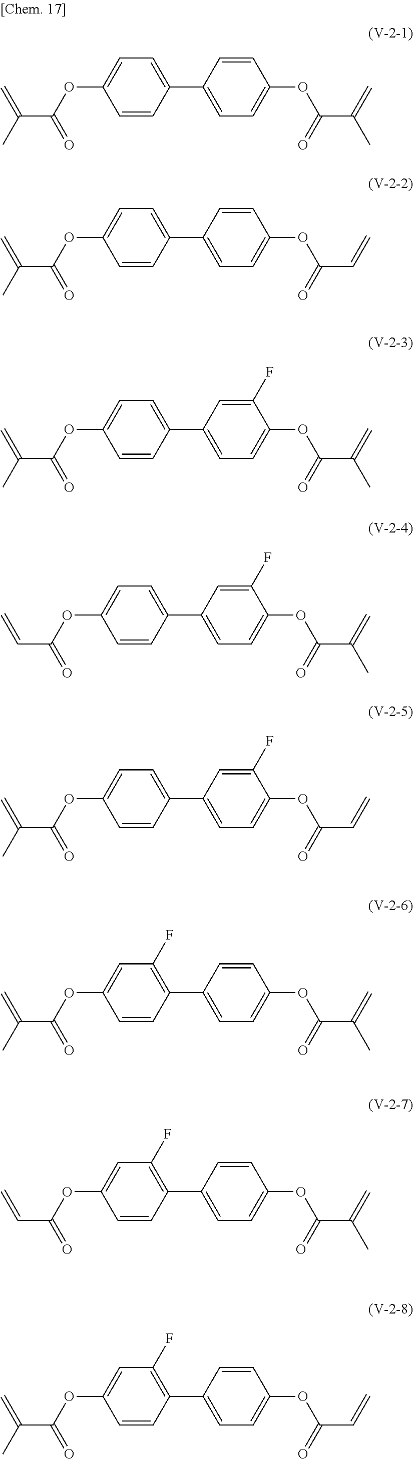

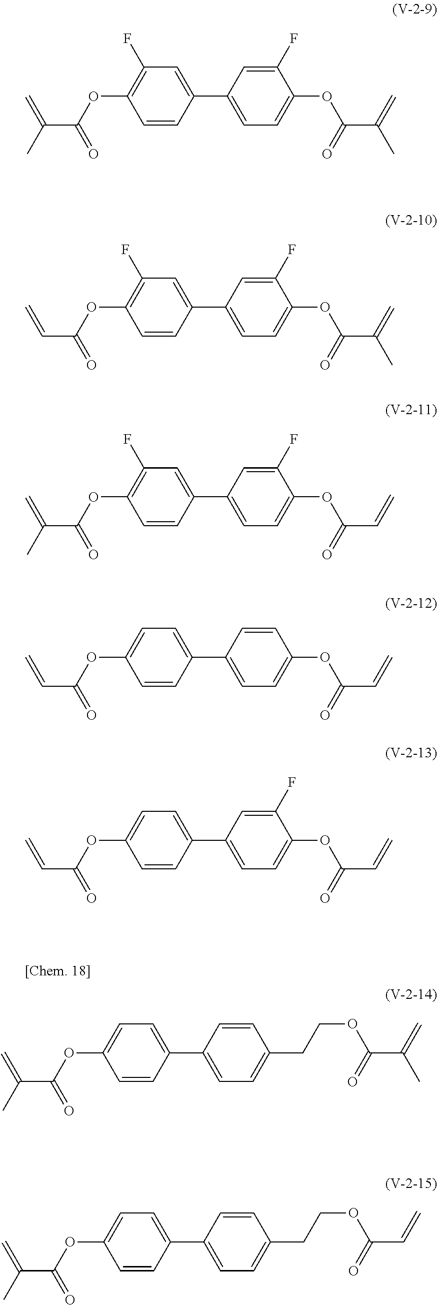

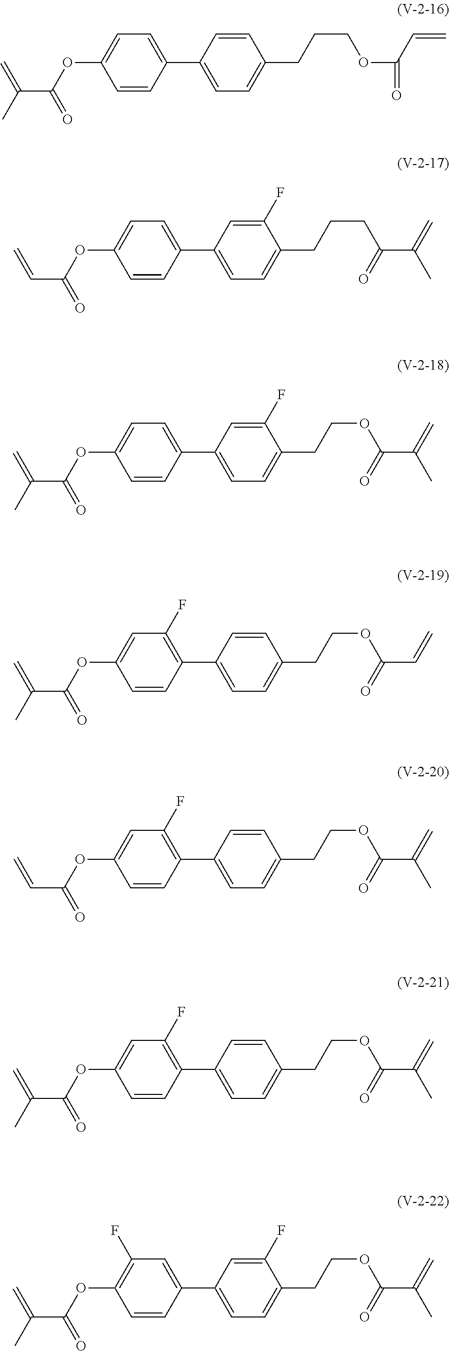

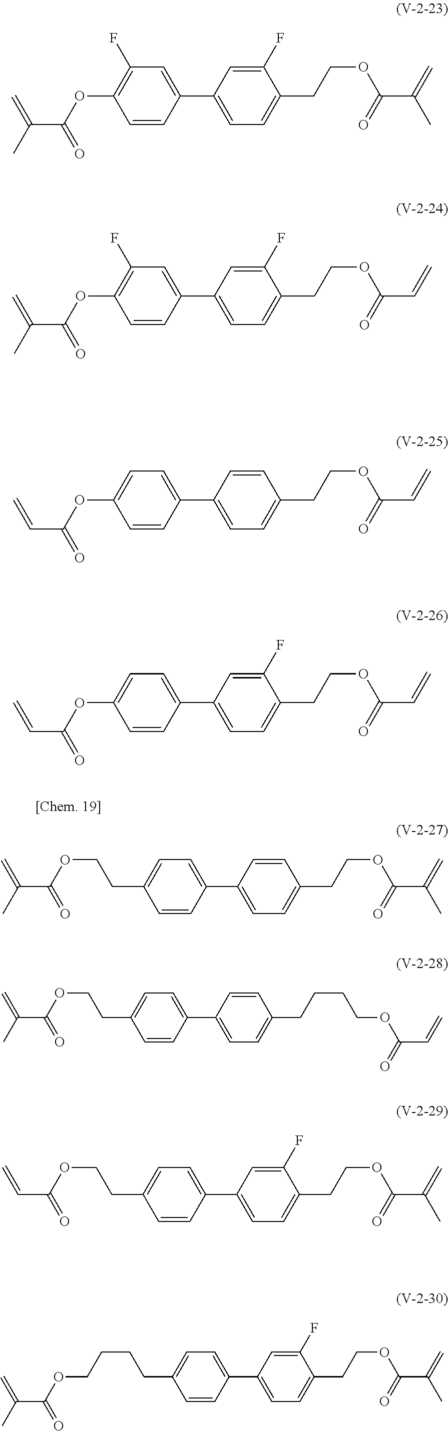

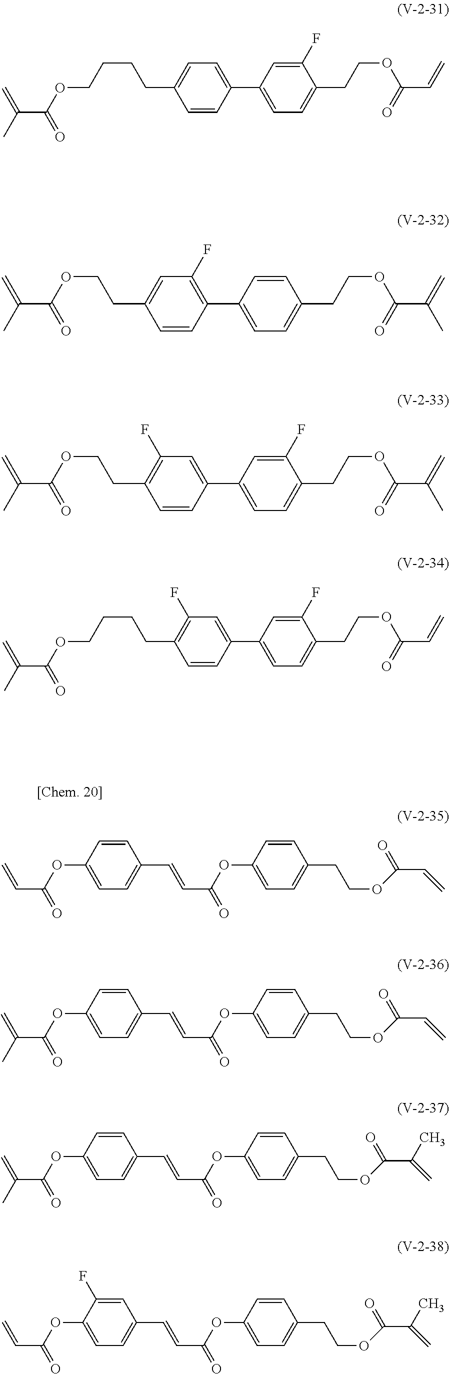

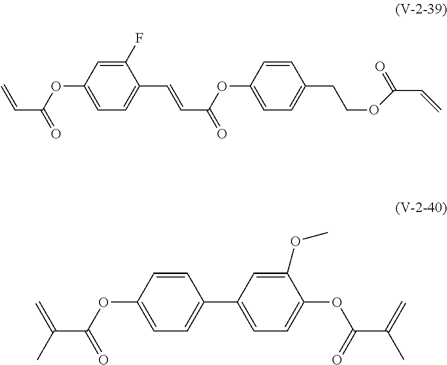

A content of the entire polymerizable compound having a polymerizable group in the polymer compound precursor for forming the alignment film is preferably 0.1% to 25% by mass, more preferably 0.3% to 20% by mass, even more preferably 0.5% to 15% by mass, and still more preferably 1% to 15% by mass. (Method of Using Polymer of Polymerizable Compound Having Crosslinking Functional Group at Side Chain Portion as Alignment Film Material)

A main chain portion of the polymerizable compound having the crosslinking functional group at the side chain portion is not particularly limited, as long as the polymerizable compound includes a crosslinking functional group (polymerizable group) at the side chain portion. It is preferable to use a compound having the imide skeleton or a siloxane skeleton as the main chain portion, and it is more preferable to use a compound having a polyimide skeleton at the main chain portion.

As the polymerizable compound having a polyimide skeleton at the main chain portion and having a crosslinking functional group as the side chain, a compound having a crosslinking functional group at the side chain in a repeating unit (main chain portion) configuring the polyimide structure is used. The crosslinking functional group becomes a polymerization reaction starting point. The polymerizable compound having a polymerizable group mixed in the alignment film material is subjected to a radical reaction to form a side chain, and accordingly, the alignment control section to control the direction of alignment of the liquid crystal molecule in the liquid crystal composition layer is obtained. The crosslinking functional group may have any structure, as long as it can be subjected to a radical reaction, groups represented by (P2-1) to (P2-7) shown below are preferable, groups represented by (P2-1) to (P2-3) are more preferable, and a group represented by (P2-1) or (P2-2) is even more preferable.

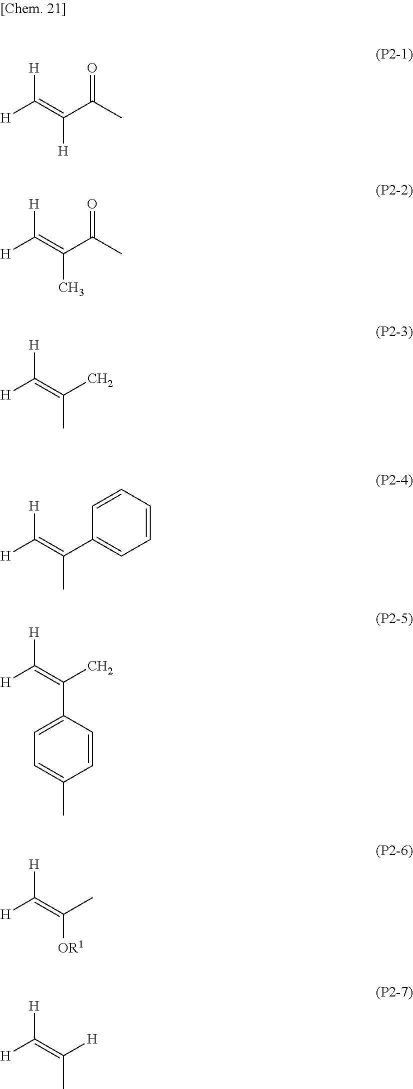

(R¹ represents an alkyl group having 1 to 5 carbon atoms.)

The crosslinking functional group may be bonded to the main chain portion through a covalent bond, may be directly bonded to the main chain portion, or may be bonded to the main chain portion through a linking group. As the linking group, —O—C₆H₄— or —O—C₆H₄—(R²O) r- is preferably used (R² represents an alkylene group having 1 to 20 carbon atoms and r represents an integer equal to or greater than 1.).

As the polymerizable compound having the polyimide skeleton as the main chain and having the crosslinking functional group as the side chain, a compound represented by General Formula (V-3) can be exemplified, for example.

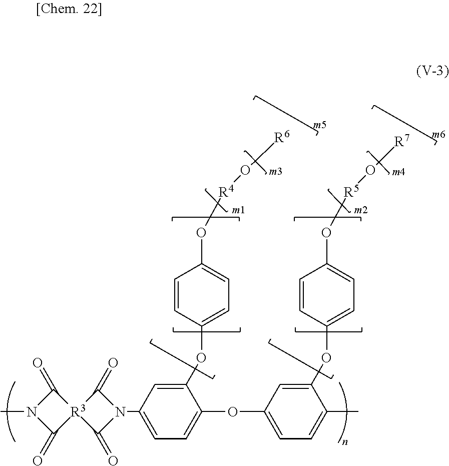

(In General Formula (V-3), R³ represents any one kind among groups represented by (V-3-A) to (V-3-F) shown below, R⁴ and R⁵ each independently represent an alkylene group having 1 to 20 carbon atoms, R⁶ and R⁷ each independently represent any one kind among groups represented by (P2-1) to (P2-7) shown above, n represents an integer equal to or greater than 1, m1 and m2 each represent 0 or 1, m3 and m4 each represent an integer of 0 or 1 or more, m5 and m6 each represent 0 or 1, and at least one of m5 and m6 represents 1.)

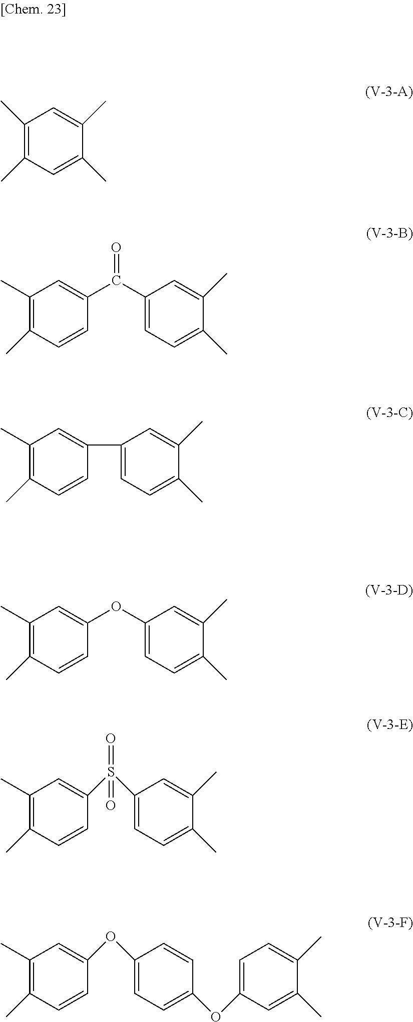

As the polymerizable compound having the polymerizable group mixed in the alignment film material, together with the polymerizable compound having the polyimide skeleton at the main chain portion and having the crosslinking functional group as the side chain, compounds same as the compound represented by General Formula (I), the compound represented by General Formula (V-1), and the compound represented by General Formula (V-2) are used, and the compound represented by General Formula (I) is necessarily included. By including the compound represented by General Formula (I), it is possible to perform the formation of the side chain with a small energy amount, that is, to reduce the amount of incidence of ultraviolet light or the like, and it is expected to decrease damage on the liquid crystal and improve productivity. In addition, heat resistance at a firing temperature of polyimide is increased and reliability can be improved.

A mixing amount of the compound represented by General Formula (I) mixed in the alignment, film material is preferably 0.1% to 25% by mass, more preferably 0.3% to 20% by mass, even more preferably 0.5% to 15% by mass, and still more preferably 1% to 15% by mass.

As the alignment film material, in a case of using a polymer of the polymerizable compound having the crosslinking functional group at the side chain portion, the well-known polyimide-based material described above may be used together.

(Method of Using Cured Material of Polymerizable Liquid Crystal Compound as Alignment Film)

In a case of using a cured material of the polymerizable liquid crystal compound as the alignment, film, an alignment film formed of the polyimide-based material or polysiloxane-based material may be used as an undercoat alignment film.

As the alignment film, in a case of using the cured material of the polymerizable liquid crystal compound, the polymerizable liquid crystal compound represented by General Formula (I) is necessarily included. By including the compound represented by General Formula (I), the cured material of the polymerizable liquid crystal compound can be obtained with a small energy amount, that is, the amount of incidence of ultraviolet light or the like can be reduced.

In a case of producing the alignment film by using the cured material of the polymerizable liquid crystal compound, with respect to a total amount of the polymerizable compounds such as the compound represented by General Formula (I), the compound represented by General Formula (V-1), the compound represented by General Formula (V-2), and a polymerizable liquid crystal compound represented by General Formula (V-4) is preferably 0% to 60% by mass, more preferably 0% to 40% by mass, and even more preferably 1% to 30% by mass.

Specifically, as the polymerisable liquid crystal compound forming the alignment film, it is preferable to include one or more polymerizable liquid crystal compounds represented by General Formula (V-4).

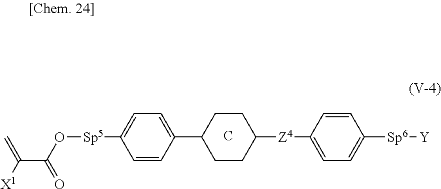

(In the formula, X¹ represents a hydrogen atom or a methyl group, Sp⁵ and Sp⁶ each independently represent a single bond, an alkylene group having 1 to 8 carbon atoms, or —O—(CH₂)ₛ—,

—OCO—(CH₂)ₛ— (in the formula, s represents an integer of 2 to 7and an oxygen atom is bonded to an aromatic ring), Z⁴ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂O—, —O(CH₂CH₂)₂O—, —CH₂CH₂—OCO—, —COO₂CH₂—, —OCO—CH₂—, —CH₂—COO—, —CH₂—OCO—, —CY¹═CY²— (Y¹ and Y² each independently represent a hydrogen atom or a fluorine atom), —C≡C—, or a single bond, Y represents an alkyl group having 1 to 8 carbon atoms, an alkenyl group having 2 to 8 carbon atoms, an alkoxy group having 1 to 8 carbon atoms, an alkenyloxy group having 2 to 8 carbon atoms, a hydrogen atom, a fluorine atom, or a cyano group, a C ring represents a 1,4-phenylene group, a trans-1,4-cyclohexylene group, or a single bond, and a random hydrogen atom of a 1,4-phenylene group in the C ring may be substituted with a fluorine atom.)

In General Formula (V-4), X¹ and X² each independently represent a hydrogen atom or a methyl group. A hydrogen atom is preferable, in a case where a reaction speed is important, and a methyl group is preferable, in a case where a decrease in amount of reaction residues is important.

In General Formula (V-4), Sp⁵ and Sp⁶ each independently represent a single bond, an alkylene group having 1 to 8 carbon atoms, or —O—(CH₂)s- (in the formula, s represents an Integer of 2 to 7 and an oxygen atom is bonded to an aromatic ring). It is preferable that a carbon chain is not excessively long. A single bond or an alkylene group having 1 to 5 carbon atoms is preferable, and a single bond or an alkylene group having 1 to 3 carbon atoms is more preferable. In addition, even in a case where Sp⁵ and Sp⁶ represent —O—(CH₂)ₛ—, s is preferably 1 to 5 and more preferably 1 to 3. It is preferable that at least one of Sp⁵ and Sp⁶ is a single bond and it is particularly preferable that both thereof are single bonds.

In General Formula (V-4), Z⁴ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO‘CH₂CH₂—, —OCO—CH₂CH₂—, —CH₂CH₂COO—, —CH₂CH₂—OCO—, —COO—CH₂—, —OCO—CH₂—, —CH₂—COO—, —CH₂—OCO—, —CY¹═CY²— (Y¹ and Y² each independently represent a hydrogen atom or a fluorine atom), —C≡C—, or a single bond. —OCH₂—, —CH₂O—, —COO—, —OCO—, —CF₂O—, —OCF₂—, —CH₂CH₂—, —CF₂CF₂—, —OCH₂CH₂O—, —O(CH₂CH₂)₂O—, or a single bond is preferable, —OCH₂CH₂O—, —O(CH₂CH₂)₂O—, —COO—, —OCO—, or a single bond is more preferable, and a single bond is particularly preferable.

In General Formula (V-4), the C ring represents a 1,4-phenylene group in which a random hydrogen atom may be substituted with a fluorine atom, a trans-1,4-cyclohexylene group, or a single bond, and a 1,4-phenylene group or a single bond is preferable.

In a case where the C ring represents a ring structure other than the single bond, Z⁴ is also preferably a linking group other than the single bond, and in a case where the C ring is a single bond, Z⁴ is preferably a single bond.

In a case of using the cured material of the polymerizable liquid crystal compound as the alignment film, it is necessary to heat the polymerizable liquid crystal compound in an alignment film forming material to obtain isotropic liquid, decrease a temperature, and set the alignment of the polymerizable liquid crystal compound as vertical alignment. After that, a pretilt angle is applied in a state where a magnetic field tilted by a specific angle from the substrate surface is applied, and ultraviolet light, is applied in this state, so that the polymerizable liquid crystal compound is cured and the alignment, film is obtained.

In addition, the alignment film may include a homogeneous alignment film as a ground layer of the alignment film. Specifically, a homogeneous alignment film, to which homogeneous alignment properties are applied, may be included, by applying a homogeneous alignment film material onto the substrate by a spin coating method by using a polyimide-based homogeneous alignment film material or the like, removing a solvent by heating or the like, performing, firing to prepare a ground layer, and performing a rubbing process.

(Polymerizable Compound Included in Liquid Crystal Composition for Forming Polymer Layer on Surface of Alignment Film)

In the liquid crystal display element of the invention, the vertical alignment film includes a polymer formed by the polymerization of the polymerizable compound having a reactive group and can apply a suitable pretilt angle by the polymer. In addition, if necessary, the polymer is formed as a polymer layer on the surface of the vertical alignment film, by providing the polymerizable compound in the liquid crystal composition, sandwiching the liquid crystal composition between the substrates, curing the polymerizable compound while applying a voltage thereto, and causing phase separation of the polymerizable compound, and accordingly, it is possible to obtain a liquid crystal display element having high alignment properties of the liquid crystal molecule and stability of a pretilt angle, a low frequency of occurrence of burn-in, and a low frequency of generation of drop marks at the time of the producing.

Examples of the polymerizable compound forming the polymer layer include a mono-functional polymerizable compound including one reactive group, and a polyfunctional polymerizable compound such as a bifunctional polymerizable compound or a trifunctional polymerizable compound including two or more reactive groups, and a polyfunctional polymerizable compound such as a bifunctional polymerizable compound or a trifunctional polymerizable compound including two or more reactive groups is preferable. The polymerizable compound used may be one kind or two or more kinds.

As the polymerizable compound forming the polymer layer, the compound represented by General Formula (I) is preferably included. By using the compound represented by General Formula (I), the polymer layer can be formed on the surface of the alignment film with a small energy amount, that is, the amount of incidence of ultraviolet light or the like can be reduced.

In addition, as the polymerizable compound for forming the polymer layer, one or more compounds selected from the compound represented by General Formula (V-1), the compound represented by General Formula (V-2), and the compound represented by General Formula (V-4) is preferably used.

A total content of the one or more compounds selected from the compound represented by General Formula (V-1), the compound represented by General Formula (V-2), and the compound represented by General Formula (V-4), used for forming the polymer layer on the surface of the vertical alignment film, in the liquid crystal composition is preferably 0% to 2% by mass, more preferably 0.03% to 0.1% by mass, and even more preferably 0.05% to 0.08% by mass.

(Liquid Crystal Composition)

The liquid crystal composition of the invention includes one or more the compounds represented by General Formula (N-1), General Formula (N-2), and General Formula (N-3).

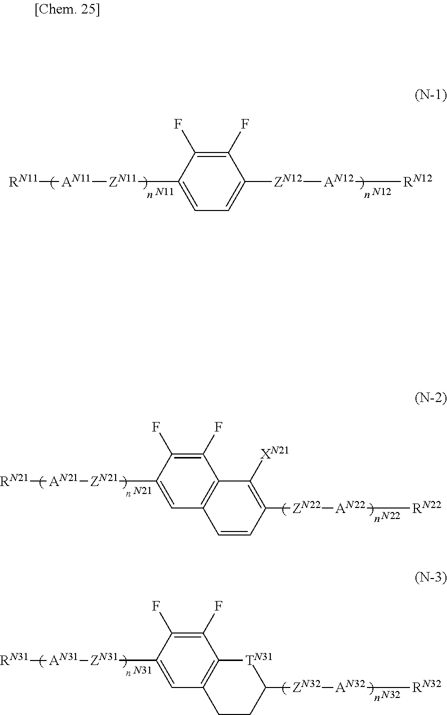

In the formulae, R^{N11}, R^{N12}, R^{N21}, R^{N22}, R^{N31}, and R^{N32} each independently represent an alkyl group having 1 to 8 carbon atoms, one —CH₂— or two or more —CH₂—'s not adjacent to each other in the alkyl group each may toe independently substituted with —CH═CH—, —C≡C—, —O—, —CO—, —COO—, or —OCO—, A^{N11}, A^{N12}, A^{N21}, A^{N22}, A^{N31}, and A^{N32} each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —H═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), the group (a), the group (b), and the group (c) each may be independently substituted with a cyano group, a fluorine atom, or a chlorine atom, Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—, X^{N21} represents a hydrogen atom or a fluorine atom, T^{N31} represents —CH₂— or —O—, n^{N11}, n^{N12}, n^{N21}, n^{N22}, n^{N31} and n^{N32} each independently represent an integer of 0 to 3, n^{N11}+n¹², n^{N21}+n^{N22}, and n^{N31}+n^{N32} are each independently 1, 2, or 3, and, in a case where a plurality of A^{N11}'s to A^{N32}'s and Z^{N11}'s to Z^{N32}'s are present, these may be the same or different.

The compounds represented by General Formulae (N-1), (N-2), and (N-3) are preferably compounds having negative Δε and an absolute value greater than 3.

In General Formulae (N-1), (N-2), and (N-3), R^{N11}, R^{N12}, R^{N21}, R^{N22}, R^{N31}, and R^{N32} each preferably independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, more preferably independently represent an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, even more preferably independently represent an alkyl group having 1 to 5 carbon atoms or an alkenyl group having 2 to 5 carbon atoms, still more preferably independently represent an alkyl group having 2 to 5 carbon atoms or an alkenyl group having 2 to 3 carbon atoms, and particularly preferably independently represent alkenyl group (propenyl group) having 3 carbon atoms.

In a case where a ring structure for the bonding thereof is a phenyl group (aromatic group), a linear alkyl group having 1 to 5 carbon atoms, a linear alkoxy group having 1 to 4 carbon atoms, and an alkenyl group having 4 or 5 carbon atoms are preferable, and in a case where a ring structure for the bonding thereof is a saturated ring structure such as cyclohexane, pyran, and dioxane, an a linear alkyl group having 1 to 5 carbon atoms, a linear alkoxy group having 1 to 4 carbon atoms, and a linear alkenyl group having 2 to 5 carbon atoms are preferable. In a case where carbon atoms are present, a total of oxygen atoms is preferably equal to or smaller than 5, and a linear group is preferable, in order to stabilize a nematic phase.

The alkenyl group is preferably selected from the groups represented by any of Formula (R1) to Formula (R5). (A black point in each formula represents a carbon atom in a ring structure.)

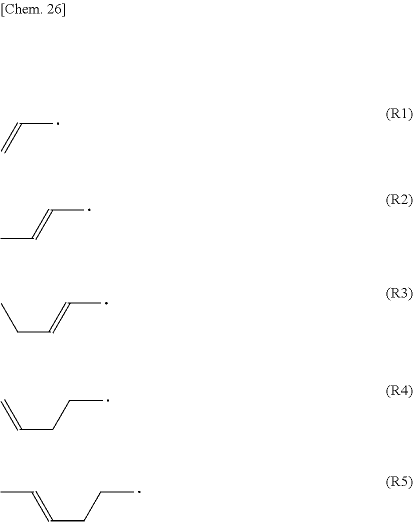

A^{N11}, A^{N12}, A^{N21}, A^{N22}, A^{N31}, and A^{N32} each preferably independently represent an aromatic group, in a case where it is necessary to increase Δn, and preferably independently represent an aliphatic group, more preferably independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo [2.2.2] octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably independently represent the following structure, in order to improve a response speed.

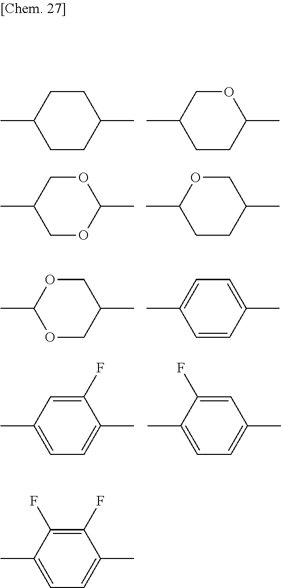

It is more preferable to represent a trans-1,4-cyclohexylene group, or a 1,4-phenylene group.

Z^{N11}, Z^{N12}, Z^{N21}, Z^{N22}, Z^{N31}, and Z^{N32} each preferably independently represent —CH₂O—, —CF₂O—, —CH₂CH₂—, —CF₂CF₂—, or a single bond, more preferably independently represent —CH₂O—, —CH₂CH₂—, or a single bond, and particularly preferably independently represent —CH₂O— or a single bond.

X^{N21} is preferably a fluorine atom.

T^{N31} is preferably —O—,

n^{N11}+n^{N12}, n^{N21}+n^{N22}, and n^{N31}+n^{N32} are preferably 1 or 2, and a combination in which n^{N11} is 1 and n^{N12} is 0, a combination in which n^{N11} is 2 and n^{N12} is 0, a combination in which n^{N11} is 1 and n^{N12} is 1, a combination in which n^{N11} is 2 and n^{N12} is 1, a combination in which n^{N21} is 1 and n^{N22} is 0, a combination in which n^{N21} is 2 and n^{N22} is 0, a combination in which n^{N31} is 1 and n^{N32} is 0, and a combination in which n^{N31} is 2 and n^{N32} is 0, are preferable.

A lower limit value of the preferable content of the compound represented by General Formula (N-1) with respect to a total amount of the liquid crystal composition of the invention (total amount of the liquid crystal compound included in the liquid crystal composition. The same applies hereinafter) is 1% by mass (hereinafter, the unit, % by mass, is simply referred to as %), 10%, 20%, 30%, 40%, 50%, 55%, 60%, 65%, 70%, 75%, or 80%. An upper limit value of the preferable content is 95%, 85%, 75%, 65%, 55%, 45%, 35%, 25%, or 20%.

A lower limit value of the preferable content of the compound represented by General Formula (N-2) with respect to a total amount of the liquid crystal composition of the invention is 1% by mass (hereinafter, the unit, % by mass, is simply referred to as %), 10%, 20%, 30%, 40%, 50%, 55%, 60%, 65%, 70%, 75%, or 80%. An upper limit value of the preferable content is 95%, 85%, 75%, 65%, 55%, 45%, 35%, 25%, or 20%.

A lower limit value of the preferable content of the compound represented by General Formula (N-3) with respect to a total amount of the liquid crystal composition of the invention is 1% by mass (hereinafter, the unit, % by mass, is simply referred to as %), 10%, 20%, 30%, 40%, 50%, 55%, 60%, 65%, 70%, 75%, or 80%. An upper limit value of the preferable content is 95%, 85%, 75%, 65%, 55%, 45%, 35%, 25%, or 20%.

In a case where a composition which maintains low viscosity of the liquid crystal composition of the invention and has a high response speed is necessary, it is preferable that the lower limit value is low and the upper limit value is low. In addition, in a case where a composition which maintains high Tni of the composition of the invention and has excellent temperature stability is necessary, it is preferable that the lower limit value thereof is low and the upper limit value thereof is low. Further, in a case of increasing dielectric anisotropy for maintaining a low driving voltage, it is preferable that the lower limit value is high and the upper limit value is high.

The compound represented by General Formula (N-1) is preferably a compound selected from a group of compounds represented by General Formulae (N-1-1) to (N-1-21).

The compound represented by General Formula (N-1-1) is the following compound.

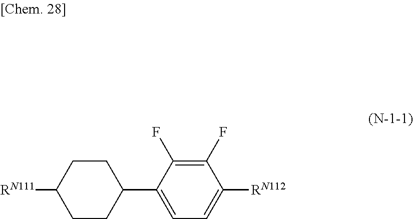

(In the formula, R^{N111} and R^{N112} each independently represent the same meaning as those of R^{N11} and R^{N12} of General Formula (N-1).)

R^{N111} is preferably an alkyl group having 1 to 5 carbon atoms or an alkenyl group having 2 to 5 carbon atoms, and is preferably a propyl group or a pentyl group. R^{N112} is preferably an alkyl group having 1 to 5 carbon atoms, an alkenyl group having 4 or 5 carbon atoms, or an alkoxy group having 1 to 4 carbon atoms, and is preferably an ethoxy group or a butoxy group.

The compound represented by General Formula (N-1-1) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a small content. In addition, in a case of improving drop marks or burn-in properties, it is preferable to set a range of the content in the middle.

A lower limit value of the preferable content of the compound represented by Formula (N-1-1) with respect to a total amount of the liquid crystal composition of the invention is 5% by mass (hereinafter, the unit, % by mass, is simply referred to as %), 10%, 13%, 15%, 17%, 20%, 23%, 25%, 27%, 30%, 33%, or 35%. An upper limit value of the preferable content with respect to a total amount of the liquid crystal composition of the invention is 50%, 40%, 38%, 35%, 33%, 30%, 28%, 25%, 23%, 20%, 18%, 15%, 13%, 10%, 8%, 7%, 6%, 5%, or 3%.

The compound represented by General Formula (N-1-1) is preferably a compound selected from a group of compounds represented by Formula (N-1-1.1) to Formula (N-1-1.14), preferably compounds represented by Formulae (N-1-1.1) to (N-1-1.4), and preferably compounds represented by Formula (N-1-1.1) and Formula (N-1-1.3).

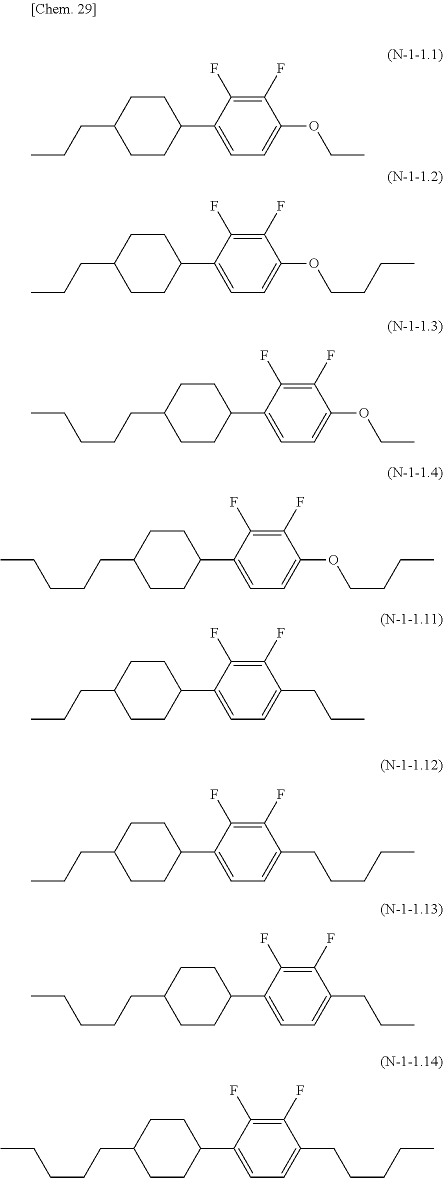

The compounds represented by Formulae (N-1-1.1) to (N-1-1.4) can be used alone or in combination, and a lower limit value of the preferable content of the single compound or these compounds with respect to a total amount of the liquid crystal composition of the invention is 5% by mass (hereinafter, the unit, % by mass, is simply referred to as %), 10%, 13%, 15%, 17%, 20%, 23%, 25%, 27%, 30%, 33%, or 35%. An upper limit value of the preferable content with respect to a total amount of the liquid crystal composition of the invention is 50%, 40%, 38%, 35%, 33%, 30%, 28%, 25%, 23%, 20%, 18%, 15%, 13%, 10%, 8%, 7%, 6%, 5%, or 3%.

The compound represented by General Formula (N-1-2) is the following compound.

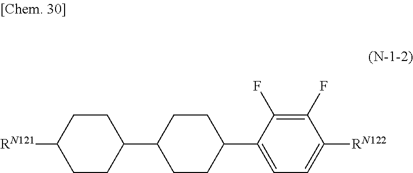

(In the formula, R^{N121} and R^{N122} each independently represent the same meaning as those of R^{N11} and R^{N12} of General Formula (N-1).)

R^{N121} is preferably an alkyl group having 1 to 5 carbon atoms or an alkenyl group having 2 to 5 carbon atoms, and is preferably an ethyl group, a propyl group, a butyl group, or a pentyl group. R^{N122} is preferably an alkyl group having 1 to 5 carbon atoms, an alkenyl group having 4 or 5 carbon atoms, or an alkoxy group having 1 to 4 carbon atoms, and is preferably a methyl group, a propyl group, a methoxy group, an ethoxy group, or a propoxy group.

The compound represented by General Formula (N-1-2) can also be used alone and two or more compounds can also be used in combination. The kinds of the compounds to to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement, of Δε is important, it is preferable to set a high content, in a case where solubility at a low temperature is important, the effect increases, in a case of setting a small content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-2) with respect to a total amount, of the liquid crystal composition of the invention is 5% by mass (hereinafter, the unit, % by mass, is simply referred to as %), 7%, 10%, 13%, 15%, 17%, 20%, 23%, 25%, 27%, 30%, 33%, 35%, 37%, 40%, or 42%. An upper limit value of the preferable content with respect to a total amount of the liquid crystal composition of the invention is 50%, 48%, 45%, 43%, 40%, 38%, 35%, 33%, 30%, 28%, 25%, 23%, 20%, 18%, 15%, 13%, 10%, 8%, 7%, 6%, or 5%.

The compound represented by General Formula (N-1-2) is preferably a compound selected from a group of compounds represented by Formula (N-1-2.1) to Formula (N-1-2.13), and preferably compounds represented by Formula (N-1-2.3) to Formula (N-1-2.7), Formula (N-1-2.10), Formula (N-1-2.11), and Formula (N-1-2.13). In a case where the improvement of Δε is important, the compounds represented by Formula (N-1-2.3) to Formula (N-1-2.7) are preferable, and in a case where improvement of T_{NI} is important, the compounds represented by Formula (N-1-2.10), Formula (N-1-2.11), and Formula (N-1-2.13) are preferable.

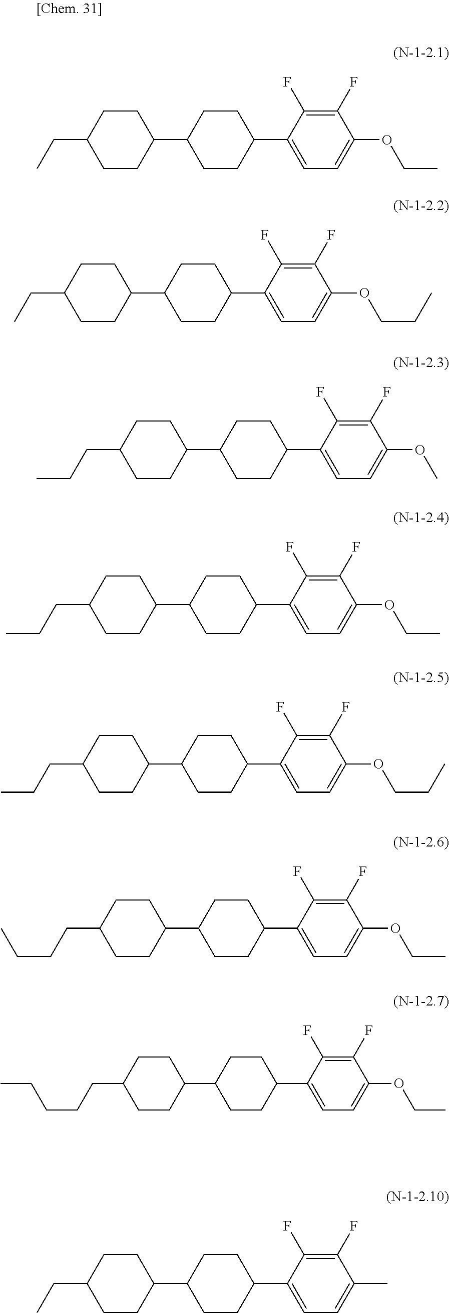

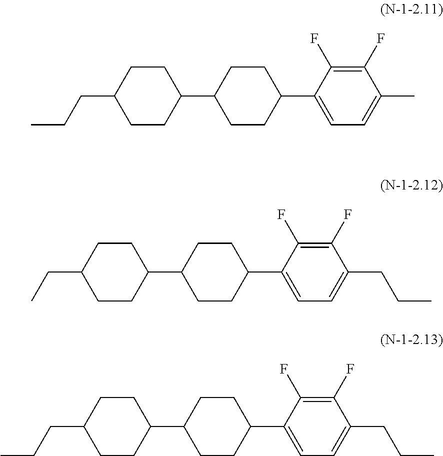

The compounds represented by Formulae (N-1-2.1) to (N-1-2.13) can be used alone or in combination, and a lower limit value of the preferable content of the single compound or these compounds with respect to a total amount of the liquid crystal composition of the invention is 5% by mass (hereinafter, the unit, % by mass, is simply referred to as %), 10%, 13%, 15%, 17%, 20%, 23%, 25%, 27%, 30%, 33%, or 35%. An upper limit value of the preferable content with respect to a total amount of the liquid crystal composition of the invention is 50%, 40%, 38%, 35%, 33%, 30%, 28%, 25%, 23%, 20%, 18%, 15%, 13%, 10%, 8%, 7%, 6%, 5%, or 3%.

The compound represented by General Formula (N-1-3) is the foiloking compound.

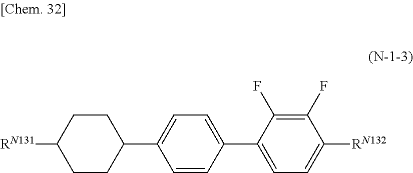

(In the formula, R^{N131} and R^{N132} each independently represent the same meaning as those of R^{N11} and R^{N12} of General Formula (N-1).)

R^{N131} is preferably an alkyl group having 1 to 5 carbon atoms or an alkenyl group having 2 to 5 carbon atoms, and is preferably an ethyl group, a propyl group, or a butyl group. R^{N132} preferably an alkyl group having 1 to 5 carbon atoms, an alkenyl group having 4 or 5 carbon atoms, or an alkoxy group having 1 to 4 carbon atoms, and is preferably an ethoxy group, a propoxy group, or a butoxy group.

The compound represented by General Formula (N-1-3) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used isr for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-3) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the composition of the invention is 35%, 30%, 28%, 25%, 23%, 20%, 18%, 15%, or 13%.

The compound represented by General Formula (N-1-3) is preferably a compound selected from a group of: compounds represented by Formula (N-1-3.1) to Formula (N-1-3.11), preferably compounds represented by Formulae (N-1-3.1) to (N-1-3.7), and preferably compounds represented by Formula (N-1-3.1), Formula (N-1-3.2), Formula (N-1-3.3), Formula (N-1-3.4), and Formula (N-1-3.6).

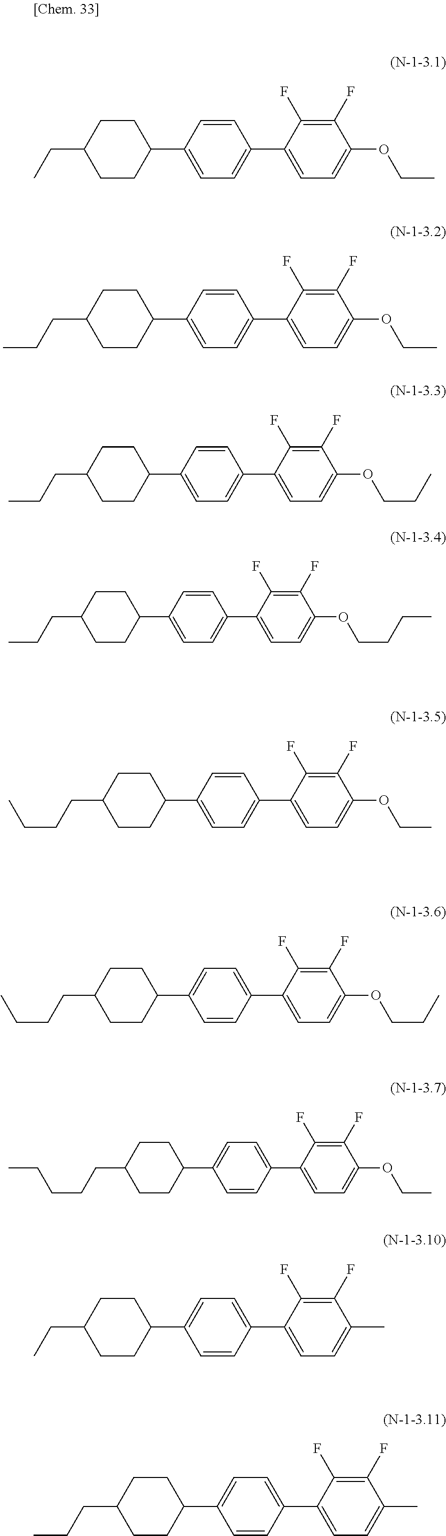

The compounds represented by Formula (N-1-3.1) to Formula (N-1-3.4) and Formula (N-1-3.6) can be used alone or in combination, and a combination of two or three kinds thereof selected from a combination of Formula (N-1-3.1) and Formula (N-1-3.2) and a combination of Formula (N-1-3.3), Formula (N-1-3.4), and Formula (N-1-3.6) is preferable. A lower limit value of the preferable content of the single compound or these compounds with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-4) is the following compound.

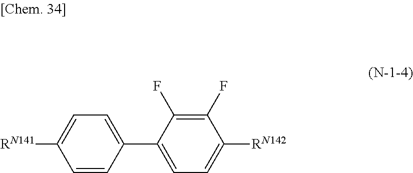

(In the formula, R^{N141} and R^{N142} each independently represent the same meaning as those of R^{N11} and R^{N12} of General Formula (N-1).)

R^{N141} and R^{N142} each independently represent an alkyl group having 1 to 5 carbon atoms, an alkenyl group having 4 or 5 carbon atoms, or an alkoxy group having 1 to 4 carbon atoms, and is preferably a methyl group, a propyl group, an ethoxy group, or a butoxy group.

The compound represented by General Formula (N-1-4) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a small content. In addition, in a case of improving drop marks or burn-in properties, it is preferable to set a range of the content in the middle.

A lower limit value of the preferable content of the compound represented by Formula (N-1-4) with respect to a total amount of the liquid crystal composition of the invention is 3% by mass (hereinafter, the unit, % by mass, is simply referred to as %), 5%, 7%, 10%, 13%, 15%, 17%, or 20%. An upper limit value of the preferable content with respect to a total amount of the liquid crystal composition of the invention is 35%, 30%, 28%, 25%, 23%, 20%, 18%, 15%, 13%, 11%, 10%, or 8%.

The compound represented by General Formula (N-1-4) is preferably a compound selected from a group of compounds represented by Formula (N-1-4.1) to Formula (N-1-1.4), preferably compounds represented by Formulae (N-1-4.1) to (N-1-4.4), and preferably compounds represented by Formula (N-1-4.1) and Formula (N-1-4.2).

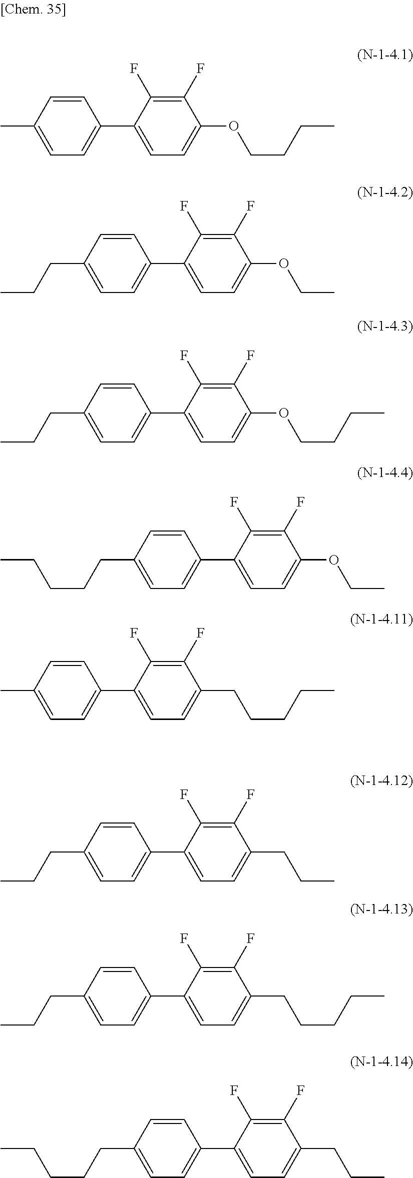

The compounds represented by Formulae (N-1-4.1) to (N-1-4.4) can be used alone or in combination, and a lower limit value of the preferable content of the single compound or these compounds with respect to a total amount of the liquid crystal composition of the invention is 3% by mass (hereinafter, the unit, % by mass, is simply referred to as %), 5%, 7%, 10%, 13%, 15%, 17%, or 20%. An upper limit value of the preferable content with respect to a total amount of the liquid crystal composition of the invention is 35%, 30%, 28%, 25%, 23%, 20%, 18%, 15%, 13%, 11%, 10%, or 8%.

The compound represented by General Formula (N-1-5) is the following compound.

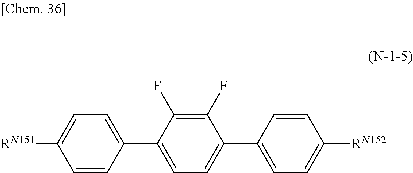

(In the formula, R^{N151} and R^{N152} each independently represent the same meaning as those of R^{N11} and R^{N12} of General Formula (N-1).)

R^{N151} and R^{N152} each independently represent an alkyl group having 1 to 5 carbon atoms, an alkenyl group having 4 or 5 carbon atoms, or an alkoxy group having 1 to 4 carbon atoms, and is preferably an ethyl group, a propyl group, or a butyl group.

The compound represented by General Formula; (N-1-5) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used isr for example, 1, 2, 3, 4, 5, or greater, as one embodiment of the invention.

In a case where the improvement of Δε is important, it is preferable to set a high content, in a case where solubility at a low temperature is important, the effect increases, in a case of setting a small content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-5) with respect to a total amount, of the liquid crystal composition of the invention is 5% by mass (hereinafter, the unit, % by mass, is simply referred to as %), 8%, 10%, 13%, 15%, 17%, or 20%. An upper limit value of the preferable content with respect to a total amount, of the liquid crystal composition of the invention is 35%, 33%, 30%, 28%, 25%, 23%, 20%, 18%, 15%, or 13%.

The compound represented by General Formula (N-1-5) is preferably a compound selected from a group of compounds represented by Formula (N-1-5.1) to Formula (N-1-5.6), and preferably compounds represented by Formula (N-1-3.2) and Formula (N-1-3.4).

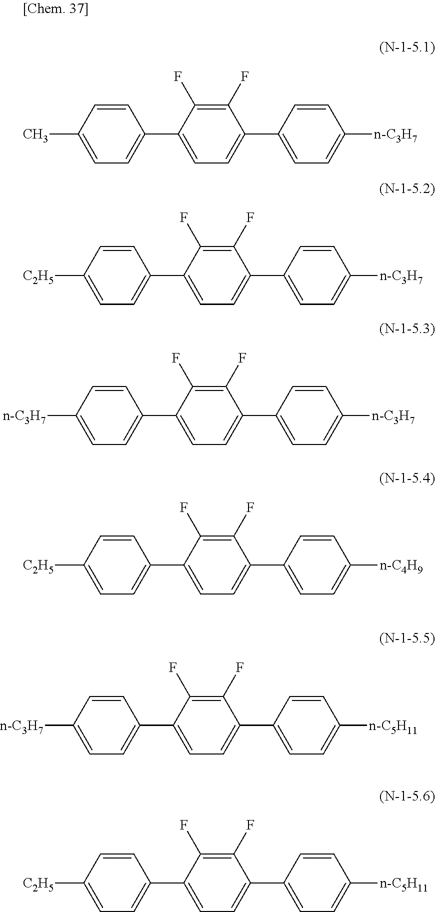

The compounds represented by Formula (N-1-3.2) and Formula (N-1-3.4) can be used alone or in combination, and a lower limit value of the preferable content of the single compound or these compounds with respect to a total amount of the liquid crystal composition of the invention is 5% by mass (hereinafter, the unit, % by mass, is simply referred to as %), 8%, 10%, 13%, 15%, 17%, or 20%. An upper limit value of the preferable content with respect to a total amount of the liquid crystal composition of the invention is 35%, 33%, 30%, 28%, 25%, 23%, 20%, 18%, 15%, or 13%.

The compound represented by General Formula (N-1-10) is the following compound.

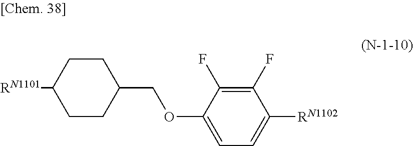

(In the formula, R^{N1101} and R^{N1102} each independently represent the same meaning as those of R^{N11} and R^{N12} of General Formula (N-1).)

R^{N1101} is preferably an alkyl group having 1 to 5 carbon atoms or an alkenyl group having 2 to 5 carbon atoms, and is preferably an ethyl group, a propyl group, or a butyl group. R^{N1102} preferabiy an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-10) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-10) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the composition of the invention is 35%, 30%, 28%, 25%, 23%, 20%, 18%, 15%, or 13%.

The compound represented by General Formula (N-1-10) is preferably a compound selected from a group of compounds represented by Formula (N-1-10.1) to Formula (N-1-10.11), preferably compounds represented by Formulae (N-1-10.1) to (N-1-10.5), and preferably compounds represented by Formula (N-1-10.1) and Formula (N-1-10.2).

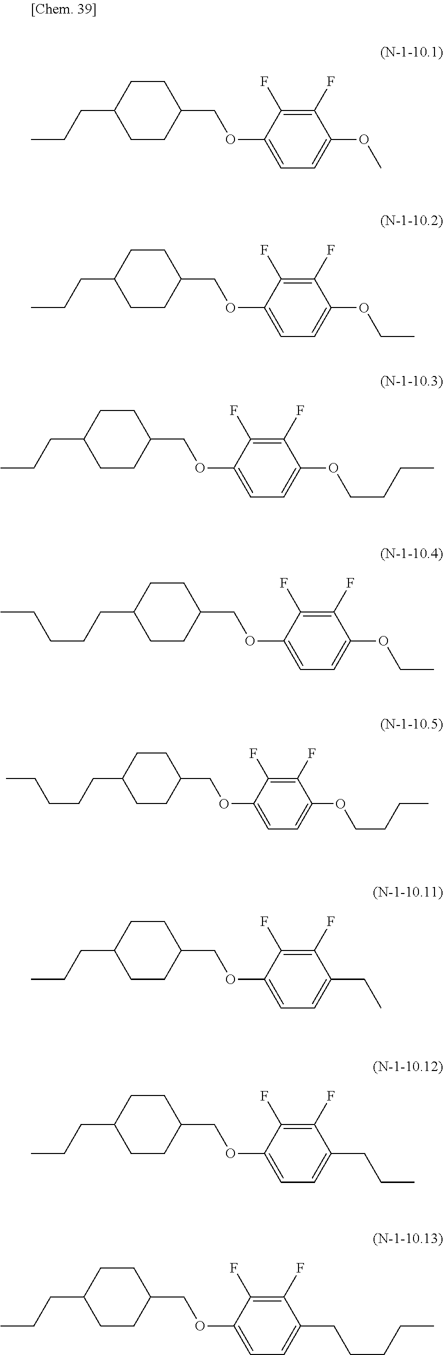

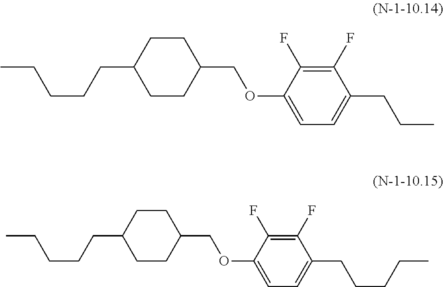

The compounds represented by Formula (N-1-10.1) and Formula (N-1-10.2) can be used alone or in combination, and a lower limit value of the preferable content of the single compound or these compounds with respect to a total amount of the liquid crystal compositions of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-11) is the following compound.

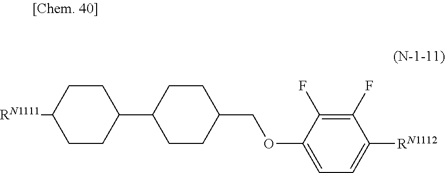

(In the formula, R^{N1111} and R^{N1112} each independently represent the sarae meaning as those of R^{N11} and R^{N12} of General Formula (N-1).)

R^{N1111} is preferably an alkyl group having 1 to 5 carbon atoms or an alkenyl group having 2 to 5 carbon atoms, and is preferably an ethyl group, a propyl group, or a butyl group. R^{N1112} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-11) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-11) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-11) is preferably a compound selected from a group of compounds represented by Formula (N-1-11.1) to Formula (N-1-11.15), preferably compounds represented by Formulae (N-1-11.1) to (N-1-11.15), and preferably compounds represented by Formula (N-1-11.2) and Formula (N-1-11.4).

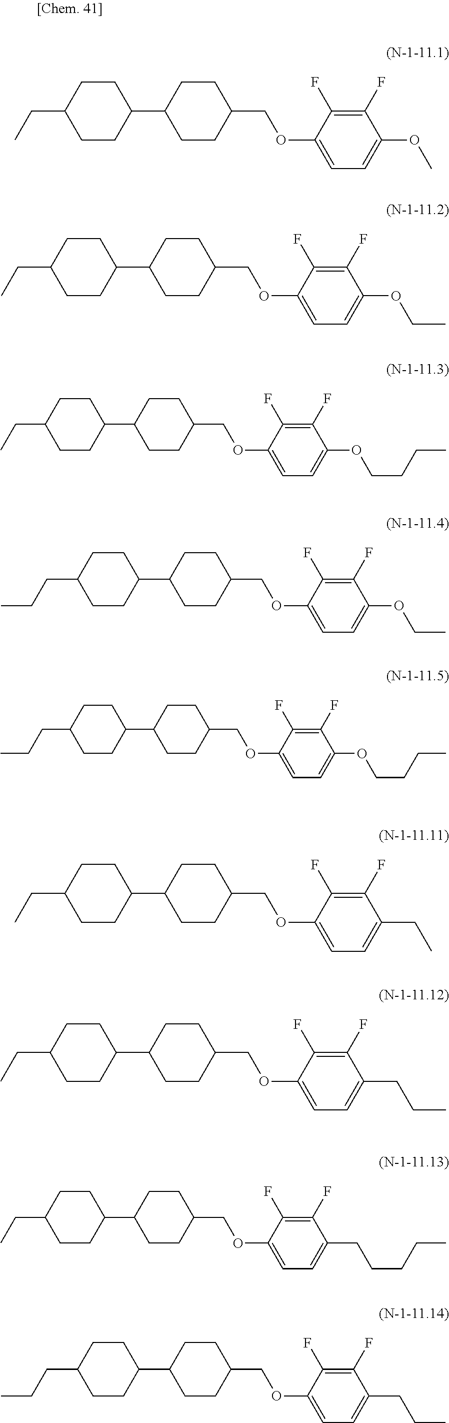

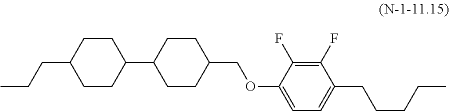

The compounds represented by Formula (N-1-11.2) and Formula (N-1-11.4) can be used alone or in combination, and a lower limit value of the preferable content of the single compound or these compounds with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-12) is the following compound.

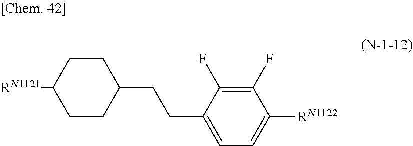

(In the formula, R^{N1121} and R^{N1122} each independently represent the same meaning as those of R^{N11} and R^{N12} of General Formula (N-1).)

R^{N1121} is preferably an alkyl group having 1 to 5 carbon atoms or an alkenyl group having 2 to 5 carbon atoms, and is preferably an ethyl group, a propyl group, or a butyl group. R^{N1122} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-12) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-12) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-13) is the following compound.

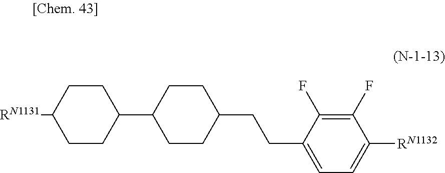

(In the formula, R^{N1131} and R^{N1132} each independently represent the same meaning as those of R^{N11} and R^{N12} of General Formula (N-1).)

R^{N1131} is preferably an alkyl group having 1 to 5 carbon atoms or an alkenyl group having 2 to 5 carbon atoms, and is preferably an ethyl group, a propyl group, or a butyl group. R^{N1132} preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-13) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-13) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-14) is the following compound.

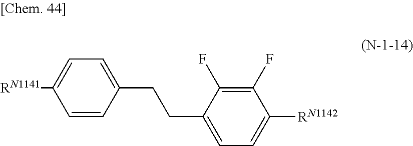

(In the formula, R^{N1141} and R^{N1142} each independently represent the same meaning as those of R^{N11} and R^{N12} of General Formula (N-1).)

R^{N1141} is preferably an alkyl group having 1 to 5 carbon atoms or an alkenyl group having 2 to 5 carbon atoms, and is preferably an ethyl group, a propyl group, or a butyl group. R^{N1142} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-14) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-14) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-15) is the following compound.

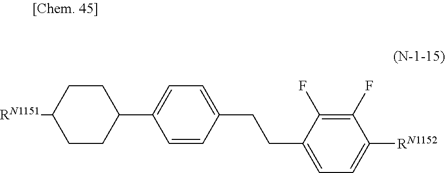

(In the formula, R^{N1151} and R^{N1152} each independently represent the same meaning as those of R^{N11} and R^{N12} of General Formula (N-1).)

R^{N1151} is preferably an alkyl group having 1 to 5 carbon atoms or an alkenyl group having 2 to 5 carbon atoms, and is preferably an ethyl group, a propyl group, or a butyl group. R^{N1152} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-15) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, if is preferable to set a range of the content in the middle.

A lower limit value of the preferable content of the compound represented by Formula (N-1-15) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-16) is the following compound.

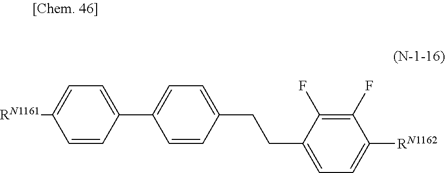

(In the formula, R^{N1161} and R^{N1162} each independently represent the same meaning as those of R^{N11} and R^{N12} of General Formula (N-1).)

R^{N1161} is preferably an alkyl group having 1 to 5 carbon atoms or an alkenyl group having 2 to 5 carbon atoms, and is preferably an ethyl group, a propyl group, or a butyl group. R^{N1162} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-16) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-16) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-17) is the following compound.

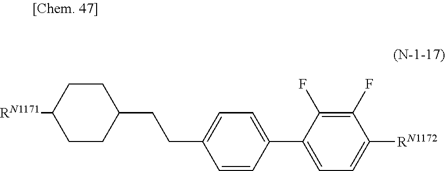

(In the formula, R^{N1171} and R^{N1172} each independently represent the same meaning as those of R^{N11} and R^{N12} of General Formula (H-1).)

R^{N1171} is preferably an alkyl group having 1 to 5 carbon atoms or an alkenyl group having 2 to 5 carbon atoms, and is preferably an ethyl group, a propyl group, or a butyl group. R^{N1172} is preferably an alkyl group having 1 to 5 carbon atoms, an alkenyl group having 4 to 5 carbon atoms, or an alkoxy group having 1 to 4 carbon atoms, and is preferably an ethoxy group, a propoxy group, or a butoxy group.

The compound represented by General Formula (N-1-17) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and: in a case where T_{NI} is important, the effect increases, in a case of setting a great content. In addition, in a case of improving drop marks or burn-in properties, it is preferable to set a range of the content in the middle.

A lower limit value of the preferable content of the compound represented by Formula (N-1-17) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 28%, 25%, 23%, 20%, 18%, 15%, or 13%.

The compound represented by General Formula (N-1-18) is the following compound.

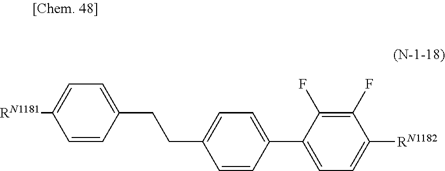

(In the formula, R^{N1181} and R^{N1182} each independently represent the same meaning as those of R^{N11} and R^{N12} of General Formula (N).)

R^{N1181} is preferably an alkyl group having 1 to 5 carbon atoms or an alkenyl group having 2 to 5 carbon atoms, and is preferably an ethyl group, a propyl group, or a butyl group. R^{N1182} is preferably an alkyl group having 1 to 5 carbon atoms, an alkenyl group having 4 or 5 carbon atoms, or an alkoxy group having 1 to 4 carbon atoms, and is preferably an ethoxy group, a propoxy group, or a butoxy group.

The compound represented by General Formula (N-1-18) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where the improvement of Δε is important, it is preferable to set a high content, in a case where solubility at a low temperature is important, the effect increases, in a case of setting a great content, and in a case where T_{NI} is important, the effect increases, in a case of setting a great, content. In addition, in a case of improving drop marks or burn-in properties, it is preferable to set a range of the content in the middle.

A lower limit value of the preferable content of the compound represented by Formula (N-1-18) with respect to a total amount of the liquid crystal composition of the invention is 5% by mass (hereinafter, the unit, % by mass, is simply referred to as %), 10%, 13%, 15%, 17%, or 20%. An upper limit value of the preferable content with respect to a total amount of the liquid crystal composition of the invention is 35%, 30%, 20%, 25%, 23%, 20%, 18%, 15%, or 13%.

The compound represented by General Formula (N-1-20) is the following compound.

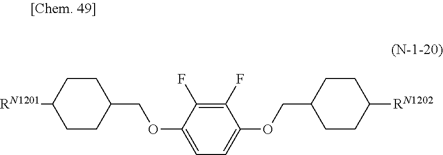

(In the formula, R^{N1201} and R^{N1202} each independently represent the same meaning as those of R^{N11} and R^{N12} of General Formula (N).)

The compound represented by General Formula (N-1-21) is the following compound.

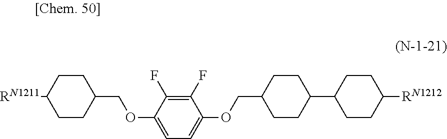

(In the formula, R^{N1211} and R^{N1212} each independently represent the same meaning as those of R^{N11} and R^{N12} of General Formula (N-1).)

The compound represented by General Formula (N-2) is preferably a compound selected from a group of compounds represented by General Formulae (N-2-1) to (N-2-3).

The compound represented by General Formula (N-2-1) is the following compound.

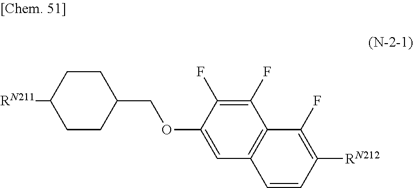

(In the formula, R^{N211} and R^{N212} each independently represent the same meaning as those of R^{N21} and R^{N22} of General Formula (N-2).)

The compound represented by General Formula (N-2-2) is the following compound.

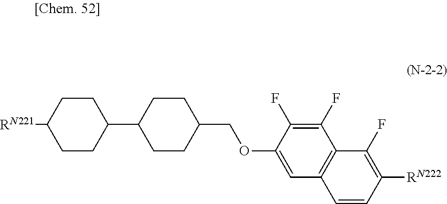

(In the formula, R^{N221} and R^{N222} each independently represent the same meaning as those of R^{N21} and R^{N22} of General Formula (N-2).)

The compound represented by General Formula (N-2-3) is the following compound.

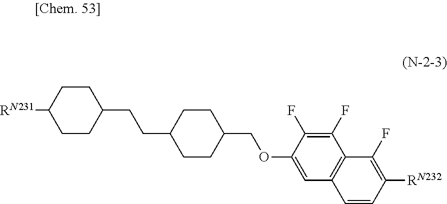

(In the formula, R^{N231} and R^{N232} each independently represent the same meaning as those of R^{N31} and R^{N32} of General Formula (N-3).)

The compound represented by General Formula (N-3) is preferably a compound selected from a group of compounds represented by General Formulae (N-3-1) and (N-3-2).

The compound represented by General Formula (N-3-1) is the following compound.

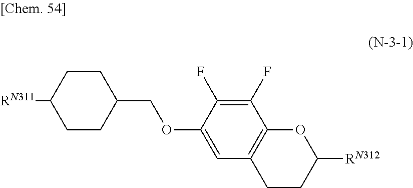

(In the formula, R^{N311} and R^{N312} each independently represent the same meaning as those of R^{N11} and R^{N12} General Formula (N-1).)

The compound represented by General Formula (N-3-2) is the following compound.

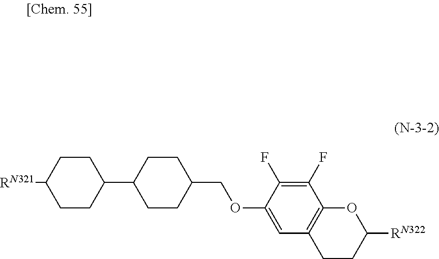

(In the formula, R^{N321} and R^{N322} each independently represent the same meaning as those of R^{N11} and R^{N12} of General Formula (N-1).)

A total amount of contents of the compounds represented by General Formula (N-1), General Formula (N-2), and General Formula (N-3) with respect to a total amount of the liquid crystal composition of the invention (total amount of liquid crystal compounds included in the liquid crystal composition) is preferably 10% to 90% by mass, more preferably 20% to 80% by mass, even more preferably 20% to 70% by mass, still preferably 20% to 60% by mass, still more preferably 20% to 55% by mass, still even more preferably 25% to 55% by mass, and particularly preferably 30% to 55% by mass.

More specifically, a lower limit value of a total amount of contents of the compounds represented by General Formula (N-1), General Formula (N-2), and General Formula (N-3) in the liquid crystal composition is preferably equal to or greater than 1% by mass thereinafter, the unit, % by Mass, is simply referred to as %), preferably equal to or greater than 5%, preferably equal to or greater than 10%, preferably equal to or greater than 13%, preferably equal to or greater than 15%, preferably equal to or greater than 18%, preferably equal to or greater than 20%, preferably equal to or greater than 23%, preferably equal to or greater than 25%, preferably equal to or greater than 28%, preferably equal to or greater than 30%, preferably equal to or greater than 33%, preferably equal to or greater than 35%, preferably equal to or greater than 38%, or preferably equal to or greater than 40%. An upper limit value thereof is preferably equal to or smaller than 95%, preferably equal to or smaller than 90%, preferably equal to or smaller than 88%, preferably equal to or smaller than 85%, preferably equal to or smaller than 83%, preferably equal to or smaller than 80%, preferably equal to or smaller than 78%, preferably equal to or smaller than 75%, preferably equal to or smaller than 73%, preferably equal to or smaller than 70%, preferably equal to or smaller than 68%, preferably equal to or smaller than 65%, preferably equal to or smaller than 63%, preferably equal to or smaller than 60%, preferably equal to or smaller than 55%, preferably equal to or smaller than 50%, or preferably equal to or smaller than 40%.

The liquid crystal composition of the invention preferably includes one or more compounds represented by General Formula (L). The compound represented by General Formula (L) corresponds to a compound which is substantially dieleetrically neutral (value of Δε is −2 to 2)

[Chem 56]

R^{L1}-A^{L1}-Z^{L1}A^{L2}-Z^{L2}ₙ_{^{L1}}A^{L3}-R^{L2} (L)

(In the formula, R^{L1} and R^{L2} each independently represent an alkyl group having 1 to 8 carbon atoms, one —CH₂— or two or more —CH₂—'s not adjacent to each, other in the alkyl group each may be independently substituted with —CH═CH—, —C≡C—, —O—, —CO—, —COO—, or —OCO—, n^{L1} represents 0, 1, 2, or 3, A^{L1}, A^{L2}, and A^{L3} each independently represent, a group selected from the group consisting of (a) a 1,4-cyclohexylene group (wherein one-CH₂— or two or more —CH₂—'s not adjacent to each other present, in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═) the group (a), the group (b), and the group (c) each may be independently substituted with a cyano group, a fluorine atom, or a chlorine atom, Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—, in a case where n^{L1} is 2 or 3 and a plurality of A^{L2}'s are present, these may be the same or different, in a case where n^{L1} is 2 or 3 and a plurality of Z^{L3}'s are present, these may be the same or different, and the compounds represented by General Formula (N-1), General Formula (N-2), and General Formula (N-3) are excluded.)

The compound represented by General Formula (L) may be used alone or can be used in combination. The kinds of the compounds to be combined are not particularly limited, and the compounds are suitably combined and used in accordance with desired properties such as solubility at a low temperature, a transition temperature, electric reliability, or birefringence. The number of kinds of the compounds used is, for example, 1 as one embodiment of the invention. Alternatively, in another embodiment of the invention, the number thereof is 2, 3, 4, 5, 6, 7, 8, 9, or 10 or greater.

In the composition of the invention, it is necessary to suitably adjust a content of the compound represented by General Formula (L) in accordance with properties to be obtained, such as solubility at a low temperature, a transition temperature, electric: reliability, birefringence, process adaptability, drop marks, burn-in, or dielectric anisotropy.

A lower limit value of the preferable content of the compound represented by Formula (L) with respect to a total, amount of the liquid crystal composition of the invention is 1% by mass (hereinafter, the unit, % by mass, is simply referred to as %), 10%, 20%, 30%, 40%, 50%, 55%, 60%, 65%, 70%, 75%, or 80%. An upper limit value of the preferable content is 95%, 85%, 75%, 65%, 55%, 45%, 35%, or 25%.

In a case where a composition which maintains low viscosity of the composition of the invention, and has a high response speed is necessary, it is preferable that the lower limit value is high and the upper limit value is high. In addition, in a case where a composition which maintains high Tni of the composition of the invention and has excellent temperature stability is necessary, it is preferable that, the lower limit value thereof is high and the upper limit value thereof is high. Further, in a case of increasing dielectric anisotropy for maintaining a low driving voltage, it is preferable that the lower limit value is low and the upper limit value is low.

In a case where the reliability is important, both of R^{L1} and R^{L2} are preferably an alkyl group, in a case where a decrease in volatility of the compound is important, an alkoxy group is preferable, and in a case where a decrease in viscosity is important, at least one thereof is preferably an alkenyl group.

In a case where a ring structure for the bonding thereof is a phenyl group (aromatic group), R^{L1} and R^{L2} are preferably a linear alkyl group having 1 to 5 carbon atoms, a linear alkoxy group having 1 to 4 carbon atoms, and an alkenyl group having 4 or 5 carbon atoms, and in a case where a ring structure for the bonding thereof is a saturated ring structure such as cyclohexane, pyran, and dioxane, R^{L1} and R^{L2} are preferably a linear alkyl group having 1 to 5 carbon atoms, a linear alkoxy group having 1 to 4 carbon atoms, and a linear alkenyl group having 2 to 5 carbon atoms. In a case where carbon atoms are present, a total of oxygen atoms is preferably equal to or smaller than 5, and a linear group is preferable, in order to stabilize a nematic phase.

The alkenyl group is preferably selected from the groups represented by any of Formula (R1) to Formula (R5), (A black point in each formula represents a carbon atom in a ring structure.)

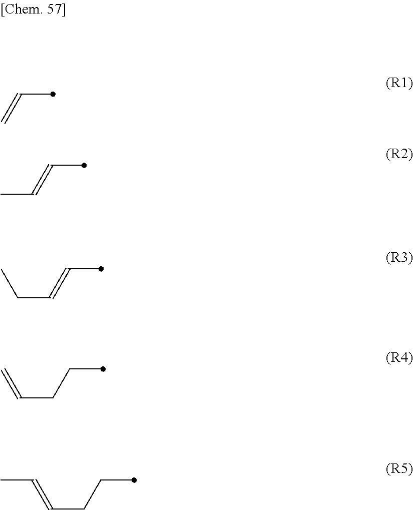

n^{L1} is preferably 0, in a case where a response speed is important, n^{L1} is preferably 2 or 3, in order to improve an upper limit temperature of a nematic phase, and n^{L1} is preferably 1, in order to balance between these. In addition, a combination of compounds having different values is preferable, in order to satisfy properties required as a composition.

A^{L1}, A^{L2}, and A^{L3} are preferably an aromatic group, in a case where it is necessary to increase Δn, and preferably an aliphatic group for response speed improvement, and each preferably independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo [2.2.2] octylene group, a piperidine-1,4-diyl group, a naphthalene-2,6-diyl group, a decahydronaphthalene-2,6-diyl group, or a 1,2,3,4-tetrahydronaphthalene-2,6-diyl group, and more preferably represent the following structures,

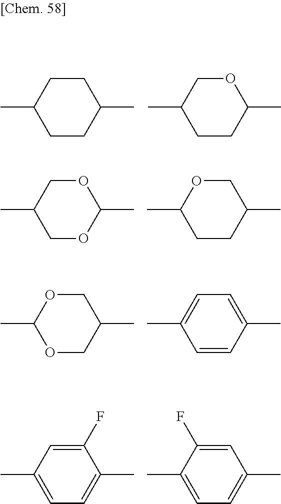

and more preferably represent a trans-1,4-cyclohexylene group or a 1,4-phenylene group.

Z^{L1} and Z^{L2} is preferably a single bond, in a case where a response speed is important.

The compound represented by General Formula (L) is preferably a compound selected from a group of compounds represented by General Formulae (L-1) to (L-7).

The compound represented by General Formula (L-1) is the following compound.

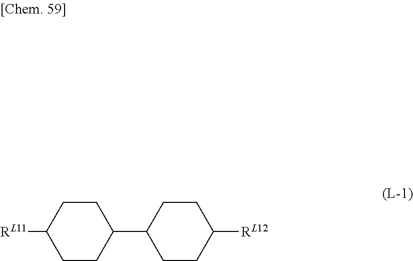

(In the formula, R^{L11} and R^{L12} each independently represent the same meaning as those of R^{L1} and R^{L2} of General Formula (L).)

R^{L11} and R^{L12} preferably a linear alkyl group having 1 to 5 carbon atoms, a linear alkoxy group having 1 to 4 carbon atoms, and an alkenyl group having 2 to 5 carbon atoms.

The compound represented by General Formula (L-1) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

A lower limit value of the preferable content thereof with respect to a total amount of the liquid crystal composition of the invention is 1% by mass (hereinafter, the unit, % by mass, is simply referred to as %), 2%, 3%, 5%, 7%, 10%, 15%, 20%, 25%, 30%, 35%, 40%, 45%, 50%, or 55%. An upper limit value of the preferable content with respect to a total amount of the composition of the invention is 95%, 90%, 85%, 80%, 75%, 70%, 65%, 60%, 55%, 50%, 45%, 40%, 35%, 30%, or 25%.

In a case where a composition which maintains low viscosity of the composition of the invention and has a high response speed is necessary, it is preferable that the lower limit value is high and the upper limit value is high. In addition, in a case where a composition which maintains high Tni of the composition of the invention and has excellent temperature stability is necessary, it is preferable that the lower limit value is medium or the upper limit value is medium. Further, in a case of increasing dielectric anisotropy for maintaining a low driving voltage, it is preferable that the lower limit value is low and the upper limit value is low.

The compound represented by General Formula (L-1) is preferably a compound selected from a group of compounds represented by General Formula (L-1-1).

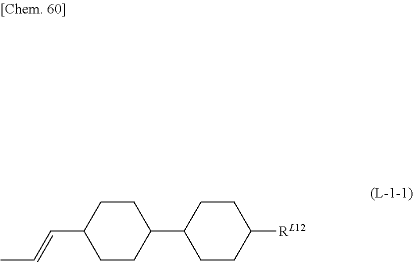

(In the formula, R^{L12} represents the same meaning as the meaning thereof in General Formula (L-1).)

The compound represented by General Formula (L-1-1) is preferably a compound selected from a group of compounds represented by Formula (L-1-1.1) to Formula (L-1-1.3), preferably a compound represented by Formula (L-1-1.2) or Formula (L-1-1.3), and particularly preferably a compound represented by formula (L-1-1.3).

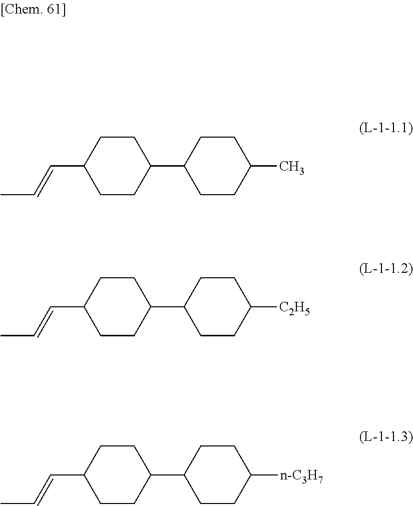

A lower limit value of the preferable content of the compound represented by Formula (L-1-1.3) with respect to a total amount of the liquid crystal composition of the invention is 1% by mass (hereinafter, the unit, % by mass, is simply referred to as %), 2%, 3%, 5%, 7%, or 10%. An upper limit value of the preferable content with respect to a total amount of the composition of the invention is 20%, 15%, 13%, 10%, 8%, 7 %, 6%, 5%, or 3%.

The compound represented by General Formula (L-1) is preferably a compound selected from a group of compounds represented by General Formula (L-1-2).

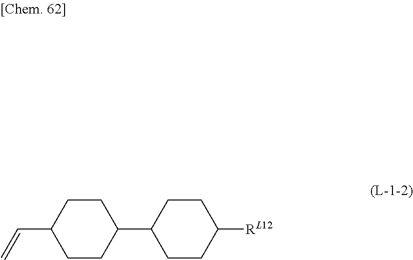

(In the formula, R^{L12} represents the same meaning as the meaning thereof in General Formula (L-1).)

A lower limit value of the preferable content of the compound represented by Formula (L-1-2) with respect to a total amount of the liquid crystal composition of the invention is 1% by mass (hereinafter, the unit, % by mass, is simply referred to as %), 5%, 10%, 15%, 17%, 20%, 23%, 25%, 27%, 30%, or 35%. An upper limit value of the preferable content with respect to a total amount of the composition of the invention is 60%, 55%, 50%, 45%, 42%, 40%, 33%, 35%, 33%, or 30%.

The compound represented by General Formula (L-1-2) is preferably a compound selected from a group of compounds represented by Formula (L-1-2.1) to Formula (L-1-2.4), and preferably compounds represented by Formula (L-1-2.2) to Formula (L-1-2.4). Particularly, a compound represented by Formula (L-1-2.2) is preferable, in order to particularly improve a response speed of the composition of the invention. In addition, in a case of obtaining Tni higher than the response speed, a compound represented by Formula (L-1-2.3) or Formula (L-1-2.4) is preferably used. A content of the compound represented by Formula (L-1-2.3) and Formula (L-1-2.4) is not preferably equal to or greater than 30% by mass, in order to obtain excellent solubility at a low temperature.

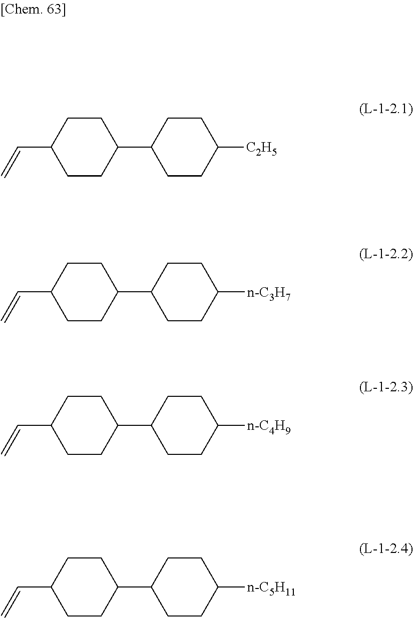

A lower limit value of the preferable content of the compound represented by Formula (L-1-2.2) with respect to a total amount of the liquid crystal composition of the invention is 10% by mass (hereinafter, the unit, % by mass, is simply referred to as %), 15%, 18%, 20%, 23%, 25%, 27%, 30%, 33%, 35%, 38%, or 40%. An upper limit value of the preferable content with respect to a total amount of the composition of the invention is 60%, 55%, 50%, 45%, 43%, 40%, 38%, 35%, 32%, 30%, 27%, 25%, or 22%.

A lower limit value of the preferable content of a total of the compound represented by Formula (L-1-1.3) and the compound represented by Formula (L-1-2.2) with respect to a total amount of the liquid crystal composition of the invention is 10% by mass (hereinafter, the unit, % by mass, is simply referred to as %), 15%, 20%, 25%, 27%, 30%, 35%, or 40%. An upper limit value of the preferable content with respect to a total amount of the composition of the invention is 60%, 55%, 50%, 45%, 43% 40% 38%, 35%, 32%, 30%, 27%, 25%, or 22%.

The compound represented by General Formula (L-1) is preferably a compound selected from a group of compounds represented by General Formula (L-1-3).

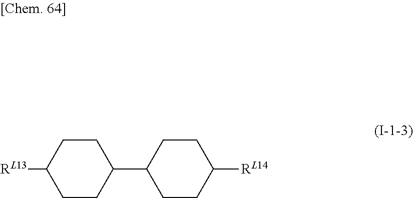

(In the formula, R^{L13} and R^{L14} each independently represent an alkyl group having 1 to 8 carbon atoms or an alkoxy group having 1 to 8 carbon atoms.)

R^{L13} and R^{L14} are preferably a linear alkyl group having 1 to 5 carbon atoms, a linear alkoxy group having 1 to 4 carbon atoms, and a linear alkenyl group having 2 to 5 carbon atoms.

A lower limit value of the preferable content of the compound represented by Formula (L-1-3) with respect to a total amount of the liquid crystal composition of the invention is 1% by mass (hereinafter, the unit, % by mass, is simply referred to as %), 5%, 10%, 13%, 15%, 17%, 20%, 23%, 25%, or 30%. An upper limit value of the preferable content with respect to a total amount of the composition of the invention is 60%, 55%, 50%, 45%, 40%, 37%, 35%, 33%, 30%, 27%, 25%, 23%, 20%, 17%, 15%, 13%, or 10%. The compound represented by General Formula (L-1-3) is preferably a compound selected from a group of compounds represented by Formula (L-1-3.1) to Formula (L-1-3.12), and preferably a compound represented by Formula (L-1-3.1), Formula (L-1-3.3), or Formula (L-1-3.4). Particularly, a compound represented by Formula (L-1-3.1) is preferable, in order to particularly improve a response speed of the composition of the invention. In addition, in a case of obtaining Tni higher than the response speed, compounds represented by Formula (L-1-3.3), Formula (L-1-3.4), Formula (L-1-3.11), and Formula (L-1-3.12) are preferably used. A total content, of the compounds represented by Formula (L-1-3.3), Formula (L-1-3.4), Formula (L-1-3.11), and Formula (L-1-3.12) is not preferably equal to or greater than 20% by mass, in order to obtain excellent solubility at a low temperature.

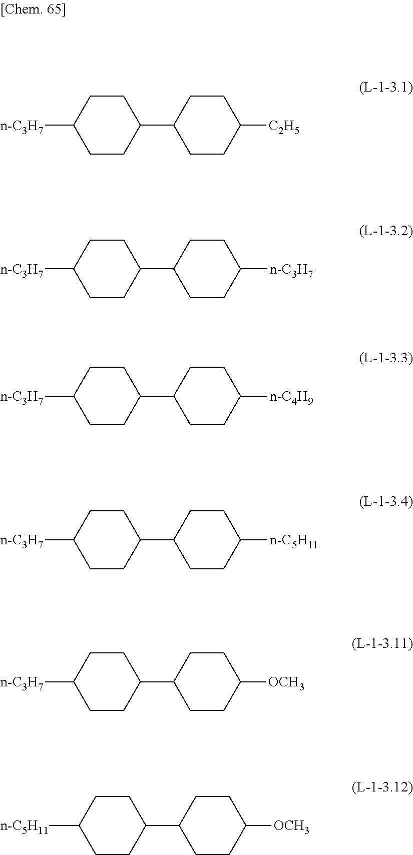

A lower limit value of the preferable content of the compound represented by Formula (L-1-3.1) with respect to a total amount of the liquid crystal composition of the invention is 1% by mass (hereinafter, the unit, % by mass, is simply referred to as %), 2%, 3%, 5%, 7%, 10%, 13%, 15%, 18%, or 20%. An upper limit value of the preferable content with respect to a total amount of the composition of the invention is 20%, 17%, 15%, 13%, 10%, 8%, 7%, or 6%.

The compound represented by General Formula (L-1) is preferably a compound selected from a group of compounds represented by General Formula (L-1-4) and/or (L-1-5).

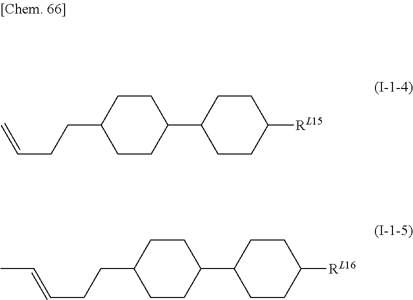

(In the formula, R^{L15} and R^{L16} each independently represent an alkyl group having 1 to 8 carbon atoms or an alkoxy group having 1 to 8 carbon atoms.)

R^{L15} and R^{L16} are preferably a linear alkyl group having 1 to 5 carbon atoms, a linear alkoxy group having 1 to 4 carbon atoms, and a linear alkenyl group having 2 to 5 carbon atoms.

A lower limit value of the preferable content of the compound represented by Formula (L-1-4) with respect to a total amount of the liquid crystal composition of the invention is 1% by mass {hereinafter, the unit, % by mass, is simply referred to as %), 5%, 10%, 13%, 15%, 17%, or 20%. An upper limit value of the preferable content with respect to a total amount of the composition of the invention is 25%, 23%, 20%, 17%, 15%, 13%, or 10%.

A lower limit value of the preferable content of the compound represented by Formula (L-1-5) with respect to a total amount of the liquid crystal composition of the invention is 1% by mass (hereinafter, the unit, % by mass, is simply referred to as %), 5%, 10%, 13%, 15%, 17%, or 20%. An upper limit value of the preferable content with respect to a total amount of the composition of the invention is 25%, 23%, 20%, 17%, 15%, 13%, or 10%.

The compounds represented by General Formulae (L-1-4) and (L-1-5) are preferably a compound selected from a group of compounds represented by Formula (L-1-4.1) to Formula (L-1-5.3), and are preferably a compound represented by Formula (L-1-4.2) or Formula (L-1-5.2).

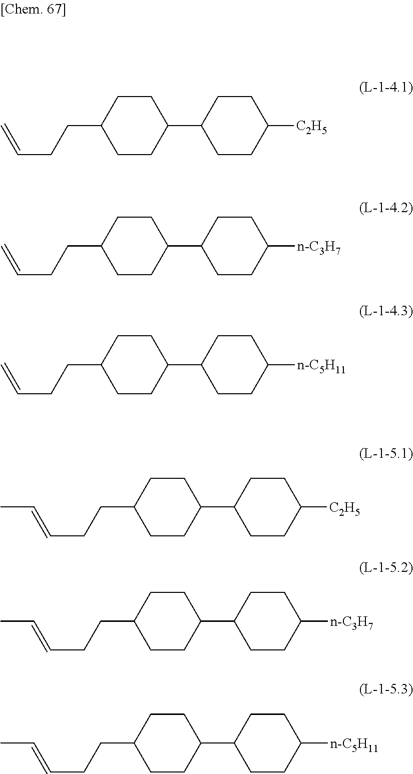

A lower limit value of the preferable content of the compound represented by Formula (L-1-4.2) with respect to a total amount of the liquid crystal composition of the invention is 1% by mass (hereinafter, the unit, % by mass, is simply referred to as %), 2%, 3%, 5%, 7%, 10%, 13%, 15%, 18%, or 20%. An upper limit value of the preferable content with respect to a total amount of the composition of the invention is 20%, 17%, 15%, 13%, 10%, 8%, 7%, or 6%.

A combination of two or more kinds of compounds selected from the compounds represented by Formula (L-1-1.3), Formula (L-1-2.2), Formula (L-1-3.1), Formula (L-1-3.3), Formula (L-1-3.4), Formula (L-1-3.11) and Formula (L-1-3.12) is preferable, and a combination of two or more kinds of compounds selected from the compounds represented by Formula (L-1-1.3), Formula (L-1-2.2), Formula (L-1-3.1), Formula (L-1-3.3), Formula (L-1-3.4), Formula (L-1-4.2) is preferable. A lower limit value of the preferable content of a total content of these compounds with respect to a total amount of the liquid crystal composition of the invention is 1% by mass (hereinafter, the unit, % by mass, is simply referred to as %), 2%, 3%, 5%, 7%, 10%, 13%, 15%, 18%, 20%, 23%, 25%, 27%, 30%, 33%, or 35%, and an upper limit value thereof with respect to a total amount of the liquid crystal composition of the invention is 80%, 70%, 60%, 50%, 45%, 40%, 37%, 35%, 33%, 30%, 28%, 25%, 23%, or 20%. In a case where the reliability of the composition is important, a combination of two or more kinds of compounds selected from the compounds represented by Formula (L-1-3.1), Formula (L-1-3.3), and Formula (L-1-3.4) is preferable, and in a case where a response speed of the composition is important, a combination of two or more kinds of compounds selected from the compounds represented by Formula (L-1-1.3) and Formula (L-1-2.2) is preferable.

The compound represented by General Formula (L-2) is the following compound.

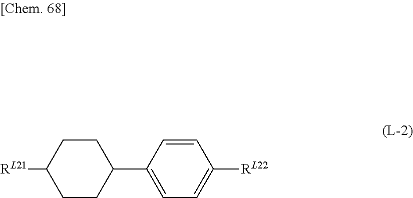

(In the formula, R^{L21} and R^{L22} each independently represent the same meaning as those of R^{L1} and R^{L2} of General Formula (L).)

R^{L21} is preferably an alkyl group having 1 to 5 carbon atoms or an alkenyl group having 2 to 5 carbon atoms, and R^{L22} is preferably an alkyl group having 1 to 5 carbon atoms, an alkenyl group having 4 to 5 carbon atoms, or an alkoxy group having 1 to 4 carbon atoms.

The compound represented by General Formula (L-1) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In a case where solubility at a low temperature is important, the effect increases, in a ca.se of setting a great content. In contrast, in a case where a response speed is important, the effect increases, in a case of setting a small content. In addition, in a case of improving drop marks or burn-in properties, it is preferable to set a range of the content in the middle.

A lower limit value of the preferable content of the compound represented by Formula (L-2) with respect to a total amount of the liquid crystal composition of the invention is 1% by mass (hereinafter, the unit, % by mass, is simply referred to as %), 2%, 3%, 5%, 7%, or 10%. An upper limit value of the preferable content with respect to a total amount of the liquid crystal composition of the invention is 20%, 15%, 13%, 10%, 8%, 7%, 6%, 5%, or 3%.

The compound represented by General Formula (L-2) is preferably a compound selected from a group of compounds represented by Formula (L-2.1) to Formula (L-2.6), and preferably a compound represented by Formula (L-2.1), Formula (L-2.3), Formula (L-2.4), and Formula (L-2.6).

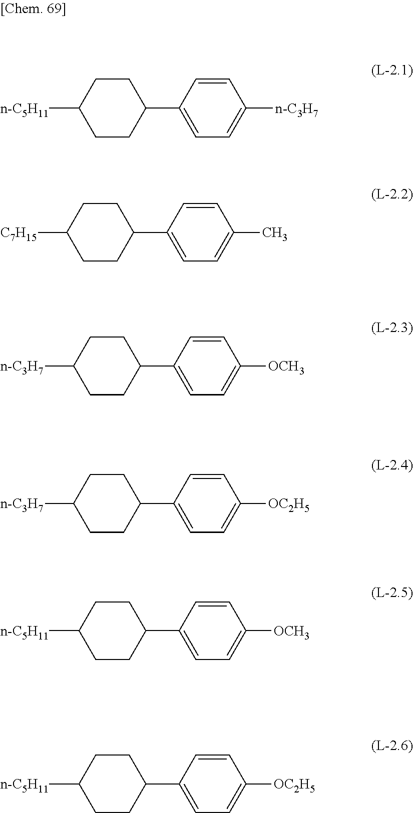

The compound represented by General Formula (L-3) is the following compound.

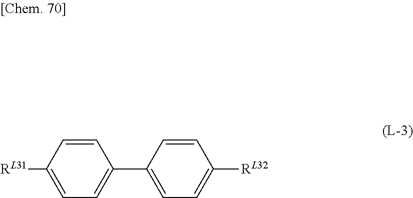

(In the formula, R^{L31} and R^{L32} each independently represent, the same meaning as those of R^{L1} and R^{L2} of General Formula (L).)

R^{L31} and R^{L32} each are preferably independently an alkyl group having 1 to 5 carbon atoms, an alkenyl group having 4 or 5 carbon atoms, or an alkoxy group having 1 to 4 carbon atoms.

The compound represented by General Formula (L-3) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

A lower limit value of the preferable content of the compound represented by Formula (L-3) with respect to a total amount of the liquid crystal composition of the invention is 1% by mass, 2%, 3%, 5%, 7%, or 10%. An upper limit value of the preferable content with respect to a total amount of the liquid crystal composition of the invention is 20%, 15%, 13%, 10%, 8%, 7%, 6%, 5%, or 3%.

In a case of obtaining high birefringence, the effect increases, in a case of setting a great content, and, in contrast, in a case where high Tni is important, the effect increases, in a case of setting a small content. In addition, in a case of improving drop marks or burn-in properties, it is preferable to set a range of the content in the middle.

The compound represented by General Formula (L-3) is preferably a compound selected from a group of compounds represented by Formula (L-3.1) to Formula (L-3.4), and preferably a compound represented by Formula (L-3.2) to Formula (L-3.7).

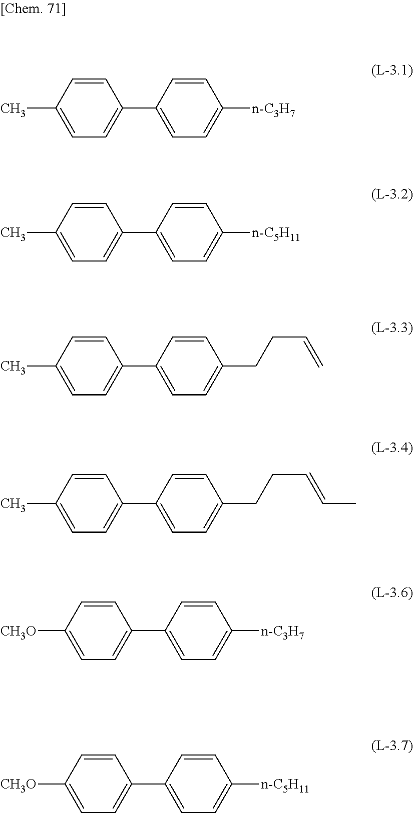

The compound represented by General Formula (L-4) is the following compound.

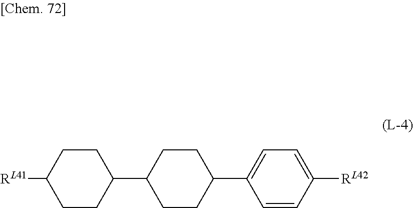

(In the formula, R^{L41} and R^{L42} each independently represent the same meaning as those of R^{L1} and R^{L2} of General Formula (L).)

R^{L41} is preferably an alleyl group having 1 to 5 carbon atoms or an alkenyl group having 2 to 5 carbon atoms, and R^{L42} is preferably an alkyl group having 1 to 5 carbon atoms, an alkenyl group having 4 or 5 carbon atoms, or an alkoxy group having 1 to 4 carbon atoms.)

The compound represented by General Formula (L-4) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment, of the invention.

In the composition of the invention, it is necessary to suitably adjust a content of the compound represented by General Formula (L-4) in accordance with properties to be obtained, such as solubility at a low temperature, a transition temperature, electric reliability, birefringence, process adaptability, drop marks, burn-in, or dielectric anisotropy.

A lower limit value of the preferable content of the compound represented by Formula (L-4) with respect to a total amount of the liquid crystal composition of the invention is 1% by mass (hereinafter, the unit, % by mass, is simply referred to as %), 2%, 3%, 5%, 7%, 10%, 14%, 16%, 20%, 23%, 26%, 30%, 35%, or 40%. An upper limit value of the preferable content of the compound represented by Formula (L-4) with respect to a total amount of the liquid crystal composition of the invention is 50%, 40%, 35%, 30%, 20%, 15%, 10%, or 5%.

The compound represented by General Formula (L-4) is, for example, preferably a compound represented by Formula (L-4.1) to Formula (L-4.3).

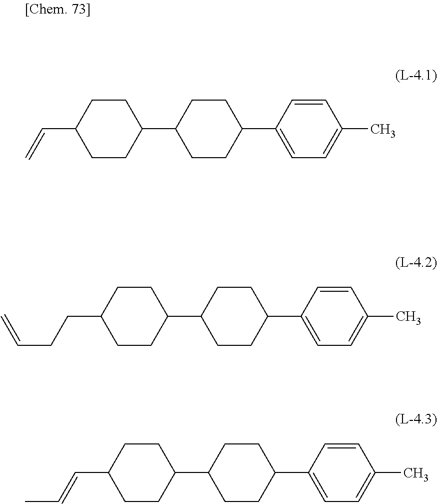

A compound represented by Formula (L-4.1) may be included, a compound represented by Formula (L-4.2) may be included, both of the compound represented by Formula (L-4.1) and the compound represented by Formula (L-4.2) may be included, or all of the compounds represented by Formula (L-4.1) to Formula (L-4.3) may be included, in accordance with required properties such as solubility at a low temperature, a transition temperature, electric reliability, or birefringence. A lower limit value of the preferable content of the compound represented by Formula (L-4.1) or Formula (L-4.2) with respect to a total amount of the liquid crystal composition, of the invention is 3%, 5%, 7%, 9%, 11%, 12%, 13%, 18%, or 21%, and a preferable upper limit value is 45%, 40%, 35%, 30%, 25%, 23%, 20%, 18%, 15%, 13%, 10%, or 8%.

In a case of including both of the compound represented by Formula (L-4.1) and the compound represented by Formula (L-4.2), a lower limit value of the preferable content of both compounds with respect to a total amount of the liquid crystal composition of the invention is 15% by mass (hereinafter, the unit, % by mass, is simply referred to as %), 19%, 24%, or 30%, and a preferable upper limit value is 45%, 40%, 35%, 30%, 25%, 23%, 20%, 13%, 15%, or 13%.

The compound represented by General Formula (L-4) is, for example, preferably compounds represented by Formula (L-4.4) to Formula (L-4.6), and preferably a compound represented by Formula (L-4.4).

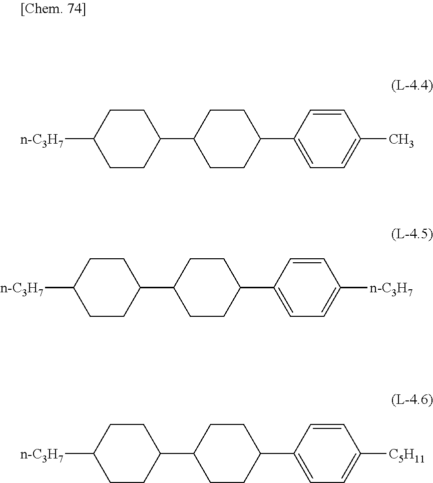

A compound represented by Formula (L-4.4) may be included, a compound represented by Formula (L-4.5) may be included, or both of the compound represented by Formula (L-4.4) and the compound represented by Formula (L-4.5) may be included, in accordance with required properties such as solubility at a low temperature, a transition temperature, electric reliability, or birefringence.

A lower limit value of the preferable content of the compound represented by Formula (L-4.4) or Formula (L-4.5) with respect to a total amount of the liquid crystal composition of the invention is 3% by mass (hereinafter, the unit, % by mass, is simply referred to as %), 5%, 7%, 9%, 11%, 12%, 13%, 18%, or 21%. A preferable upper limit value is 45%, 40%, 35%, 30%, 25%, 23%, 20%, 18%, 15%, 13%, 10%, or 8%.

In a case of including both of the compound represented by Formula (L-4.4) and the compound represented by Formula (L-4.5), a lower limit value of the preferable content of both compounds with respect to a total amount of the liquid crystal composition of the invention is 15% by mass (hereinafter, the unit, % by mass, is simply referred to as %), 19%, 24%, or 30%, and a preferable upper limit value is 45%, 40%, 35%, 30%, 25%, 23%, 20%, 18%, 15%, or 13%.

The compound represented by General Formula (L-4) is, for example, preferably compounds represented by Formula (L-4.7) to Formula (L-4.10), and particularly preferably a compound represented by Formula (L-4.9).

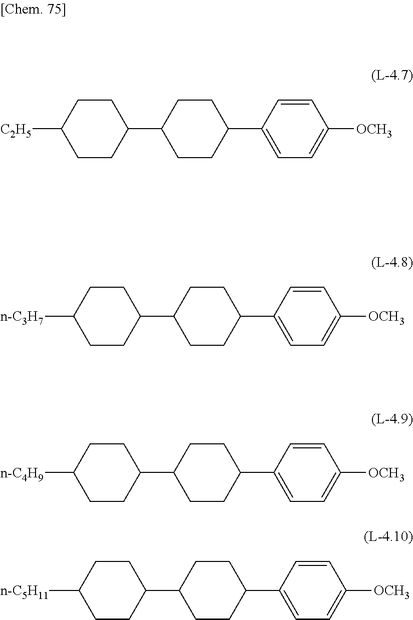

The compound represented by General Formula (L-5) is the following compound.

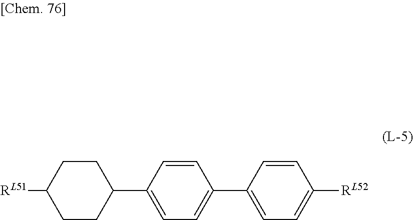

(In the formula, R^{L51} and R^{L52} each independently represent the same meaning as those of R^{L1} and R^{L2} of General Formula (L).)

R^{L51} is preferably an alkyl group having 1 to 5 carbon atoms or an alkenyl group having 2 to 5 carbon atoms, and R^{L52} is preferably an alkyl group having 1 to 5 carbon atoms, an alkenyl group having 4 or 5 carbon atoms, or an alkoxy group having 1 to 4 carbon atoms.

The compound represented by General Formula (L-5) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

In the composition of the invention, it is necessary to suitably adjust a content of the compound represented by General Formula (L-5) in accordance with properties to be obtained, such as solubility at a low temperature, a transition temperature, electric reliability, birefringence, process adaptability, drop marks, burn-in, or dielectric anisotropy.

A lower limit value of the preferable content of the compound represented by Formula (L-5) with respect to a total amount of the liquid crystal composition of the invention is 1% by mass thereinaf ter, the unit, % by mass, is simply referred to as %), 2%, 3%, 5%, 7%, 10%, 14%, 16%, 20%, 23%, 26%, 30%, 35%, or 40%. An upper limit value of the preferable content of the compound represented by Formula (L-5) with respect, to a total amount of the liquid crystal composition of the invention is 50%, 40%, 35%, 30%, 20%, 15%, 10%, or 5%.

The compound represented by General Formula (L-5) is, for example, preferably a compound represented by Formula (L-5.1) or Formula (L-5.2), and particularly preferably a compound represented by Formula (L-5.1).

A lower limit value of the preferable content, of these compounds with respect to a total amount of the liquid crystal composition of the invention is 1% by mass (hereinafter, the unit, % by mass, is simply referred to as %), 2%, 3%, 5%, or 7%. An upper limit value of the preferable content of these compounds is 20%, 15%, 13%, 10%, or 9%.

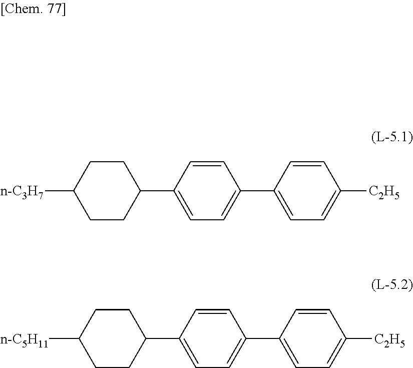

The compound represented by General Formula (L-5) is preferably a compound represented by Formula (L-5.3) or Formula (L-5.4).

A lower limit value of the preferable content of these compounds with respect to a total amount of the liquid crystal composition of the invention is 1% by mass (hereinafter, the unit, % by mass, is simply referred to as %), 2%, 3%, 5%, or 7%. An upper limit value of the preferable content of these compounds is 20%, 15%, 13%, 10%, or 9%.

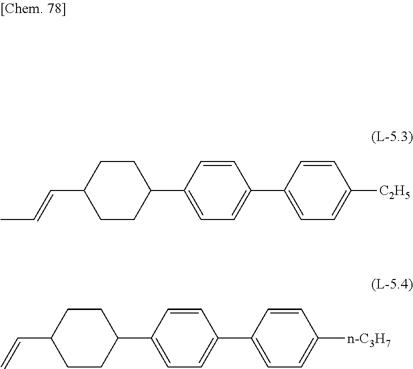

The compound represented by General Formula (L-5) is preferably a compound selected from a group of compounds represented by Formula (L-5.5) to Formula (L-5.7), and particularly preferably a compound represented by Formula (L-5.7).

A lower limit value of the preferable content, of these compounds with respect to a total amount of the liquid crystal composition of the invention is 1% by mass (hereinafter, the unit, % by mass, is simply referred to as %), 2% , 3%, 5%, or 7%. An upper limit value of the preferable content of these compounds is 25%, 15%, 13%, 10%, or 9%.

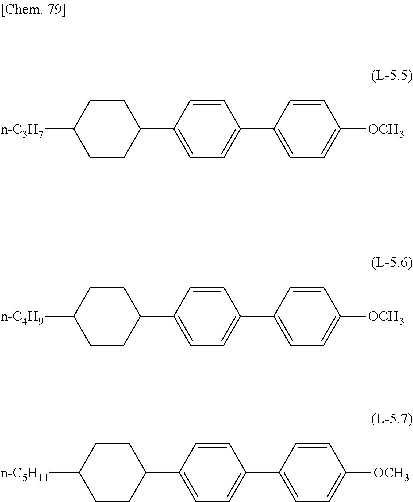

The compound represented by General Formula (L-6) is the following compound.

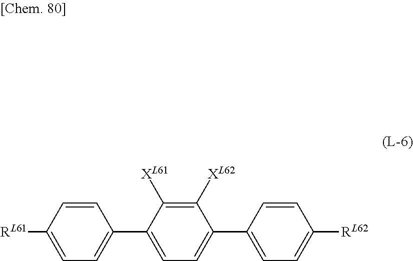

(In the formula, R^{L61} and R^{L62} each independently represent the same meaning as those of R^{L1} and R^{L2} of General Formula (L) and X^{L61} and X^{L62} each independently represent a hydrogen atom or a fluorine atom.)

R^{L61} and R^{L62} each preferably independently represent an alkyl group having 1 to 5 carbon atoms or an alkenyl group having 2 to 5 carbon atoms, one of X^{L61} and X^{L62} is preferably a fluorine atom, and the other is preferably a hydrogen atom.

The compound represented by General Formula (L-6) can also be used alone and two or more compounds can also be used in combination. The kinds of the compounds to be combined are not particularly limited, and the compounds are suitably combined and used in accordance with properties to be obtained, such as solubility at a low temperature, a transition temperature, electric reliability, or birefringence. The number of kinds of the compounds used is, for example, 1, 2, 3, 4, 5, or greater, as one embodiment of the invention.

A lower limit value of the preferable content of the compound represented by Formula (L-6) with respect to a total amount, of the liquid crystal composition of the invention is 1% by mass (hereinafter, the unit, % by mass, is simply referred to as %), 2%, 3%, 5%, 7%, 10%, 14%, 16%, 20%, 23%, 26%, 30%, 35%, or 40%. An upper limit value of the preferable content, of the compound represented by Formula (L-6) with respect to a total amount of the liquid crystal composition of the invention is 50%, 40%, 35%, 30%, 20%, 15%, 10%, or 5%. In a case where an increase in Δn is important, it is preferable to increase the content, and in a case where precipitate at a low temperature is important, it is preferable to decrease the content.

The compound represented by General Formula (L-6) is preferably a compound represented by Formula (L-6.1) to Formula (L-6.9).

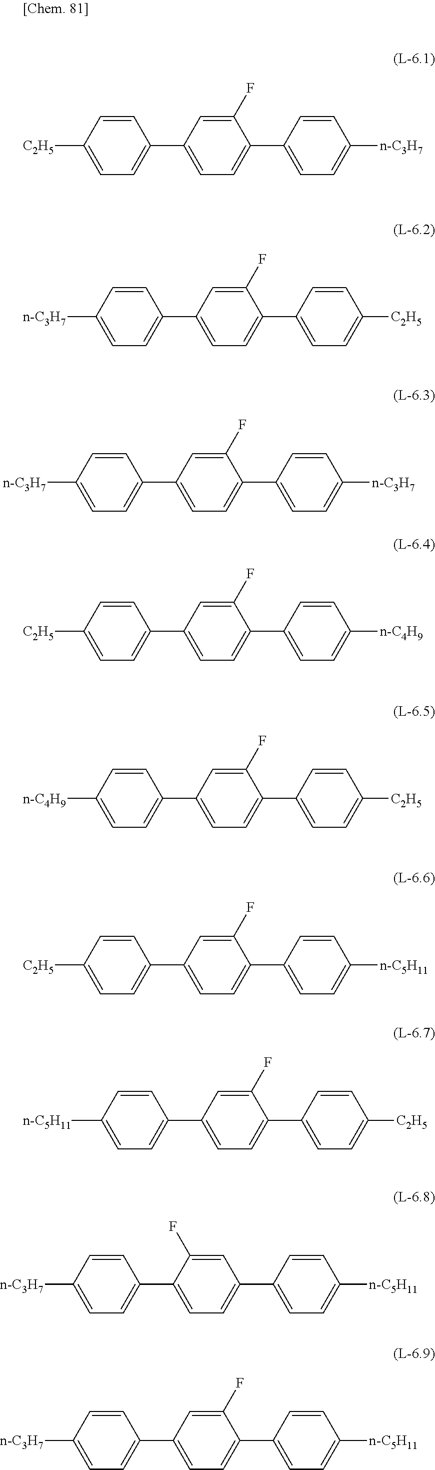

The kinds of the compounds to be combined are not particularly limited, and one to three: kinds from these compounds are preferably included, or one to four kinds thereof are more preferably included. In addition, a wide molecular weight distribution of the compound selected is effective for solubility, and thus, for example, one kind from the compound represented by Formula (L-6.1) or (L-6.2), one kind from the compound represented by Formula (L-6.4) or (L-6.5), one kind from the compound represented by Formula (L-6.6) or (L-6.7), and one kind from the compound represented by Formula (L-6.8) or (L-6.9) are selected, and these are preferably suitably combined. Among these, it is preferable to include compounds represented by Formula (L-6.1), Formula (L-6.3), Formula (L-6.4), Formula (L-6.6), and Formula (L-6.9).

In addition, the compound represented by Formula (L-6) is, for example, preferably compounds represented by Formula (L-6.10) to Formula (L-6.17), and among these, a compound represented by Formula (L-6.11) is preferable.

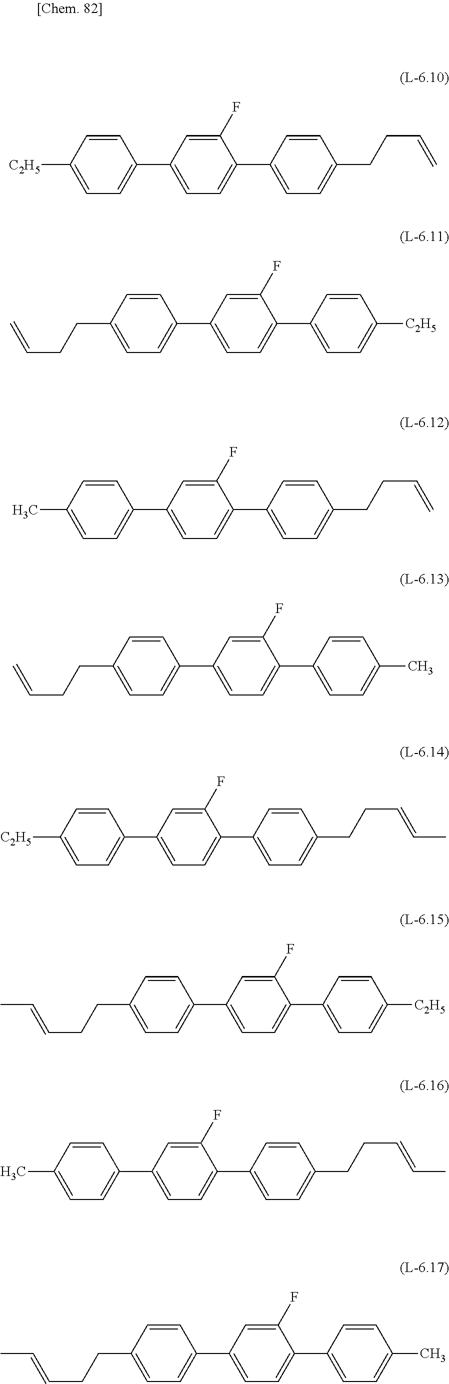

A lower limit value of the preferable content of these compounds with respect to a total amount of the liquid crystal composition of the invention is 1% by mass (hereinafter, the unit, % by mass, is simply referred to as %), 2%, 3%, 5%, or 7%. An upper limit value of the preferable content of these compounds is 20%, 15%, 13%, 10%, or 9%.

The compound represented by General Formula (L-7) is the following compound.

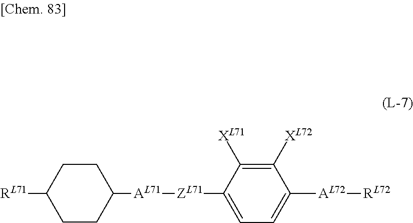

(In the formula, R^{L71} and R^{L72} each independently represent the same meaning as those of R^{L1} and R^{L72} of General Formula (L), A^{L71} and A^{L72} each independently represent the same meaning as those of A^{L2} and A^{L3} of General Formula (L), hydrogen atoms in A^{L71} and A^{L72} each may be independently substituted with a fluorine atom, Z^{L71} represents the same meaning as that of Z^{L2} of General Formula (L), and X^{L71} and X^{L72} each independently represent a fluorine atom or a hydrogen atom.)

In the formula, R^{L71} and R^{L72} each independently represent an alkyl group having 1 to 5 carbon atoms, an alkenyl group having 2 to 5 carbon atoms, or an alkoxy group having 1 to 4 carbon atoms, A^{L71} and A^{L72} each preferably independently represent 1,4-cyclohexylene group or 1,4-phenylene group, hydrogen atoms of A^{L71} and A^{L72} each may be independently substituted with a fluorine atom, Q^{L71} is preferably a single bond or COO— and preferably a single bond, and X^{L71} and X^{L72} are preferably a hydrogen atom.

The kinds of the compounds to be combined are not particularly limited, and the compounds are combined in accordance with properties to be obtained, such as solubility at a low temperature, a transition temperature, electric reliability, or birefringence. The number of kinds of the compounds used is, for example, 1, 2, 3, or 4, as one embodiment, of the invention.

In the composition of the invention, it is necessary to suitably adjust a content of the compound represented by General Formula (L-7) in accordance with properties to be obtained, such as solubility at a low temperature, a transition temperature, electric reliability, birefringence, process adaptability, drop marks, burn-in, or dielectric anisotropy.

A lower limit value of the preferable content of the compound represented by Formula (L-7) with respect to a total amount of the liquid crystal composition of the invention is 1% by mass (hereinafter, the unit, % by mass, is simply referred to as %), 2%, 3%, 5%, 7%, 10%, 14%, 16%, or 20%. An upper limit value of the preferable content of the compound represented by Formula (L-7) with respect to a total amount of the liquid crystal composition of the invention is 30%, 25%, 23%, 20%, 18%, 15%, 10%, or 5%.

In a case where an embodiment in which the composition of the invention has a high Tni is desired, it is preferable to increase a content of the compound represented by Formula (L-7), and in a case where an embodiment in which the composition of the invention has a low viscosity is desired, it is preferable to decrease the content thereof.

The compound represented by General Formula (L-7) is preferably compounds represented by Formula (L-7.1) to Formula (L-7.4) and is preferably a compound represented by Formula (L-7.2).

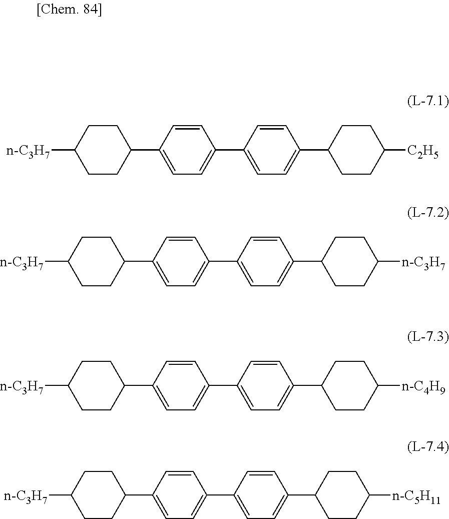

The compound represented by General Formula (L-7) is preferably compounds represented by Formula (L-7.11) to Formula (L-7.13) and is preferably a compound represented by Formula (L-7.11).

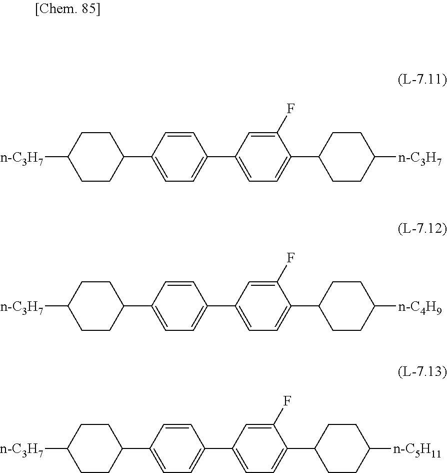

The compound represented by General Formula (L-7) may be each of compounds represented by Formula (L-7.21) to Formula (L-7.23). A compound represented by Formula (L-7.21) is preferable.

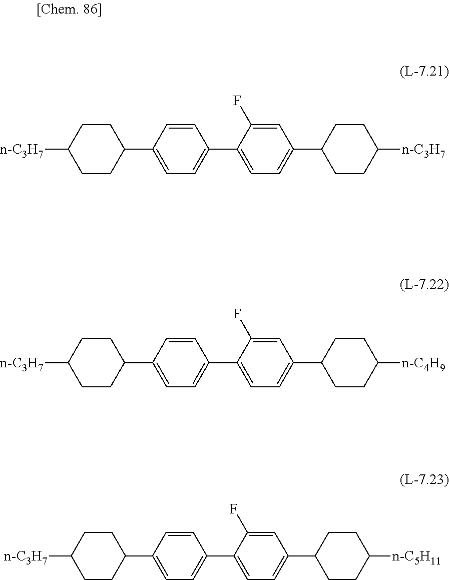

The compound represented by General Formula (L-7) is preferably compounds represented by Formula (L-7.31) to Formula (L-7.34) and is preferably compounds represented by Formula (L-7.31) or/and Formula (L-7.32).

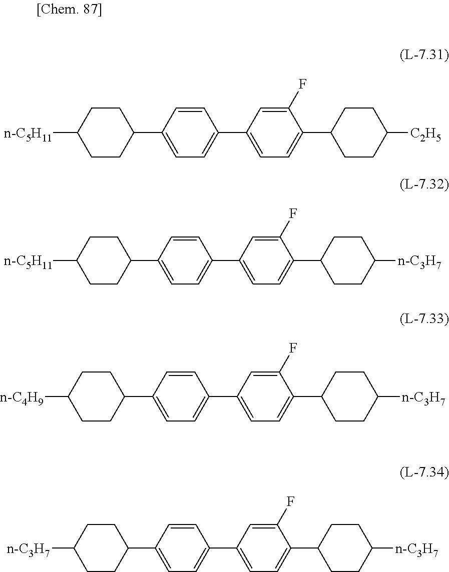

The compound represented by General Formula (L-7) is preferably compounds represented by Formula (L-7.41) to Formula (L-7.44) and is preferably compounds represented by Formula (L-7.41) or/and Formula (L-7.42).

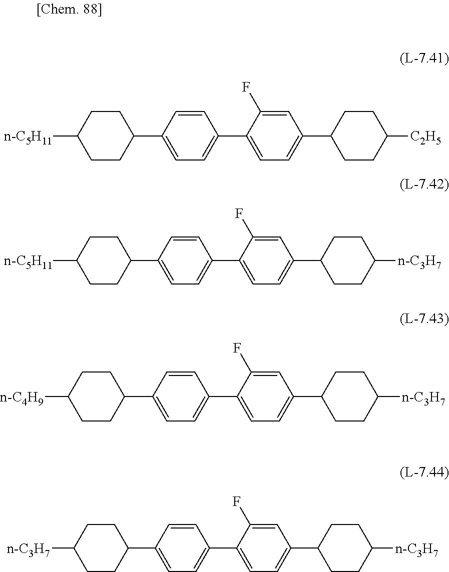

The amount or additives (antioxidant, a UV absorber, and the like) in the liquid crystal composition according to the invention is preferably 100 ppm to 1% by mass.

The liquid crystal composition of the invention can be used with a nematic phase-isotropic liquid phase transition temperature (Tni) in a wide range, and the nematic phase-isotropic liquid phase transition temperature (Tni) is preferably 60° C. to 120° C., more preferably 70° C. to 100° C., and particularly preferably 70° C. to 85° C.

The dielectric anisotropy Δε of the liquid crystal composition of the invention at 25° C. is preferably −2.0 to −6.0, more preferably −2.5 to −5.0, and particularly preferably −2.5 to −3.5.

The refractive index anisotropy Δn of the liquid crystal composition of the invention at 25° C. is preferably 0.08 to 0.13 and more preferably 0.09 to 0.12. More specifically, in a case of dealing with a thin cell gap, the refractive index anisotropy Δn of the liquid crystal composition of the invention at 25° C. is preferably 0.10 to 0.12. Even more specifically, in a case of dealing with a thin cell gap (cell gap equal to or smaller than 3.4 μm), the refractive index anisotropy thereof is preferably approximately 0.9 to 0.12, and in a case of dealing with a thick cell gap (cell gap equal to or greater than 3.5 μm), the refractive index anisotropy thereof is preferably approximately 0.08 to 0.1.

An upper limit value of rotational viscosity (γ₁) of the liquid crystal composition according to the invention is preferably equal to or smaller than 150 (mPa·s), more preferably equal to or smaller than 130 (mPa·s), and particularly preferably equal to or smaller than 120 (mPa·s). On the other hand, a lower limit value of the rotational viscosity (γ₁) is preferably equal to or greater than 20 (mPa·s), more preferably equal to or greater than 30 (mPa·s), even more preferably equal to or greater than 40 (mPa·s), still preferably equal to or greater than 50 (mPa·s), still more preferably equal to or greater than 60 (mPa·s), and particularly preferably equal to or greater than 70 (mPa·s).

In the liquid crystal composition according to the invention, it is preferable that Z as a function of the rotational viscosity and the refractive index anisotropy shows a specific value.

$$Z = \frac{γ 1}{{( Δ n )}^{2}} \qquad [ Expression 1 ]$$

(In the expression, γ₁ represents rotational viscosity and An represents refractive index anisotropy.)

Z is preferably equal to or smaller than 13,000, more preferably equal to or smaller than 12,000, and particularly preferably equal to or smaller than 11,000.

In a case where the liquid crystal composition according to the invention is used in an active matrix display element, specific resistance equal to or greater than 10¹¹ (Ω·m) is necessarily provided, and the specific resistance is preferably 10¹² (Ω·m) and more preferably 10 ¹³ (Ω·m).

The liquid crystal composition of the invention can be used with a nematic: phase-isotropic liquid phase transition temperature (T_{NI}) in a wide range, and the nematic phase-isotropic liquid phase transition temperature (T_{NI}) is preferably 60° C. to 120° C., more preferably 70° C. to 110° C., and particularly preferably 75° C. to 100° C.

[Method for Producing Liquid Crystal Display Element]

Next, a method for producing the liquid crystal display element of the invention will be described with reference to FIG. 1.

The alignment film material including the polymerizable compound having the polymerizable group or the polymerizable liquid crystal compound is applied to the surface of the first substrate 11 where the common electrode 14 is formed and the surface of the second substrate 12 where the pixel electrode 15 is formed, and heated, to form the vertical alignment films 16 and 17. In a case of using the polymerizable liquid crystal compound as the alignment film, a typical alignment film may be provided as a ground alignment film.

Here, first, an alignment film material including a polymer compound precursor which is a first polymer compound, and/or the compound represented by General Formula (V-3), a polymerizable compound such as the compound represented by General Formula (I), and if necessary, compounds represented by General Formula (V-1), General Formula (V-2), and General Formula (V-4), and a photo-polymerizable and photo-crosslinkable compound, or an alignment film material formed of the compound represented by General Formula (I) and the polymerizable liquid crystal compound is prepared.

In a case where the first polymer compound is polyimide, as the polymer compound precursor, a polyimide solution obtained by dissolving or dispersing a mixture of tetracarboxylic acid dianhydride and diisocyanate, polyamic acid, or a polyimide in a solvent is used.

A content of polyimide in the polyimide solution is preferably 1% by mass to 10% by mass and more preferably 3% by mass to 5% by mass.

In a case where the first polymer compound is polysiloxane, as the polymer compound precursor, a polysiloxane solution obtained by mixing a silicon compound having an alkoxy group, a silicon compound having a halogenated alkoxy group, alcohol, and oxalic acid with each other at a predetermined blending amount ratio, heating, the mixture to synthesize polysiloxane, and dissolving polysiloxane in a solvent, is used.

If necessary, a photo-crosslinkable compound, a photopolymerization initiator, a solvent, and the like may be added to the alignment film material.

After preparing the alignment film material, this alignment film material is applied or printed to each of the first substrate 11 and the second substrate 12 so as to cover the common electrode 14, the pixel electrode 15, and the slit portions (not shown) thereof, and heated. Accordingly, the polymer compound precursor and/or the compound represented by General Formula (V-3), or polymerizable liquid crystal compound included in the applied or printed alignment film material is polymerized and cured to become a polymer compound, the polymer compound, the compound represented by General Formula (I), and if necessary, compounds represented by General Formula (V-1), General Formula (V-2), and General Formula (V-4) are mixed, or the polymerizable liquid crystal compound such as the compound represented by General Formula (I) is semi-cured, to form the vertical alignment films 16 and 17.

Here, in a case of performing a heating process, a temperature thereof is preferably equal to or higher than 80° C. and more preferably 150° C. to 200° C.

In this stage, the vertical alignment section to align the liquid crystal molecule in the liquid crystal composition layer in a vertical direction to the substrate surface is formed. After that, a process such as rubbing may be performed, if necessary.

Next, the first substrate 11 and the second substrate 12 are superimposed and the liquid crystal composition layer 13 including liquid crystal molecules is sealed between, these substrates.

Specifically, spacer protrusions for ensuring a cell gap, for example, plastic beads are dispersed with respect to any one surface of the first substrate 11 and the second substrate 12 where the vertical alignment films 16 and 17 are formed, and a sealing portion is printed thereon by using an epoxy adhesive by a screen printing method, for example.

After that, the first substrate 11 and the second substrate 12 are bonded to each other through the spacer protrusions and sealing portion so as to face the vertical alignment films 16 and 17, and the liquid crystal composition including liquid crystal molecules and, if necessary, the polymerizable compound is injected thereto.

Then, heating or the like is performed to cure the sealing portion, and accordingly, the liquid crystal composition is sealed between the first substrate 11 and the second substrate 12.

Next, a voltage is applied between the common electrode 14 and the pixel electrode 15 by using a voltage applying unit. The voltage is applied, for example, at magnitude of 5 to 30 (V). The applying may be performed by applying a charge approximately vertically to the first substrate and the second substrate. Accordingly, an electric field in a direction forming a predetermined angle with respect to the surface of the first substrate 11 adjacent to the liquid crystal composition layer 13 (surface facing the liquid crystal composition layer 13) and the surface of the second substrate 12 adjacent to the liquid crystal composition layer 13 (surface facing the liquid crystal composition layer 13) is generated, and liquid crystal molecules 19 are tilted and aligned in a predetermined direction from the normal direction of the first substrate 11 and the second substrate 12. At this time, an inclined angle of the liquid crystal molecules 19 is substantially equivalent to the pretilt θ applied to the liquid crystal molecules 19 in a step which will be described later. Accordingly, it is possible to control a size of the pretilt θ of the liquid crystal molecules 19 by suitably adjusting the size of the voltage (see FIG. 3).

In addition, in a state where the voltage is applied, ultraviolet light UV is applied to the liquid crystal composition layer 13 from the outer side of the first substrate 11, to polymerize the compound represented by General Formula (I), compounds represented by General Formula (V-1), General Formula (V-2), and General Formula (V-4), or the polymerizable liquid crystal compound in the vertical alignment films 16 and 17, and the polymerizable compound in the liquid crystal composition, and a high molecular weight polymer is generated.

In this case, the intensity of the applied ultraviolet light UV may be or may not be constant, and the irradiation time at each intensity in a case of changing the irradiation intensity is random. In a case of using an irradiation step of two or more stages, the irradiation intensity of the irradiation step after the second stage is preferably intensity weaker than the irradiation intensity of the first stage, and the total irradiation time after the second stage is preferably longer than the irradiation time of the first stage and the total irradiation energy amount is preferably great. In addition, in a case of discontinuously changing the irradiation intensity, an average irradiation light intensity in the first half time of the total irradiation step time is desirably stronger than an average irradiation light intensity in the second half time, it is more desirable that the intensity immediately after starting the irradiation is the strongest, and it is more preferable that the irradiation intensity is constantly continuously decreased to a certain value with the elapse of the irradiation time. The ultraviolet light UV intensity in this case is preferably 2 mW/cm⁻² to 100 mW/cm⁻², and it is more preferable that the highest irradiation intensity in the first stage in a case of multi-stage irradiation, or in the entire irradiation step in a case of discontinuously changing the irradiation intensity is 10 mW/cm⁻² to 100 mW/cm⁻², and the lowest irradiation intensity in the second, stage, in a case, of multi-stage irradiation, or in a case of discontinuously changing the irradiation intensity is 2 mW/cm⁻² to 50 mW/cm⁻². In addition, the total irradiation energy amount is preferably 10 J to 300 J, more preferably 50 J to 250 J, and even more preferably 100 J to 250 J.

In this case, the applied voltage may be alternating current, or direct current.

As a result, by including the alignment control section (not shown) including the vertical alignment film material, fixed to an alignment control unit of the vertical alignment films 16 and 17, the polymer layers 20 and 21 are further formed on the surfaces thereof, if necessary. This alignment control unit has a function (alignment control section) of applying a pretilt θ to the liquid crystal molecules 19 of the liquid crystal composition layer 13 positioning in the vicinity of the boundaries with the polymer layers 20 and 21 (vertical alignment films 16 and 17), in a non-driving state. Here, the ultraviolet light UV is applied from the outer side of the first substrate 11, but may be applied from the outer side of the second substrate 12 or may be applied from the outer side of both of the first substrate 11 and the second substrate 12.

As described above, in the liquid crystal display element of the invention, the liquid crystal molecule 19 has a predetermined pretilt θ in the liquid crystal composition layer 13. Accordingly, compared to a liquid crystal display element which is not subjected to a pretilt process and a liquid crystal display device including the liquid crystal display element, it is possible to significantly improve a response speed with respect to a driving voltage.

In the liquid crystal display element of the invention, a polyimide precursor which does not have photosensitivity is preferable, as the polymer compound precursor configuring the vertical alignment films 16 and 17.

### EXAMPLES

Hereinafter, the invention will be described more specifically with reference to examples and comparative examples, but the invention is not limited to the following examples. “%” in the following examples and comparative examples means “% by mass”.

In the following examples and comparative examples, Tni, Δn, Δε, η, and γ₁ are respectively defined as follows.

Tₙᵢ: nematic phase-isotropic liquid phase transition temperature (° C.)

T_{cn}: solid phase-nematic phase transition temperature (° C.)

Δn: refractive index anisotropy at 25° C.

Δε: dielectric anisotropy at 25° C.

γ₁ rotational viscosity at 25° C. (mPa·s)

K₃₃: elastic constant of bending at 20° C. (pN)

Voltage holding ratio before UV irradiation (initial VHR): frequency of 60 Hz, voltage holding ratio (%) at 343 K under condition of applied voltage of 1 V

VHR after UV irradiation: measured under the same conditions as the VHR measurement method described above, after performing UV irradiation with respect to the liquid crystal display element of the following examples and comparative examples.

In the following examples and comparative examples, burn-in, drop marks, and a pretilt angle of the liquid crystal display element were evaluated by the following methods.

(Burn-In)

The evaluation of the burn-in of the liquid crystal display element was performed by the following four-stage evaluation in which a level of an afterimage of a fixed pattern was visually evaluated, in a case where a predetermined fixed pattern was displayed in a display area for 1,000 hours and the display was evenly performed over the entire screen.

A: No afterimage

B: slight afterimage is observed, but acceptable level

C: afterimage is observed and not acceptable level

D: afterimage is observed and significantly poor state

(Drop Marks)

The evaluation of drop marks of the liquid crystal display device was performed by the following four-stage evaluation in which drop marks appearing in white in a case of black display of the entire screen were visually observed.

A: No afterimage

B: slight afterimage is observed, but acceptable level

C: afterimage is observed and not acceptable level

D: afterimage is observed and significantly poor state

(Pretilt Angle)

Angles of five portions on the surface of the liquid crystal display element were randomly measured, and an average value thereof was set as a pretilt angle. In addition, in a case of evaluating stability of the pretilt angle, a change of the pretilt angles before and after stress was compared. The stress was applied by placing the liquid crystal display device in an oven held at 70° C. and applying square waves at 1 kHz and 30 V for 168 hours.

Pretilt change angle (°): pretilt angle after stress−pretilt angle before stress

For the description of the compounds in the examples, the following abbreviations were used. The letter n represents a natural number.

(Side Chain)

—n: —CₙH₂ₙ₊₁ linear alkyl group having n carbon atoms

n-: CₙH₂ₙ₊₁— linear alkyl group having n carbon atoms

—On: —OCₙH₂ₙ₊₁ linear alkoxyl group having n carbon atoms

nO—: CₙH₂ₙ₊₁O— linear alkoxyl group having n carbon atoms

—V : —CH═CH₂

V—: CH₂═CH—

—V1: —CH═CH—CH₃

1V−: CH₃—CH═CH—

-2V: —CH₂—CH₂—CH═CH₃

V2-: CH₃═CH—CH₂—CH₂—

-2V1: —CH₂—CH₂—CH═CH—CH₃

1V2-: CH₃—CH═CH—CH₂—CH₂

(Linking Group)

-n-: —CₙH₂ₙ—

-nO—: —CₙH₂ₙ—O—

—On-: —O—CₙH₂ₙ—

—COO—: —C(═O)—O—

—OCO—: —O—C(═O)—

—CF2O—: —CF₂—O—

—OCF2-: —O—CF₂—

D: —C═C—

T: —C≡C—

(Ring Structure)

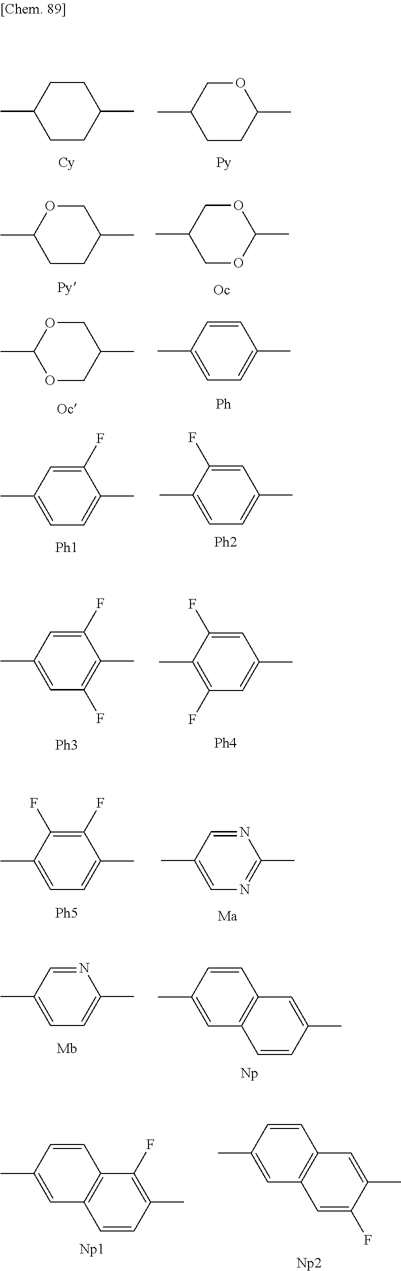

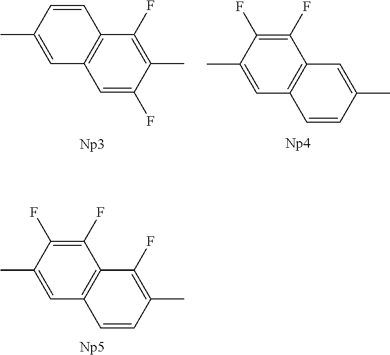

### Example 1

A first substrate provided with a transparent electrode layer formed of a transparent common electrode and a color filter layer (common electrode substrate), and a second substrate provided with a pixel electrode layer including a transparent pixel electrode driven by an active element (pixel electrode substrate) were produced.

In the pixel electrode substrate, as each pixel electrode, etched ITO was used so that a slit not including an electrode is present in the pixel electrode, in order to divide the alignment of the liquid crystal molecules.

The vertical alignment film material including the polyimide precursor and the polymerizable compound having the polymerizable group was applied to each of the common electrode substrate and the pixel electrode substrate by a spin coating method, the coating film was heated at 200° C. to cure the polyimide precursor in the vertical alignment film material, and a vertical alignment film having a thickness of 100 nm±20 nm was formed on the surface of each substrate. In this stage, the polymerizable compound having the polymerizable group in the vertical alignment film is not cured.

A solution obtained by adding 0.4% of a compound represented by Formula (I-10) to a 3% polyimide precursor-containing polyimide solution (product name: JALS 2131-R6, manufactured by JSR Corporation) was used as a vertical alignment film forming material.

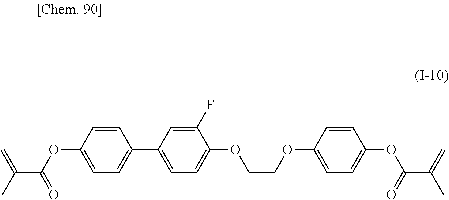 [SMILES: C=C(C)C(=O)Oc1ccc(OCCOc2ccc(-c3ccc(OC(=O)C(=C)C)cc3)cc2F)cc1]

A liquid crystal composition (LC-A) containing the compounds represented by chemical formulae shown in the following table was sandwiched between the common electrode substrate and the pixel electrode substrate, on which the vertical alignment film was formed, and a sealing material was cured, and a liquid crystal composition layer was formed. At this time, the thickness of the liquid crystal composition layer was set as 3.0 μm by using a spacer having a thickness of 3.0 μm.

TABLE 1

| | LC-A |
|---|---|
| 3-Cy-Cy-2 | 3 |
| 3-Cy-Cy-V | 20 |
| 3-Cy-Cy-V1 | 8 |
| 3-Ph-Ph-1 | 10 |
| 3-Cy-Ph-Ph-2 | 6 |
| 5-Cy-Ph-Ph-2 | 2 |
| 3-Cy-1O-Ph5-O2 | 11 |
| 1V-Cy-1O-Ph5-O2 | 3 |
| 3-Ph-2-Ph-Ph5-O2 | 10 |
| 3-Cy-Cy-1O-Ph5-O2 | 13 |
| V-Cy-Cy-1O-Ph5-O2 | 7 |
| 1V-Cy-Cy-1O-Ph5-O2 | 7 |
| Total | 100 |
| Tni [° C.] | 75 |
| Tcn [° C.] | −56 |
| Δn | 0.109 |
| Δε | −3.6 |
| γ₁ [mPa · s] | 117.1 |
| K₃₃ [pN] | 16.9 |
| γ₁/K₃₃ [mPa · s · pN⁻¹] | 6.9 |
| γ₁/Δn² × 10⁻² [mPa · s] | 98 |

The obtained liquid crystal display element was irradiated with ultraviolet light in a state where a rectangular alternating electric field was applied, and the compound represented by Formula (I-1) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 1 was obtained. By this step, the vertical alignment film including the compound represented by Formula (I-1) was formed, and the pretilt angle was applied to the liquid crystal molecules in the liquid crystal composition layer.

Here, the pretilt angle was defined as shown in FIG. 3. In a case of complete vertical alignment, the pretilt angle (θ) is 90°, and in a case where the pretilt angle was applied, the pretilt angle (θ) is smaller than 90°.

The liquid crystal display element of Example 1 had pretilt angles in different directions in four sections according to the slits of the pixel electrode shown in FIG. 2, and the pretilt angles were maintained even in a state where the application of alternating electric field was stopped, after curing of the polymerizable compound.

Various properties of the liquid crystal composition used in the liquid crystal display element of Example 1, the VHRs before and after the UV irradiation, the evaluation of the drop marks of the obtained liquid crystal display element, and the evaluation of the burn-in are shown in Table 2 below. As a result, in the liquid crystal composition used in the liquid crystal display element of Example 1, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 2

| | Example 1 |
|---|---|
| VHR before UV irradiation (%) | 95.3 |
| VHR after UV irradiation (%) | 99.1 |
| Evaluation of drop marks | B |
| Evaluation of burn-in | A |

### Comparative Example 1

A liquid crystal display element of Comparative Example 1 was obtained in the same manner as in Example 1, except that a solution obtained by adding 0.4% of a compound represented by Formula (Va-1-1) to a 3% polyimide precursor-containing polyimide solution (product name: JALS 2131-R6, manufactured by JSR Corporation) was used as a vertical alignment film forming material.

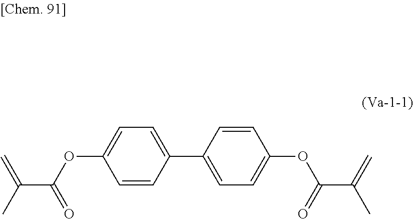 [SMILES: C=C(C)C(=O)Oc1ccc(-c2ccc(OC(=O)C(=C)C)cc2)cc1]

The obtained liquid crystal display element was irradiated with ultraviolet light in a state where a rectangular alternating electric field was applied, and the polymerizable compound having a reactive group in the alignment film was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element, of Comparative Example 1 was obtained. The liquid crystal display element was irradiated with ultraviolet light under the same conditions as those in Example 1 (20 mW for 300 seconds) and the pretilt angle was applied, but the curing of the polymerizable compound having a reactive group in the alignment film was insufficient, the pretilt angle was not stably applied, and thus, it was necessary to perform the irradiation at 20 mW for 600 seconds for holding the pretilt angle.

Various properties of the liquid crystal composition used in the liquid crystal display element of Comparative Example 1, the VHRs before and after the UV irradiation, the evaluation of the drop marks of the obtained liquid crystal display element, and the evaluation of the burn-in are shown in Table 3 below. As a result, since polymerizable compound represented by General Formula (I) is not included in the alignment film material of Comparative Example 1, the total energy amount of the UV irradiation for curing the polymerizable compound having a polymerizable group in the alignment film was increased, and accordingly, a decrease in VHR was observed and a decrease in properties due to the decomposition of the liquid crystal compounds in the liquid crystal composition was confirmed.

TABLE 3

| | Comparative Example 1 |
|---|---|
| VHR before UV irradiation (%) | 99.1 |
| VHR after UV irradiation (%) | 98.5 |
| Evaluation of drop marks | C |
| Evaluation of burn-in | C |

Example 2

A liquid crystal composition (LC-A2) including compounds shown in the following table was prepared, and the liquid crystal composition was used. A liquid crystal display element of Example 2 was obtained under the same conditions as Example 1, except for this.

TABLE 4

| | LC-A2 |
|---|---|
| 3-Cy-Cy-2 | 16 |
| 3-Cy-Cy-4 | 7 |
| 3-Cy-Cy-5 | 4 |
| 3-Ph-Ph-O1 | 3 |
| 5-Ph-Ph-O1 | 3 |
| 5-Ph-Ph-1 | 9 |
| 3-Cy-Cy-Ph-1 | 7 |
| 3-Cy-Cy-Ph-3 | 4 |
| 3-Cy-1O-Ph5-O1 | 6 |
| 3-Cy-1O-Ph5-O2 | 8 |
| 3-Cy-Ph-Ph5-O3 | 7 |
| 3-Cy-Ph-Ph5-O4 | 6 |
| 4-Cy-Ph-Ph5-O3 | 6 |
| 2-Cy-Cy-1O-Ph5-O2 | 6 |
| 3-Cy-Cy-1O-Ph5-O2 | 8 |
| Total | 100 |
| Tni [° C.] | 76 |
| Tcn [° C.] | −32 |
| Δn | 0.102 |
| Δε | −2.9 |
| γ₁ [mPa · s] | 122 |
| K₃₃ [pN] | 13.0 |
| γ₁/K₃₃ [mPa · s · pN⁻¹] | 9.4 |
| γ₁/Δn² × 10⁻² [mPa · s] | 117 |

The obtained liquid crystal display element was irradiated with ultraviolet light in a state where a rectangular alternating electric field was applied, and the compound represented by Formula (I-1) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 2 was obtained. As in Example 1, the liquid crystal display element of Example 2 had pretilt angles, and the pretilt angles were maintained even in a state where the application of alternating electric field was stopped, after curing of the polymerizable compound.

Various properties of the liquid crystal composition used in the liquid crystal display element of Example 2, the VHRs before and after the UV irradiation, the evaluation of the drop marks of the obtained liquid crystal display element, and the evaluation of the burn-in are shown in Table 5 below. As a result, in the liquid crystal composition used in the liquid crystal display element of Example 2, a decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 5

| | Example 2 |
|---|---|
| VHR before UV irradiation (%) | 99.7 |
| VHR after UV irradiation (%) | 99.6 |
| Evaluation of drop marks | A |
| Evaluation of burn-in | A |

### Example 3

A liquid crystal composition (LC-A3) including compounds shown in the following table was prepared, and the liquid crystal composition was used. A liquid crystal display element of Example 3 was obtained under the same conditions as Example 1, except for this.

TABLE 6

| | LC-A3 |
|---|---|
| 3-Cy-Cy-2 | 18 |
| 3-Cy-Cy-4 | 5 |
| 3-Cy-Cy-5 | 4 |
| 3-Ph-Ph-1 | 12 |
| 3-Cy-Ph-Ph-2 | 6 |
| 3-Cy-1O-Ph5-O1 | 4.5 |
| 3-Cy-1O-Ph5-O2 | 10 |
| 2-Cy-Ph-Ph5-O2 | 6 |
| 3-Cy-Ph-Ph5-O2 | 7 |
| 3-Cy-Ph-Ph5-O4 | 8.5 |
| 2-Cy-Cy-1O-Ph5-O2 | 6 |
| 3-Cy-Cy-1O-Ph5-O2 | 13 |
| Total | 100 |
| Tni [° C.] | 75 |
| Tcn [° C.] | −32 |
| Δn | 0.109 |
| Δε | −3.7 |
| γ₁ [mPa · s] | 135 |
| K₃₃ [pN] | 14.0 |
| γ₁/K₃₃ [mPa · s · pN⁻¹] | 9.6 |
| γ₁/Δn² × 10⁻² [mPa · s] | 114 |

The obtained liquid crystal display element was irradiated with ultraviolet light in a state where a rectangular alternating electric field was applied, and the compound represented by Formula (I-1) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 3 was obtained. As in Example 1, the liquid crystal display element of Example 3 had pretilt angles, and the pretilt angles were maintained even in a state where the application of alternating electric field was stopped, after curing of the polymerizable compound.

Various properties of the liquid crystal composition used in the liquid crystal display element of Example 3, the VHRs before and after the UV irradiation, the evaluation of the drop marks of the obtained liquid crystal display element, and the evaluation of the burn-in are shown in Table 7 below. As a result, in the liquid crystal composition used in the liquid crystal display element of Example 3, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 7

| | Example 3 |
|---|---|
| VHR before UV irradiation (%) | 99.3 |
| VHR after UV irradiation (%) | 99.2 |
| Evaluation of drop marks | A |
| Evaluation of burn-in | A |

### Example 4

A liquid crystal composition (LC-A4) including compounds shown in the following table, was prepared, and the liquid crystal composition was used. A solution obtained by adding 0.2% of a compound represented by Formula (I-11) and 0.2% of a compound represented by Formula (V-2-40) to a 3% polyimide precursor-containing polyimide solution (product name: JALS 2131-R6, manufactured by JSR Corporation) was used as a vertical alignment film forming material. A liquid crystal display element of Example 4 was obtained under the same conditions as Example 1, except for this.

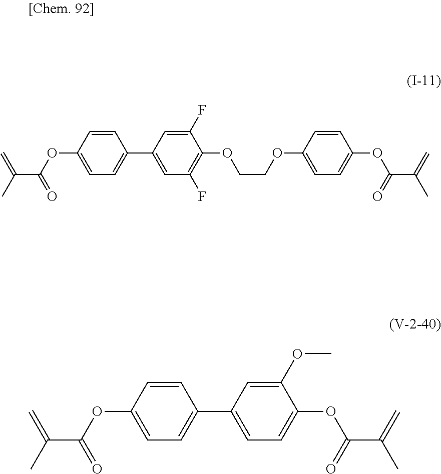

TABLE 8

| | LC-A4 |
|---|---|
| 3-Cy-Cy-V | 39 |
| 3-Ph-Ph-1 | 5 |
| 3-Cy-1O-Ph5-O2 | 9 |
| 2-Cy-Cy-1O-Ph5-O2 | 12.5 |
| 3-Cy-Cy-1O-Ph5-O2 | 13 |
| 4-Cy-Cy-1O-Ph5-O2 | 3.5 |
| 3-Ph-Ph5-Ph-1 | 9 |
| 3-Ph-Ph5-Ph-2 | 9 |
| Total | 100 |
| Tni [° C.] | 75 |
| Tcn [° C.] | −54 |
| Δn | 0.108 |
| Δε | −3.1 |
| γ₁ [mPa · s] | 96 |
| K₃₃ [pN] | 14.3 |
| γ₁/K₃₃ [mPa · s · pN⁻¹] | 6.7 |
| γ₁/Δn² × 10⁻² [mPa · s] | 83 |

The obtained liquid crystal display element was irradiated with ultraviolet light in a state where a rectangular alternating electric field was applied, and the compound represented by Formula (I-1) and the compound represented by Formula (Va-1-1) were cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 4 was obtained. As in Example 1, the liquid crystal display element of Example 4 had pretilt angles, and the pretilt angles were maintained even in a state where the application of alternating electric field was stopped., after curing of the polymerizable e compound.

Various properties of the liquid crystal composition used in the liquid crystal display element of Example 4, the VHRs before and after the UV irradiation, the evaluation of the drop marks of the obtained liquid crystal display element, and the evaluation of the burn-in are shown in Table 9 below. As a result, in the liquid crystal composition used in the liquid crystal display element of Example 4, a great decrease in VHR is not observed before and after the UV irradiation. It is considered that this is because that, since the polymerizable compound represented by General Formula (I) is included in the alignment film material, the total energy amount, of UV irradiation in a case of polymerizing the polymerizable compound having the polymerizable group in the alignment film can be kept low, and thus, decomposition of the liquid crystal compounds configuring the liquid crystal composition can be prevented.

TABLE 9

| | Example 4 |
|---|---|
| VHR before UV irradiation (%) | 99.5 |
| VHR after UV irradiation (%) | 99.1 |
| Evaluation of drop marks | B |
| Evaluation of burn-in | A |

### Example 5

A liquid crystal composition (LC-A5) including compounds shown in the following table was prepared, and the liquid crystal composition was used. A solution obtained by adding 0.5% of a compound represented by Formula (I-4) to a 3% polyimide precursor-containing polyimide solution (product name: JALS 2131-R6, manufactured by JSR Corporation) was used as a vertical alignment film forming material. A liquid crystal display element of Example 5 was obtained under the same conditions as Example 1, except for this.

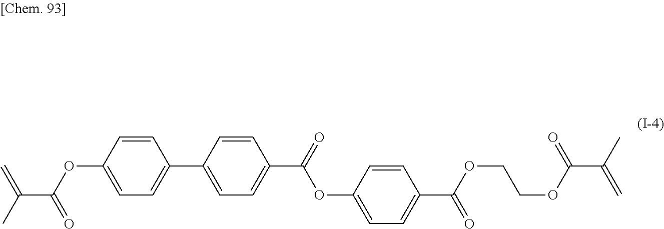 [SMILES: C=C(C)C(=O)OCCOC(=O)c1ccc(OC(=O)c2ccc(-c3ccc(OC(=O)C(=C)C)cc3)cc2)cc1]

TABLE 10

| | LC-A5 |
|---|---|
| 3-Cy-Cy-2 | 4 |
| 2-Cy-Cy-V1 | 20 |
| 3-Cy-Cy-V1 | 8 |
| 3-Ph-Ph-1 | 10 |
| 5-Ph-Ph-1 | 7 |
| 3-Cy-Ph-Ph-2 | 5.5 |
| 1V-Cy-1O-Ph5-O2 | 8 |
| 2-Cy-Cy-1O-Ph5-O2 | 5.5 |
| 3-Cy-Cy-1O-Ph5-O2 | 10 |
| V-Cy-Cy-1O-Ph5-O2 | 10 |
| 1V-Cy-Cy-1O-Ph5-O2 | 10 |
| 3-Np-Ph5-Ph-2 | 2 |
| Total | 100 |
| Tni [° C.] | 75 |
| Tcn [° C.] | −54 |
| Δn | 0.109 |
| Δε | −3.1 |
| γ₁ [mPa · s] | 114 |
| K₃₃ [pN] | 16.2 |
| γ₁/K₃₃ [mPa · s · pN⁻¹] | 7.0 |
| γ₁/Δn² × 10⁻² [mPa · s] | 96 |

The obtained liquid crystal display element was irradiated with ultraviolet light in a state where a rectangular alternating electric field was applied, and the compound represented by Formula (I-21) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 5 was obtained. As in Example 1, the liquid crystal display element of Example 5 had pretilt angles, and the pretilt angles were maintained even in a state where the application of alternating electric field was stopped, after curing of the polymerizable compound.

Various properties of the liquid crystal composition used in the liquid crystal display element of Example 5, the VHRs before and after the UV irradiation, the evaluation of the drop marks of the obtained liquid crystal display element, and the evaluation of the burn-in are shown in Table 11 below. As a result, in the liquid crystal composition used in the liquid crystal display element of Example 5, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 11

| | Example 5 |
|---|---|
| VHR before UV irradiation (%) | 99.2 |
| VHR after UV irradiation (%) | 99.1 |
| Evaluation of drop marks | B |
| Evaluation of burn-in | A |

### Example 6

A liquid crystal composition (LC-A6) including compounds shown in the following table was prepared, and the liquid crystal composition was used. A liquid crystal display element of Example 6 was obtained under the same conditions as Example 5, except for this.

TABLE 12

| | LC-A6 |
|---|---|
| 3-Cy-Cy-V | 26.5 |
| 3-Cy-Cy-V1 | 10 |
| 3-Ph-Ph-1 | 3 |
| 3-Cy-Ph-Ph-2 | 1.5 |
| 3-Cy-1O-Ph5-O1 | 5 |
| 3-Cy-1O-Ph5-O2 | 11 |
| 2-Cy-Cy-1O-Ph5-O2 | 7 |
| 3-Cy-Cy-1O-Ph5-O2 | 12 |
| 1V-Cy-Cy-1O-Ph5-O2 | 7 |
| 3-Ph-Ph5-Ph-1 | 5 |
| 3-Ph-Ph5-Ph-2 | 12 |
| Total | 100 |
| Tni [° C.] | 76 |
| Tcn [° C.] | −40 |
| Δn | 0.109 |
| Δε | −3.7 |
| γ₁ [mPa · s] | 109 |
| K₃₃ [pN] | 15.4 |
| γ₁/K₃₃ [mPa · s · pN⁻¹] | 7.1 |
| γ₁/Δn² × 10⁻² [mPa · s] | 93 |

The obtained liquid crystal display element was irradiated with ultraviolet light in a state where a rectangular alternating electric field was applied, and the compound represented by Formula (I-21) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 6 was obtained. As in Example 5, the liquid crystal display element of Example 6 had pretilt angles, and the pretilt angles were maintained even in a state where the application of alternating electric field was stopped, after curing of the polymerizable compound.

Various properties of the liquid crystal composition used in the liquid crystal display element of Example 6, the VHRs before and after the UV irradiation, the evaluation of the drop marks of the obtained liquid crystal display element, and the evaluation of the burn-in are shown in Table 13 below. As a result, in the liquid crystal composition used in the liquid crystal display element of Example 6, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 13

| | Example 6 |
|---|---|
| VHR before UV irradiation (%) | 99.3 |
| VHR after UV irradiation (%) | 99.1 |
| Evaluation of drop marks | A |
| Evaluation of burn-in | A |

### Example 7

A liquid crystal composition (LC-B) including compounds shown in the following table was prepared, and the liquid crystal composition was used. A solution obtained by adding 0.2% of a compound represented by Formula (I-7) to a 3% polyimide precursor-containing polyimide solution (product name: JALS 2131-R6, manufactured by JSR Corporation) was used as a vertical alignment film forming material. A liquid crystal display element of Example 7 was obtained under the same conditions as Example 1, except for this.

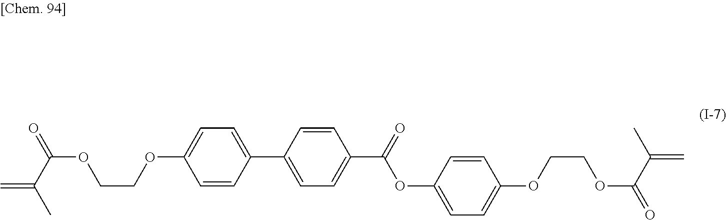 [SMILES: C=C(C)C(=O)OCCOc1ccc(OC(=O)c2ccc(-c3ccc(OCCOC(=O)C(=C)C)cc3)cc2)cc1]

TABLE 14

| | LC-B |
|---|---|
| 3-Cy-Cy-2 | 8 |
| 3-Cy-Cy~4 | 7 |
| 3-Cy-Cy-V | 15 |
| 3-Cy-Cy-V1 | 9.5 |
| 3-Cy-Ph5-O2 | 7 |
| 3-Ph-Ph5-O2 | 16 |
| 3-Cy-Cy-Ph5-O2 | 10 |
| 5-Cy-Cy-Ph5-O2 | 8 |
| 2-Cy-Ph-Ph5-O2 | 3 |
| 3-Cy-Ph-Ph5-O2 | 8.5 |
| 3-Ph-Ph5-Ph-2 | 8 |
| Total | 100 |
| Tni [° C.] | 75 |
| Tcn [° C.] | −25 |
| Δn | 0.109 |
| Δε | −2.9 |
| γ₁ [mPa · s] | 98 |
| K₃₃ [pN] | 14.4 |
| γ₁/K₃₃ [mPa · s · pN⁻¹] | 6.8 |
| γ₁/Δn² × 10⁻² [mPa · s] | 82 |

The obtained liquid crystal display element was irradiated with ultraviolet light in a state where a rectangular alternating electric field was applied, and the compound represented by Formula (I-33) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 7 was obtained. As in Example 1, the liquid crystal display element of Example 7 had pretilt angles, and the pretilt angles were maintained even in a state where the application of alternating electric field was stopped, after curing of the polymerizable compound.

Various properties of the liquid crystal composition used in the liquid crystal display element of Example 7, the VHRs before and after the UV irradiation, the evaluation of the drop marks of the obtained liquid crystal display element, and the evaluation of the burn-in are shown in Table 15 below. As a result, in the liquid crystal composition used in the liquid crystal display element of Example 7, a great decrease in VHR is not observed before and after the UV irradiation. It is considered that this is because that, since the polymerizable compound represented by General Formula (I) is included in the alignment film material, the total energy amount, of UV irradiation in a case of polymerizing the polymerizable compound having the polymerizable group in the alignment, film can be kept low, and thus, decomposition of the liquid crystal compounds configuring the liquid crystal composition can be prevented.

TABLE 15

| | Example 7 |
|---|---|
| VHR before UV irradiation (%) | 99.1 |
| VHR after UV irradiation (%) | 98.9 |
| Evaluation of drop marks | B |
| Evaluation of burn-in | A |

### Comparative Example 2

A liquid crystal display element of Comparative Example 2 was obtained in the same manner as in Example 7, except that a solution obtained by adding 0.2% of a compound represented by Formula (Va-1-1) to a 3% polyimide precursor-containing polyimide solution (product name: JALS 2131-R6, manufactured by JSR Corporation) was used.

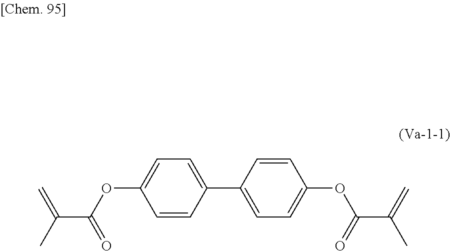 [SMILES: C=C(C)C(=O)Oc1ccc(-c2ccc(OC(=O)C(=C)C)cc2)cc1]

The obtained, liquid crystal display element was irradiated with ultraviolet light in a state where a rectangular alternating electric field was applied, and the polymerizable compound having a reactive group in the alignment film was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Comparative Example 2 was obtained. The liquid crystal display element was irradiated with ultraviolet light under the same conditions as those in Example 7 (20 mW for 300 seconds) and the pretilt angle was applied, but the curing of the polymerizable compound having a reactive group in the alignment film was insufficient, the pretilt angle was not stably applied, and thus, it was necessary to perform the irradiation, at 20 mW for 600 seconds for holding the pretilt angle.

Various properties of the liquid crystal composition used in the liquid crystal display element of Comparative Example 2, the VHRs before and after the UV irradiation, the evaluation of the drop marks of the obtained liquid crystal display element, and the evaluation of the burn-in are shown in Table 16 below. As a result, since polymerizable compound represented by General Formula (I) is not included in the alignment film material of Comparative Example 2, the total energy amount of the UV irradiation for curing the polymerizable compound having a polymerizable group in the alignment film was increased, and accordingly, a decrease in VHR was observed and a decrease in properties due to the decomposition of the liquid crystal compounds in the liquid crystal composition was confirmed.

TABLE 16

| | Comparative Example 2 |
|---|---|
| VHR before UV irradiation (%) | 99.3 |
| VHR after UV irradiation (%) | 98.4 |
| Evaluation of drop marks | C |
| Evaluation of burn-in | D |

### Example 8

A liquid crystal composition (LC-B2) including compounds shown in the following table was prepared, and the liquid crystal composition was used. A liquid crystal display element of Example 8 was obtained under the same conditions as Example 1, except for this.

TABLE 17

| | LC-B2 |
|---|---|
| 3-Cy-Cy-2 | 24 |
| 3-Cy-Cy-4 | 10 |
| 3-Cy-Ph-O1 | 7 |
| 3-Cy-Ph5-O2 | 13 |
| 4-Cy-Cy-Ph5-O2 | 9 |
| 5-Cy-Cy-Ph5-O2 | 5 |
| 2-Cy-Ph-Ph5-O2 | 8.5 |
| 3-Cy-Ph-Ph5-O2 | 8.5 |
| 3-Ph-Ph5-Ph-2 | 7 |
| 4-Ph-Ph5-Ph-2 | 8 |
| Total | 100 |
| Tni [° C.] | 76 |
| Tcn [° C.] | −28 |
| Δn | 0.108 |
| Δε | −2.8 |
| γ₁ [mPa · s] | 112 |
| K₃₃ [pN] | 13.7 |
| γ₁/K₃₃ [mPa · s · pN⁻¹] | 8.2 |
| γ₁/Δn² × 10⁻² [mPa · s] | 96 |

The obtained liquid crystal display element was irradiated with ultraviolet light in a state where a rectangular alternating electric field was applied, and the compound represented by Formula (I-1) was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 8 was obtained. As in Example 1, the liquid crystal display element of Example 8 had pretilt angles, and the pretilt angles were maintained even in a state where the application of alternating electric field was stopped, after curing of the polymerizable compound.

Various properties of the liquid crystal composition used in the liquid crystal display element of Example 8, the VHRs before and after the UV irradiation, the evaluation of the drop marks of the obtained liquid crystal display element, and the evaluation of the burn-in are shown in Table 18 below. As a result, in the liquid crystal composition used in the liquid crystal display element of Example 8, a decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 18

| | Example 8 |
|---|---|
| VHR before UV irradiation (%) | 99.7 |
| VHR after UV irradiation (%) | 99.6 |
| Evaluation of drop marks | A |
| Evaluation of burn-in | A |

### Example 9

A first substrate provided with a transparent electrode layer formed of a transparent common electrode and a color filter layer (common electrode substrate), and a second substrate provided with a pixel electrode layer including a transparent pixel electrode driven by an active element (pixel electrode substrate) were produced.

In the pixel electrode substrate, as each pixel electrode, etched ITO was used so that a slit not including an electrode is present in the pixel electrode, in order to divide the alignment of the liquid crystal molecules.

The vertical alignment film material including the polyimide precursor and the polymerizable compound having the polymerizable group was applied to each of the common electrode substrate and the pixel electrode substrate by a spin coating method, the coating film was heated at 200° C. to cure the polyimide precursor in the vertical alignment film material, and a vertical, alignment film having a thickness of 100 nm was formed on the surface of each substrate. In this stage, the polymerizable compound having the polymerizable group in the vertical alignment film is not cured.

An N-methyl-2-pyrrolidone solution containing 3% of a polyimide derivative represented by the following formula and 0.4% of the polymerizable compound represented by Formula (I-10) was used as a vertical alignment film forming material,

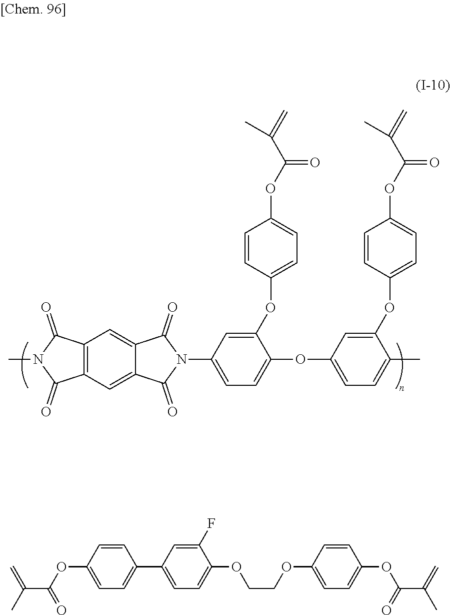

A liquid crystal composition (LC-A) containing the compounds represented by chemical formulae shown in the following table was sandwiched between the common electrode substrate and the pixel electrode substrate, on which the vertical alignment film was formed, and a sealing material was cured, and a liquid crystal composition layer was formed. At this time, the thickness of the liquid crystal composition layer was set as 3.0 μm by using a spacer having a thickness of 3.0 μm.

TABLE 19

| | LC-A |
|---|---|
| 3-Cy-Cy-2 | 3 |
| 3-Cy-Cy-V | 20 |
| 3-Cy-Cy-V1 | 8 |
| 3-Ph-Ph-1 | 10 |
| 3-Cy-Ph-Ph-2 | 6 |
| 5-Cy-Ph-Ph-2 | 2 |
| 3-Cy-1O-Ph5-O2 | 11 |
| 1V-Cy-1O-Ph5-O2 | 3 |
| 3-Ph-2-Ph-Ph5-O2 | 10 |
| 3-Cy-Cy-1O-Ph5-O2 | 13 |
| V-Cy-Cy-1O-Ph5-O2 | 7 |
| 1V-Cy-Cy-1O-Ph5-O2 | 7 |
| Total | 100 |
| Tni [° C.] | 75 |
| Tcn [° C.] | −56 |
| Δn | 0.109 |
| Δε | −3.6 |
| γ₁ [mPa · s] | 117.1 |
| K₃₃ [pN] | 16.9 |
| γ₁/K₃₃ [mPa · s · pN⁻¹] | 6.9 |
| γ1/Δn² × 10⁻² [mPa · s] | 98 |

The obtained liquid crystal display element was irradiated with ultraviolet light in a state where a rectangular alternating electric field was applied, and the polymerizable compound having the reactive group was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 9 was obtained. By this step, the vertical alignment film including a polymer of a polymerizable compound having a polyimide skeleton as a main chain and a polymerizable group as a side chain was formed, and the pretilt angle was applied to the liquid crystal molecules in the liquid crystal composition layer.

The liquid crystal display element of Example 9 had pretilt angles in different directions in four sections according to the slits of the pixel electrode shown in FIG. 2, and the pretilt angles were maintained even in a state where the application of alternating electric field was stopped, after curing of the polymerizable compound.

Various properties of the liquid crystal composition used in the liquid crystal display element of Example 9, the VHRs before and after the UV irradiation, the evaluation of the drop marks of the obtained liquid crystal display element, and the evaluation of the burn-in are shown in Table 20 below. As a result, in the liquid crystal composition used in the liquid crystal display element of Example 9, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 20

| | Example 9 |
|---|---|
| VHR before UV irradiation (%) | 99.3 |
| VHR after UV irradiation (%) | 99.2 |
| Evaluation of drop marks | B |
| Evaluation of burn-in | A |

### Comparative Example 3

A liquid crystal display element of Comparative Example 3 was obtained in the same manner as in Example 9, except that an N-methyl-2-pyrrolidone solution containing 3% of a polyimide derivative represented by the following formula and 0.4% of the polymerizable compound represented by Formula (Va-1-1) was used as a vertical alignment film forming material.

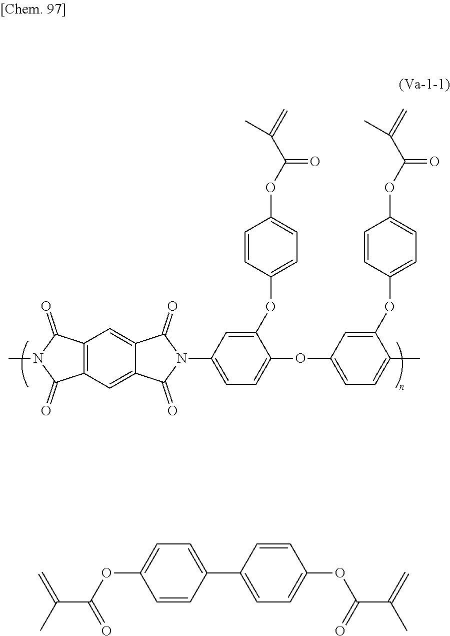

The obtained liquid crystal display element was irradiated with ultraviolet light in a state where a rectangular alternating electric field was applied, and the polymerizable compound having a reactive group in the alignment film was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Comparative Example 3 was obtained. The liquid crystal display element was irradiated with ultraviolet light under the same conditions as those in Example 9 (20 mW for 300 seconds) and the pretilt angle was applied, but the curing of the polymerizable compound having a reactive group in the alignment film was insufficient, the pretilt angle, was not stably applied, and thus, it was necessary to perform the irradiation at 20 mW for 600 seconds for holding the pretilt angle.

Various properties of the liquid crystal composition used in the liquid crystal display element of Comparative Example 3, the VHRs before and after the UV irradiation, the evaluation of the drop marks of the obtained liquid crystal display element, and the evaluation of the burn-in are shown in Table 21 below. As a result, since polymerizable compound represented by General Formula (I) is not included in the alignment film material of Comparative Example 3, the total energy amount of the UV irradiation for curing the polymerizable compound having a polymerizable group in the alignment, film was increased, and accordingly, a decrease in VHR was observed and a decrease in properties due to the decomposition of the liquid crystal compounds in the liquid crystal composition was confirmed.

TABLE 21

| | Comparative Example 3 |
|---|---|
| VHR before UV irradiation (%) | 99.2 |
| VHR after UV irradiation (%) | 97.5 |
| Evaluation of drop marks | D |
| Evaluation of burn-in | C |

### Example 10

A liquid crystal composition (LC-A3) including compounds shown in the following table was prepared, and the liquid crystal composition was used. A liquid crystal display element of Example 10 was obtained under the same conditions as Example 9, except for this.

TABLE 22

| | LC-A3 |
|---|---|
| 3-Cy-Cy-2 | 18 |
| 3-Cy-Cy-4 | 5 |
| 3-Cy-Cy-5 | 4 |
| 3-Ph-Ph-1 | 12 |
| 3-Cy-Ph-Ph-2 | 6 |
| 3-Cy-1O-Ph5-G1 | 4.5 |
| 3-Cy-1O-Ph5-O2 | 10 |
| 2-Cy-Ph-Ph5-O2 | 6 |
| 3-Cy-Ph-Ph5-O2 | 7 |
| 3-Cy-Ph-Ph5-O4 | 8.5 |
| 2-Cy-Cy-1O-Ph5-O2 | 6 |
| 3-Cy-Cy-1O-Ph5-O2 | 13 |
| Total | 100 |
| Tni [° C.] | 75 |
| Tcn [° C.] | −32 |
| Δn | 0.109 |
| Δε | −3.7 |
| γ₁ [mPa · s] | 135 |
| K₃₃ [pN] | 14.0 |
| γ₁/K₃₃ [mPa · s · pN⁻¹] | 9.6 |
| γ₁/Δn² × 10⁻² [mPa · s] | 114 |

The obtained liquid crystal display element was irradiated with ultraviolet light in a state where a rectangular alternating electric field was applied, and the polymerizable compound having the reactive group was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Example 10 was obtained. As in Example, 9, the liquid crystal display element of Example 10 had pretilt angles, and the pretilt angles were maintained even in a state where the application of alternating electric field was stopped, after curing of the polymerizable compound.

Various properties of the liquid crystal composition used in the liquid crystal display element of Example 10, the VHRs before and after the UV irradiation, the evaluation of the drop marks of the obtained liquid crystal display element, and the evaluation of the burn-in are shown in Table 23 below. As a result, in the liquid crystal composition used in the liquid crystal display element of Example 10, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 23

| | Example 10 |
|---|---|
| VHR before UV irradiation (%) | 99.5 |
| VHR after UV irradiation (%) | 99.3 |
| Evaluation of drop marks | A |
| Evaluation of burn-in | A |

### Example 11

A liquid crystal composition (LC-A6) including compounds shown in the following table was prepared, and the liquid crystal composition was used. An N-methyl-2-pyrrolidone solution containing 3% of a polyimide derivative represented by the following formula and 0.4% of the polymerizable compound represented by Formula (I-11) was used as a vertical alignment film forming material. A liquid crystal display element of Example 11 was obtained under the same conditions as Example 9, except for this.

TABLE 24

| | LC-A6 |
|---|---|
| 3-Cy-Cy-V | 26.5 |
| 3-Cy-Cy-V1 | 10 |
| 3-Ph-Ph-1 | 3 |
| 3-Cy-Ph-Ph-2 | 1.5 |
| 3-Cy-1O-Ph5-O1 | 5 |
| 3-Cy-1O-Ph5-O2 | 11 |
| 2-Cy-Cy-1O-Ph5-O2 | 7 |
| 3-Cy-Cy-1O-Ph5-O2 | 12 |
| 1V-Cy-Cy-1O-Ph5-O2 | 7 |
| 3-Ph-Ph5-Ph-1 | 5 |
| 3-Ph-Ph5-Ph-2 | 12 |
| Total | 100 |
| Tni [° C.] | 76 |
| Tcn [° C.] | −40 |
| Δn | 0.109 |
| Δε | −3.7 |
| γ₁ [mPa · s] | 109 |
| K₃₃ [pN] | 15.4 |
| γ₁/K₃₃ [mPa · s · pN⁻¹] | 7.1 |
| γ₁/Δn² × 10⁻² [mPa · s] | 93 |

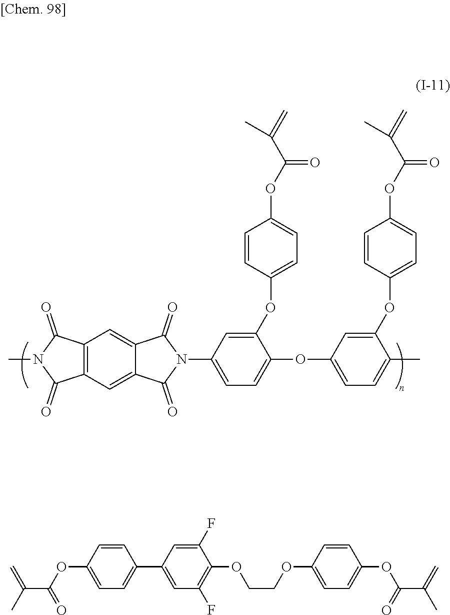

The obtained liquid crystal display element was irradiated with ultraviolet light in a state where a rectangular alternating electric field was applied, and the polymerizable compound having the reactive group was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Example 11 was obtained. As in Example 9, the liquid crystal display element of Example 11 had pretilt angles, and the pretilt angles were maintained even in a state where the application of alternating electric field was stopped, after curing of the polymerizable compound.

Various properties of the liquid crystal composition used in the liquid crystal display element of Example 11, the VHRs before and after the UV irradiation, the evaluation of the drop marks of the obtained liquid crystal display element, and the evaluation of the burn-in are shown in Table 25 below. As a result, in the liquid crystal composition used in the liquid crystal display element of Example 11, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 25

| | Example 11 |
|---|---|
| VHR before UV irradiation (%) | 99.4 |
| VHR after UV irradiation (%) | 99.2 |
| Evaluation of drop marks | A |
| Evaluation of burn-in | B |

### Example 12

A liquid crystal composition (LC-B) including compounds shown in the following table was prepared, and the liquid crystal composition was used. An M-methyl-2-pyrrolidone solution containing 3% of a polyimide derivative represented by the following formula and 0.4% of the polymerizable compound represented by Formula (I-5) was used as a vertical alignment film forming material. A liquid crystal display element of Example 12 was obtained under the same conditions as Example 9, except for this.

TABLE 26

| | LC-B |
|---|---|
| 3-Cy-Cy-2 | 8 |
| 3-Cy-Cy-4 | 7 |
| 3-Cy-Cy-V | 15 |
| 3-Cy-Cy-V1 | 9.5 |
| 3-Cy-Ph5-O2 | 7 |
| 3-Ph-Ph5-O2 | 16 |
| 3-Cy-Cy-Ph5-O2 | 10 |
| 5-Cy-Cy-Ph5-O2 | 8 |
| 2-Cy-Ph-Ph5-O2 | 3 |
| 3-Cy-Ph-Ph5-O2 | 8.5 |
| 3-Ph-Ph5-Ph-2 | 8 |
| Total | 100 |
| Tni [° C.] | 75 |
| Tcn [° C.] | −25 |
| Δn | 0.109 |
| Δε | −2.9 |
| γ₁ [mPa · s] | 98 |
| K₃₃ [pN] | 14.4 |
| γ₁/K₃₃ [mPa · s · pN⁻¹] | 6.8 |
| γ₁/Δn² × 10⁻² [mPa · s] | 82 |

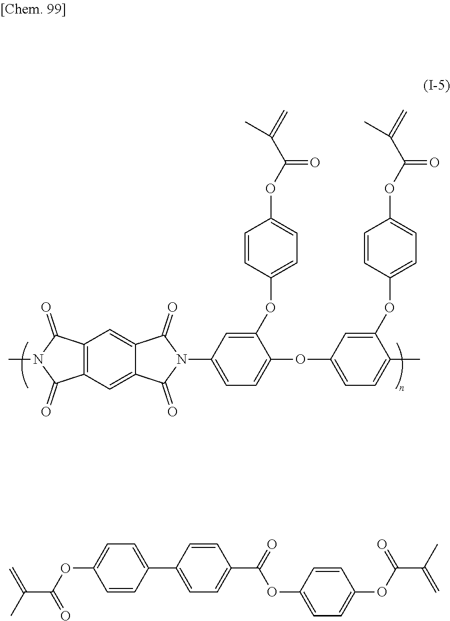

The obtained liquid crystal, display element was irradiated with ultraviolet light in a state where a rectangular alternating electric field was applied, and the polymerizable compound having the reactive group was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Example 12 was obtained. As in Example 9, the liquid crystal display element of Example 12 had pretilt angles, and the pretilt angles were maintained even in a state where the application of alternating electric field was stopped, after curing of the polymerizable compound.

Various properties of the liquid crystal composition used in the liquid crystal display element of Example 12, the VHRs before and after the UV irradiation, the evaluation of the drop marks of the obtained liquid crystal display element, and the evaluation of the burn-in are shown in Table 27 below. As a result, in the liquid crystal composition used in the liquid crystal display element of Example 12, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable compound having the polymerizable group in the alignment film can be kept low, and thus, decomposition of the liquid crystal compounds configuring the liquid crystal composition can be prevented.

TABLE 27

| | Example 12 |
|---|---|
| VHR before UV irradiation (%) | 99.3 |
| VHR after UV irradiation (%) | 99.2 |
| Evaluation of drop marks | A |
| Evaluation of burn-in | A |

### Comparative Example 4

A liquid crystal display element of Comparative Example 4 was obtained in the same manner as in Example 12, except that an N-methyl-2-pyrrolidone solution containing 3% of a polyimide derivative represented by the following formula and 0.4% of the polymerizable compound represented by Formula (Va-1-1) was used as a vertical alignment film forming material.

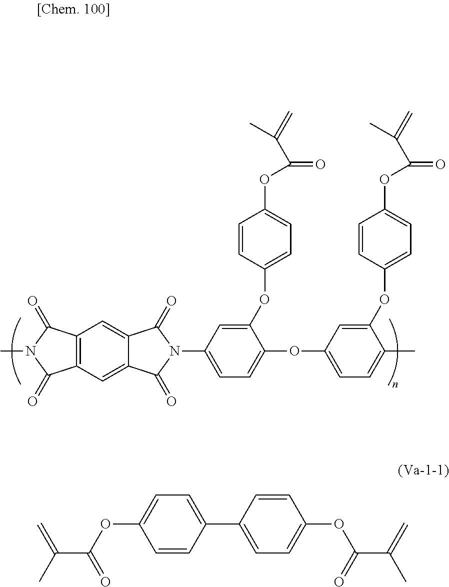

The obtained liquid crystal display element was irradiated with ultraviolet light in a state where a rectangular alternating electric field was applied, and the polymerizable compound having a reactive group in the alignment film was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Comparative Example 4 was obtained. The liquid crystal display element was irradiated with ultraviolet light under the same conditions as those in Example 12 (20 mW for 300 seconds) and the pretilt angle was applied, but the curing of the polymerizable compound having a reactive group in the alignment film was insufficient, the pretilt angle was not stably applied, and thus, it was necessary to perform the irradiation at 20 mW for 600 seconds for holding the pretilt angle.

Various properties of the liquid crystal composition used in the liquid crystal display element of Comparative Example 4, the VHRs before and after the UV irradiation, the evaluation of the drop marks of the obtained liquid crystal display element, and the evaluation of the burn-in are shown in Table 28 below. As a result, since polymerizable compound represented by General Formula (I) is not included in the alignment film material of Comparative Example 4, the total energy amount of the UV irradiation for curing the polymerizable compound having a polymerizable group in the alignment film was increased, and accordingly, a decrease in VHR was observed and a decrease in properties due to the decomposition of the liquid crystal compounds in the liquid crystal composition was confirmed.

TABLE 28

| | Comparative Example 4 |
|---|---|
| VHR before UV irradiation (%) | 99.4 |
| VHR after UV irradiation (%) | 97.9 |
| Evaluation of drop marks | C |
| Evaluation of burn-in | D |

### Example 13

A first substrate provided with a transparent electrode layer formed of a transparent common electrode and a color filter layer (common electrode substrate), and a second substrate provided with a pixel electrode layer including a transparent pixel electrode driven by an active element (pixel electrode substrate) were produced.

The vertical alignment film material including the polymerizable liquid crystal compound and the polymerization initiator was applied to each of the common electrode substrate and the pixel electrode substrate by a spin coating method, and a precursor layer of the vertical alignment film having a thickness of 200 nm was formed. As a vertical alignment film forming material, 3.0% of the polymerizable compound represented by Formula (I-10) and 97.0% of the polymerizable compound UCL-011-K1 (manufactured by DIC Corporation) was used.

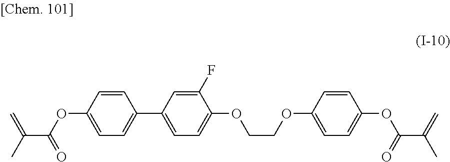 [SMILES: C=C(C)C(=O)Oc1ccc(OCCOc2ccc(-c3ccc(OC(=O)C(=C)C)cc3)cc2F)cc1]

Each of the substrates coated with the vertical alignment film forming material was heated in a thermostat at 70° C. for 15 minutes, and accordingly, the polymerizable liquid crystal compound in the applied vertical alignment film forming material was set as isotropic liquid.

Then, the temperature was decreased to room temperature at a rate of 10° C./min and the alignment of the polymerizable liquid crystal compound in the vertical alignment film forming material was set as vertical alignment.

A magnetic field inclined by 70° from the substrate surfaces was applied to each of the pixel electrode substrate and the common electrode substrate, and the pretilt angle was applied to the polymerizable liquid crystal compound. In this state, the ultraviolet light was applied, so that the polymerizable liquid crystal compound was cured and the vertical alignment film was formed.

A liquid crystal composition (LC-A) containing the compounds represented by chemical formulae shown in the following table was sandwiched between the common electrode substrate and the pixel electrode substrate, on which the vertical alignment film was formed, and a sealing material was cured, and a liquid crystal composition layer was formed. At this time, the thickness of the liquid crystal composition layer was set as 3.0 μm by using a spacer having a thickness of 3.0 μm.

TABLE 29

| | LC-A |
|---|---|
| 3-Cy-Cy-2 | 3 |
| 3-Cy-Cy-V | 20 |
| 3-Cy-Cy-V1 | 8 |
| 3-Ph-Ph-1 | 10 |
| 3-Cy-Ph-Ph-2 | 6 |
| 5-Cy-Ph-Ph-2 | 2 |
| 3-Cy-1O-Ph5-O2 | 11 |
| 1V-Cy-1O-Ph5-O2 | 3 |
| 3-Ph-2-Ph-Ph5-O2 | 10 |
| 3-Cy-Cy-1O-Ph5-O2 | 13 |
| V-Cy-Cy-1O-Ph5-O2 | 7 |
| 1V-Cy-Cy-1O-Ph5-O2 | 7 |
| Total | 100 |
| Tni [° C.] | 75 |
| Tcn [° C.] | −56 |
| Δn | 0.109 |
| Δε | −3.6 |
| γ₁ [mPa · s] | 117.1 |
| K₃₃ [pN] | 16.9 |
| γ₁/K₃₃ [mPa · s · pN⁻¹] | 6.9 |
| γ₁/Δn² × 10⁻² [mPa · s] | 98 |

The obtained liquid crystal display element was irradiated with ultraviolet light in a state where a rectangular alternating electric field was applied, and the polymerizable compound was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 13 was obtained. By this step, the vertical alignment film including the polymer of the polymerizable liquid crystal compound was formed, and the pretilt angle was applied to the liquid crystal molecules in the liquid crystal composition layer.

The liquid crystal display element of Example 13 had pretilt angles in different directions in four sections according to the slits of the pixel electrode shown in FIG. 2, and the pretilt angles were maintained even in a state where the application of alternating electric field was stopped, after curing of the polymerizable liquid crystal compound.

Various properties of the liquid crystal composition used in the liquid crystal display element of Example 13, the VHRs before and after the UV irradiation, the evaluation of the drop marks of the obtained liquid crystal display element, and the evaluation of the burn-in are shown in Table below. As a result, in the liquid crystal composition used in the liquid crystal display element of Example 13, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable liquid crystal compound in the alignment film can be kept low, and thus, decomposition of the liquid crystal compounds configuring the liquid crystal composition can be prevented.

TABLE 30

| | Example 13 |
|---|---|
| VHR before UV irradiation (%) | 99.3 |
| VHR after UV irradiation (%) | 99.2 |
| Evaluation of drop marks | B |
| Evaluation of burn-in | A |

### Comparative Example 5

A liquid crystal display element of Comparative Example 5 was obtained in the same manner as in Example 13, except that 100% of UCL-011-K1 (manufactured by DIC Corporation) was used as the vertical alignment film forming material.

The obtained liquid crystal display element was irradiated with ultraviolet light in a state where a rectangular alternating electric field was applied, and the polymerizable compound was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Comparative Example 5 was obtained. The liquid crystal display element was irradiated with ultraviolet light under the same conditions as those in Example 13 (20 mW for 300 seconds) and the pretilt angle was applied, but the curing of the polymerizable liquid crystal compound in the alignment film was insufficient, the pretilt angle, was not stably applied, and thus, it was necessary to perform the irradiation at 20 mW for 600 seconds for holding the pretilt angle.

Various properties of the liquid crystal composition used in the liquid crystal display element of Comparative Example 5, the VHRs before and after the UV irradiation, the evaluation of the drop marks of the obtained liquid crystal display element, and the evaluation of the burn-in are shown in Table 31 below. As a result, since polymerizable compound represented by General Formula (I) is not included in the alignment film material of Comparative Example 5, the total energy amount of the UV irradiation for curing the polymerizable liquid crystal compound in the alignment film was increased, and accordingly, a decrease in VHR was observed and a decrease in properties due to the decomposition of the liquid crystal compounds in the liquid crystal composition was confirmed.

TABLE 31

| | Comparative Example 5 |
|---|---|
| VHR before UV irradiation (%) | 99.3 |
| VHR after UV irradiation (%) | 98.0 |
| Evaluation of drop marks | D |
| Evaluation of burn-in | D |

### Example 14

A liquid crystal display element of Example 14 was obtained under the same conditions as in Example 13, except that a liquid crystal composition (LC-A3) including compounds shown in the following table was prepared and the liquid crystal composition was used.

TABLE 32

| | LC-A3 |
|---|---|
| 3-Cy-Cy-2 | 18 |
| 3-Cy-Cy-4 | 5 |
| 3-Cy-Cy-5 | 4 |
| 3-Ph-Ph-1 | 12 |
| 3-Cy-Ph-Ph-2 | 6 |
| 3-Cy-1O-Ph5-O1 | 4.5 |
| 3-Cy-1O-Ph5-O2 | 10 |
| 2-Cy-Ph-Ph5-O2 | 6 |
| 3-Cy-Ph-Ph5-O2 | 7 |
| 3-Cy-Ph-Ph5-O4 | 8.5 |
| 2-Cy-Cy-1O-Ph5-O2 | 6 |
| 3-Cy-Cy-1O-Ph5-O2 | 13 |
| Total | 100 |
| Tni [° C.] | 75 |
| Tcn [° C.] | −32 |
| Δn | 0.109 |
| Δε | −3.7 |
| γ₁ [mPa · s] | 135 |
| K₃₃ [pN] | 14.0 |
| γ₁/K₃₃ [mPa · s · pN⁻¹] | 9.6 |
| γ₁/Δn² × 10⁻² [mPa · s] | 114 |

The obtained liquid crystal display element was irradiated with ultraviolet light in a state where a rectangular alternating electric field was applied, and the polymerizable compound was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 14 was obtained. As in Example 13, the liquid crystal display element of Example 14 had pretilt angles, and the pretilt angles were maintained even in a state where the application or alternating electric field was stopped, after curing of the polymerizable compound.

Various properties of the liquid crystal composition used in the liquid crystal display element of Example 14, the VHRs before and after the UV irradiation, the evaluation of the drop marks of the obtained liquid crystal display element, and the evaluation of the burn-in are shown in Table 33 below. As a result, in the liquid crystal composition used in the liquid crystal display element of Example 14, a great decrease in VHR is not observed before and after the UV irradiation. It is considered that this is because that, since the polymerizable compound represented by General Formula (I) is included in the alignment film material, the total energy amount, of UV irradiation in a case of polymerizing the polymerizable liquid crystal compound in the alignment film can be kept low, and thus, decomposition of the liquid crystal compounds configuring the liquid crystal composition can be prevented.

TABLE 33

| | Example 14 |
|---|---|
| VHR before UV irradiation (%) | 99.2 |
| VHR after UV irradiation (%) | 99.1 |
| Evaluation of drop marks | A |
| Evaluation of burn-in | A |

### Example 15

A liquid crystal composition (LC-A6) including compounds shown in the following table was prepared, and the liquid crystal composition was used. As a vertical alignment film forming material, 3.0% of the polymerizable compound represented by Formula (I-4) and 97.0% of the polymerizable compound UCL-011-K1 (manufactured by DIC Corporation) was used. A liquid crystal display element of Example 15 was obtained under the same conditions as Example 13, except for this.

TABLE 34

| | LC-A6 |
|---|---|
| 3-Cy-Cy-V | 26.5 |
| 3-Cy-Cy-V1 | 10 |
| 3-Ph-Ph-1 | 3 |
| 3-Cy-Ph-Ph-2 | 1.5 |
| 3-Cy-1O-Ph5-O1 | 5 |
| 3-Cy-1O-Ph5-O2 | 11 |
| 2-Cy-Cy-1O-Ph5-O2 | 7 |
| 3-Cy-Cy-1O-Ph5-O2 | 12 |
| 1V-Cy-Cy-1O-Ph5-O2 | 7 |
| 3-Ph-Ph5-Ph-1 | 5 |
| 3-Ph-Ph5-Ph-2 | 12 |
| Total | 100 |
| Tni [° C.] | 76 |
| Tcn [° C.] | −40 |
| Δn | 0.109 |
| Δε | −3.7 |
| γ₁ [mPa · s] | 109 |
| K₃₃ [pN] | 15.4 |
| γ₁/K₃₃ [mPa · s · pN⁻¹] | 7.1 |
| γ₁/Δn² × 10⁻² [mPa · s] | 93 |

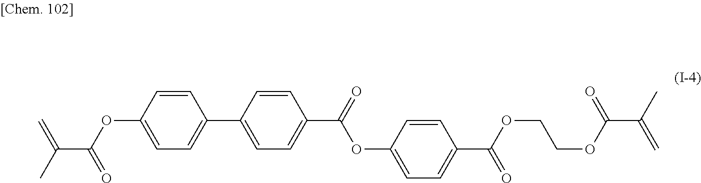 [SMILES: C=C(C)C(=O)OCCOC(=O)c1ccc(OC(=O)c2ccc(-c3ccc(OC(=O)C(=C)C)cc3)cc2)cc1]

The obtained liquid crystal display element was irradiated with ultraviolet light in a state where a rectangular alternating electric field was applied, and the polymerizable compound was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 15 was obtained. As in Example, 13, the liquid crystal display element of Example 15 had pretilt angles, and the pretilt angles were maintained even in a state where the application of alternating electric field was stopped, after curing of the polymerizable compound.

Various properties of the liquid crystal composition used in the liquid crystal display element of Example 15, the VHRs before and after the UV irradiation, the evaluation of the drop marks of the obtained liquid crystal display element, and the evaluation of the burn-in are shown in Table 35 below. As a result, in the liquid crystal composition used in the liquid crystal display element of Example 15, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable liquid crystal compound in the alignment film can be kept low, and thus, decomposition of the liquid crystal compounds configuring the liquid crystal composition can be prevented.

TABLE 35

| | Example 15 |
|---|---|
| VHR before UV irradiation (%) | 99.2 |
| VHR after UV irradiation (%) | 99.0 |
| Evaluation of drop marks | B |
| Evaluation of burn-in | A |

### Example 16

A liquid crystal composition (LC-B) including compounds shown in the following table was prepared, and the liquid crystal composition was used.

As a vertical alignment film forming material, 3.0% of the polymerizable compound represented by Formula (I-22) and 97.0% of the polymerizable compound UCL-011-K1 (manufactured by DIC Corporation) was used. A liquid crystal display element of Example 16 was obtained under the same conditions as Example 13, except for this.

TABLE 36

| | LC-B |
|---|---|
| 3-Cy-Cy-2 | 8 |
| 3-Cy-Cy-4 | 7 |
| 3-Cy-Cy-V | 15 |
| 3-Cy-Cy-V1 | 9.5 |
| 3-Cy-Ph5-O2 | 7 |
| 3-Ph-Ph5-O2 | 16 |
| 3-Cy-Cy-Ph5-O2 | 10 |
| 5-Cy-Cy-Ph5-O2 | 8 |
| 2-Cy-Ph-Ph5-O2 | 3 |
| 3-Cy-Ph-Ph5-O2 | 8.5 |
| 3-Ph-Ph5-Ph-2 | 8 |
| Total | 100 |
| Tni [° C.] | 75 |
| Tcn [° C.] | −25 |
| Δn | 0.109 |
| Δε | −2.9 |
| γ₁ [mPa· s] | 98 |
| K₃₃ [pN] | 14.4 |
| γ₁/K₃₃ [mPa · s · pN⁻¹] | 6.8 |
| γ₁/Δn² × 10⁻² [mPa · s] | 82 |

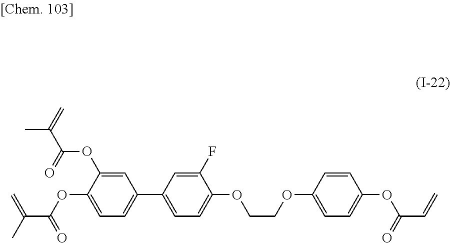 [SMILES: C=CC(=O)Oc1ccc(OCCOc2ccc(-c3ccc(OC(=O)C(=C)C)c(OC(=O)C(=C)C)c3)cc2F)cc1]

The obtained liquid crystal display element was irradiated with ultraviolet light in a state where a rectangular alternating electric field was applied, and the polymerizable compound was cured. The liquid crystal display element was irradiated with ultraviolet light at 20 mW for 300 seconds by using UIS-S2511RZ manufactured by Ushio Inc., as an irradiation device, and USH-250BY manufactured by Ushio Inc., as an ultraviolet light lamp, and a liquid crystal display element of Example 16 was obtained. As in Example 13, the liquid crystal display element of Example 16 had pretilt angles, and the pretilt angles were maintained even in a state where the application of alternating electric field was stopped, after curing of the polymerizable compound.

Various properties of the liquid crystal composition used in the liquid crystal display element of Example 16, the VHRs before and after the UV irradiation, the evaluation of the drop marks of the obtained liquid crystal display element, and the evaluation of the burn-in are shown in Table 37 below. As a result, in the liquid crystal composition used in the liquid crystal display element of Example 16, a great decrease in VHR is not observed before and after the UV irradiation. It is considered that this is because that, since the polymerizable compound represented by General Formula (I) is included in the alignment film material, the total energy amount of UV irradiation in a case of polymerizing the polymerizable liquid crystal compound in the alignment film can be kept low, and thus, decomposition of the liquid crystal compounds configuring the liquid crystal composition can be prevented.

TABLE 37

| | Example 16 |
|---|---|
| VHR before UV irradiation (%) | 99.5 |
| VHR after UV irradiation (%) | 99.3 |
| Evaluation of drop marks | A |
| Evaluation of burn-in | A |

### Comparative Example 6

A liquid crystal display element of Comparative Example 6 was obtained in the same manner as in Example 16, except that 100% of UCL-011-K1 (manufactured by DIC Corporation) was used as the vertical alignment film forming material.

The obtained liquid crystal display element was irradiated with ultraviolet light in a state where a rectangular alternating electric field was applied, and the polymerizable compound was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Comparative Example 6 was obtained. The liquid crystal display element was irradiated with ultraviolet light under the same conditions as those in Example 16 (20 mW for 300 seconds) and the pretilt angle was applied, but the curing of the polymerizable liquid crystal compound in the alignment film was insufficient, the pretilt angle was not stably applied, and thus, it was necessary to perform the irradiation at 20 mW for 600 seconds for holding the pretilt angle.

Various properties of the liquid crystal composition used in the liquid crystal display element of Comparative Example 6, the VHRs before and after the UV irradiation, the evaluation of the drop marks of the obtained liquid crystal display element, and the evaluation of the burn-in are shown in Table 38 below. As a result, since polymerizable compound represented by General Formula (I) is not included in the alignment film material of Comparative Example 6, the total energy amount of the UV irradiation for curing the polymerizable liquid crystal compound in the alignment film was increased, and accordingly, a decrease in VHR was observed and a decrease in properties due to the decomposition of the liquid crystal compounds in the liquid crystal composition was confirmed.

TABLE 38

| | Comparative Example 6 |
|---|---|
| VHR before UV irradiation (%) | 99.4 |
| VHR after UV irradiation (%) | 98.3 |
| Evaluation of drop marks | D |
| Evaluation of burn-in | D |

### Example 17

A liquid crystal composition (LC-B3) including compounds shown in the following table was prepared, and the liquid crystal composition was used. An N-methyl-2-pyrrolidone solution containing 3% of a polyimide derivative represented by the following formula and 0.4% of the polymerizable compound represented by Formula (I-29) was used as a vertical alignment film forming material. A liquid crystal display element of Example 17 was obtained under the same conditions as Example 9, except for this.

TABLE 39

| | LC-B3 |
|---|---|
| 3-Cy-Cy-2 | 20 |
| 3-Ph-Ph-1 | 5 |
| 3-Ph-Ph5-01 | 7 |
| 3-Cy-Cy-4 | 7 |
| 3-Ph-Ph-02 | 8 |
| 5-Ph-Ph-1 | 8 |
| 3-Cy-Cy-5 | 2 |
| 3-Cy-Cy-Ph-1 | 10 |
| 2-Cy-Cy-1O-Ph5-O2 | 20 |
| 3-Cy-Cy-1O-Ph5-O2 | 13 |
| Total | 100 |
| Tni [° C.] | 73 |
| Tcn [° C.] | −25 |
| Δn | 0.106 |
| Δε | −3.1 |
| γ₁ [mPa · s] | 120.0 |
| K₃₃ [pN] | 13.2 |
| γ₁/K₃₃ [mPa · s · pN⁻¹] | 9.1 |
| γ₁/Δn² × 10⁻² [mPa · s] | 106 |

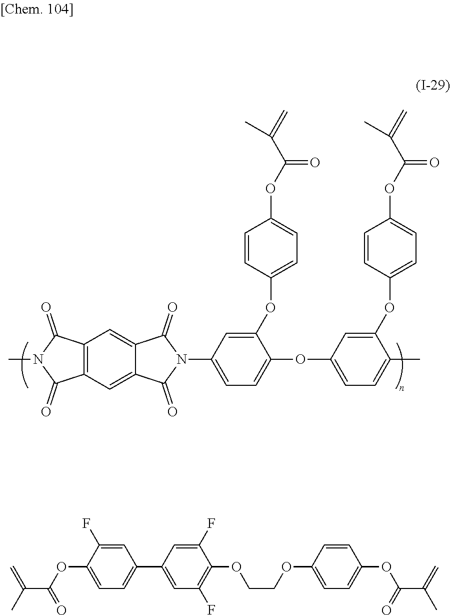

The obtained liquid crystal display element was irradiated with ultraviolet light in a state where a rectangular alternating electric field was applied, and the polymerizable compound having the reactive group was cured. The liquid crystal display element was irradiated with ultraviolet light at 20 mW for 600 seconds by using UIS-S2511RZ manufactured by Ushio Inc., as an irradiation device, and USH-250BY manufactured by Ushio Inc., as an ultraviolet light lamp, and a liquid crystal display element of Example 17 was obtained. As in Example 9, the liquid crystal display element of Example 17 had pretilt angles, and the pretilt angles were maintained even in a state where the application of alternating electric field was stopped, after curing of the polymerizable compound.

Various properties of the liquid crystal composition used in the liquid crystal display element of Example 17, the VHRs before and after the UV irradiation, the evaluation of the drop marks of the obtained liquid crystal display element, and the evaluation of the burn-in are shown in Table 40 below. As a result, in the liquid crystal composition used in the liquid crystal display element of Example 17, a great decrease in VHR is not observed before and after the UV irradiation. It is considered that this is because that, since the polymerizable compound represented by General Formula (I) is included in the alignment film material, the total energy amount, of UV irradiation in a case of polymerizing the polymerizable compound having the polymerizable group in the alignment film can be kept low, and thus, decomposition of the liquid crystal compounds configuring the liquid crystal composition can be prevented.

TABLE 40

| | Example 17 |
|---|---|
| VHR before UV irradiation (%) | 99.8 |
| VHR after UV irradiation (%) | 99.7 |
| Evaluation of drop marks | A |
| Evaluation of burn-in | A |

### Example 18

31 g (100 millimoles) of 4-bromo-2,6-difluoro-(2-tert-butoxyethyloxy) benzene, 24.4 g (110 millimoles) of 4 (2-tetrahyaropyranyloxy) phenylboronic acid, 21 g (150 millimoles) of potassium, carbonate, 1.1 g of tetrakistriphenylphosphine palladium, 400 ml of tetrahydrofuran, and 100 ml of pure water were put into a reaction vessel equipped with a stirrer, a cooler, and a thermometer, and a reaction was allowed at 70° C. for 5 hours. After finishing the reaction, the reactant was cooled, 10% hydrochloric acid was added thereto, and a target material was extracted with ethyl acetate. An organic layer was washed with water and a saturated saline solution and a solvent was distilled. After that, dispersion and washing with toluene were performed and 34 g of a compound represented by Formula (1) was obtained.

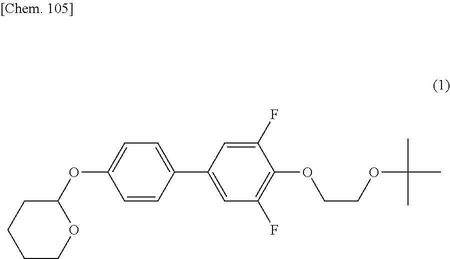 [SMILES: CC(C)(C)OCCOc1c(F)cc(-c2ccc(OC3CCCCO3)cc2)cc1F]

34 g of the compound represented by Formula (1) and 200 ml of THF were put into a reaction vessel equipped with a stirrer and a thermometer, and a mixed solution of 10 ml of a methanol solution and 1 ml of hydrochloric acid was slowly added dropwise. After finishing the dropwise addition, a reaction was further allowed for 2 hours. After finishing the reaction, 300 ml of ethyl acetate was added to the reaction solution, the organic layer was washed, with pure water and a saturated sodium hydrogen carbonate-5% hydrochloric acid solution, and further washed with saturated saline solution, and the organic layer was dried with anhydrous sodium sulfate. The solvent was distilled and 26 g of a compound represented by Formula (2) was obtained.

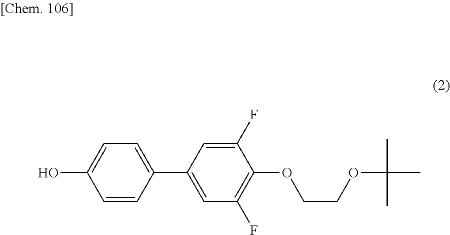 [SMILES: CC(C)(C)OCCOc1c(F)cc(-c2ccc(O)cc2)cc1F]

Then, 25 g (81 millimoles) of the compound represented by Formula (2), 10.5 g of triethylamine, and 150 ml of dichloromethane were put into a reaction vessel equipped with a stirrer, a cooler, and a thermometer, the reaction vessel was held in an ice cooling bath at a temperature equal to or lower than 5° C., and 11.4 g (108 millimoles) of methacrylic acid chloride was slowly added dropwise under the atmosphere of nitrogen gas. After finishing the dropwise addition, the temperature of the reaction vessel was returned to room temperature, and a reaction was allowed for 5 hours. After the reaction solution was filtered, 150 ml of dichloromethane was added to a filtrate, the resultant material was washed with a 5% hydrochloric acid solution and further washed with a saturated saline solution, and the organic layer was dried with anhydrous sodium sulfate. The solvent was distilled, purification was performed with 2-fold amounts (weight ratio) of alumina column, and dispersion and washing with a mixed solution of dichloromethane and methanol were performed, and accordingly, 28 g of a compound represented by Formula (3) was obtained.

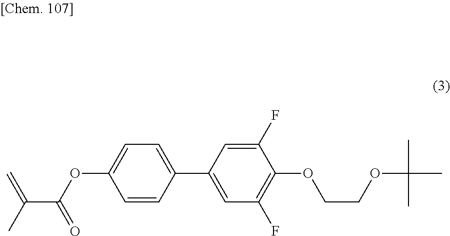 [SMILES: C=C(C)C(=O)Oc1ccc(-c2cc(F)c(OCCOC(C)(C)C)c(F)c2)cc1]

28 g of the compound represented by Formula (3) and 100 ml of dichloromethane were put into a reaction vessel equipped with a stirrer, a cooler, and a thermometer, the reaction vessel was held in an ice cooling bath at a temperature equal to or lower than 5° C., and 30 ml of trifluoroacetic acid was slowly added dropwise. After finishing the dropwise addition, the temperature of the reaction vessel was returned to room temperature, and a reaction was allowed for 1 hours. After finishing the reaction, the reaction solution was cooled at a temperature equal to or lower than 10° C., and 50 ml of pure water was slowly added thereto. Then, 150 ml of dichloromethane was added, the organic layer was washed with pure water and saturated sodium hydrogen carbonate 5% hydrochloric acid solution, and further washed, with saturated saline solution, and the organic layer was dried, with anhydrous sodium sulfate. The solvent was distilled and 21.5 g of a compound represented by Formula (4) was obtained.

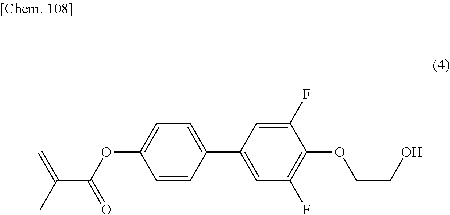 [SMILES: C=C(C)C(=O)Oc1ccc(-c2cc(F)c(OCCO)c(F)c2)cc1]

Then, 21.5 g of the compound represented by Formula (4), 11.5 g (64 millimoles) of 4-methacryloyloxyphenol, 17.0 g (64 millimoles) of triphenylphosphine, and 150 ml of dichloromethane were put into a reaction vessel equipped with a stirrer, a cooler, and a thermometer, and the reaction vessel was cooled at 5° C. After that, 15.6 g (77.2 millimoles) of DIAD was added dropwise. After finishing the dropwise addition, the resultant material was stirred at room temperature for 5 hours and the reaction was finished. After finishing the reaction, 200 ml of dichloromethane was added and the organic layer was washed with pure water and a saturated saline solution. The solvent, was distilled, purification was performed with silica gel column chromatography, and accordingly, 25.5 g of a compound represented by Formula (I-11) was obtained.

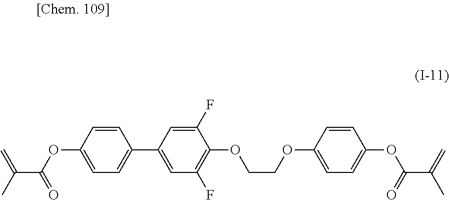 [SMILES: C=C(C)C(=O)Oc1ccc(OCCOc2c(F)cc(-c3ccc(OC(=O)C(=C)C)cc3)cc2F)cc1]

(Values of Physical Properties)

¹H-NMR (solvent: heavy chloroform): δ: 1.98 (s, 3H), 2.01 (s, 3H), 4.23 (t, 2H), 4.45 (t, 2H), 5.68 (m, 2H), 6.28 (m, 2H), 6.86 (m, 2H), 6.97 (m, 2H), 7.06 (m, 2H), 7.13 (m, 2H), 7.44 (m, 2H)

¹³C-NMR (solvent: heavy chloroform): δ: 18.4, 67.6, 72.6, 110.6, 110.8, 115.4, 122.2, 122.4, 127.1, 127.6, 127.8, 134.6, 134.8, 134.8, 135.8, 136.0, 136.1, 136.2, 136.3, 144.8, 150.9, 154.8, 154.9, 156.2, 157.3, 165.8, 166.2

Infrared absorption spectrum (IR) (KBr): 1760, 1652-1622, 809 cm⁻¹

Melting point: 136° C.

### REFERENCE SIGNS LIST

10: liquid crystal display element

11: first substrate

12: second substrate

13: liquid crystal composition layer

14: common electrode

15: pixel electrode

16: vertical alignment film

17: vertical alignment film

18: color filter

19: liquid crystal Molecule

20: polymer layer

21: polymer layer

1-13. (canceled)

14. A liquid crystal display element comprising:
a first substrate;
a second substrate; and
a liquid crystal composition layer sandwiched between the first substrate and the second substrate,
wherein at least one of the first substrate and the second substrate is provided with an electrode,
at least one of the first substrate and the second substrate is provided with as alignment film including a polymer of a compound having a polymerizable group which controls a direction of alignment of a liquid crystal molecule in the liquid crystal composition layer,
a liquid crystal composition constituting the liquid crystal composition layer includes one or more compounds selected from a group of compounds represented by General Formula (N-1), General Formula (N-2), and General Formula (N-3), 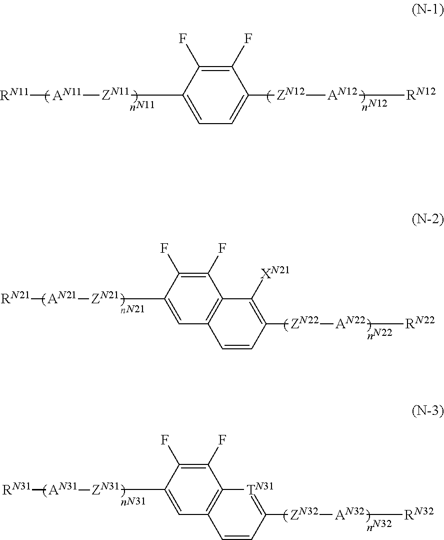
(wherein R^{N11}, R^{N12}, R^{N21}, R^{N22}, R^{N31}, and R^{N32} each independently represent an alkyl group having 1 to 8 carbon atoms, one —CH₂— or two or more —CH₂—'s not adjacent to each other in the alkyl group each may be independently substituted with —CH═CH—, —C≡C—, —O—, —CO—, —COO—, or —OCO—, A^{N11}, A^{N12}, A^{N21}, A^{N22}, A^{N31}, and A^{N32} each independently represent a group selected from the group consisting of (a) a 1,4-cyclohexylene group (wherein one —CH₂— or two or more —CH₂—'s not adjacent to each other present in this group may be substituted with —O—). (b) a 1,4-phenylene group wherein one —CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one —CH═ or two or more —CH═'s not adjacent to each other present in the naphthalene-2,6-diyl group or the 1,2,3,4-tetrahydronaphthalene-2,6-diyl group may be substituted with —N═), the group (a), the group (b), and the group (c) each may be independently substituted with a cyano group, a fluorine atom, or a chlorine atom, Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—, X^{N21} represents a hydrogen atom or a fluorine atom, T^{N31} represents —CH₂— or —O—, n^{N11}, n^{N12}, n^{N21}, n^{N22}, n^{N31}, and n^{N32} each independently represent an integer of 0 to 3, n^{N11}+n^{N12}, n^{N21}+n^{N22}, and n^{N31}+n^{N32} are each independently 1, 2, or 3 and, in a case where a plurality of A^{N11}'s to A^{N32}'s and Z^{N11}'s to Z^{N32}'s are present, these may be the same or different), and
the compound having the polymerizable group includes one or more compounds represented by General Formula (I).
P¹-Sp¹B¹—Z¹ᵣ₁B²—Z²—B³Sp²-P²)ₙ₁ (I)
(wherein P¹ and P² each independently represent a polymerizable functional group, Sp¹ and Sp² each independently represent a single bond or an alkylene group having 1 to 18 carbon atoms, a hydrogen atom in the alkylene group may be substituted with one or more halogen atoms or a CN group, one —CH₂— or two or more —CH₂—'s not adjacent to each other present in the alkylene group each may be independently substituted with —O—, —COO—, —OCO—, or —OCO—O—, P¹-Sp¹ and Sp²-P² do not include a —O—O— group, n1 represents 1, 2 or 3, in a case where a plurality of Sp²'s and P²'s are present, these may be the same or different, B¹, B², and B³ each independently represent a group selected from the group consisting of (a) a 1,4-cyclohexylene group (wherein one —CH₂— or two or more —CH₂—'s not adjacent to each other present in this group may be substituted with —O—), (b) a 1,4-phenylene group (wherein one —CH═ or two or more —CH═'s not adjacent, to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one —CH═ or two or more —CH═'s not adjacent to each other present in the naphthalene-2,6-diyl group or the 1,2,3,4-tetrahydronaphthalene-2,6-diyl group may be substituted with —N═), hydrogen atoms present in the group (a), the group (b), and the group (c) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or Sp²-P², Z¹ and Z² each independently represent —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, —O(CH₂)ₘO—, an alkylene group having 2 to 10 carbon atoms which may include a halogen atom, or a single bond, m represents an integer of 1 to 8, r1 represents 1, 2, or 3, and in a case where a plurality of B¹'s and Z¹'s are present, these may be the same or different, provided that at least one of Sp¹, Sp², Z¹, and Z² represents —O(CH₂)ₘO—.).

15. The liquid crystal display element according to claim 14, which includes a plurality of pixels,
wherein the pixel includes two or more regions having different pretilt angles.

16. The liquid crystal display element according to claim 14,
wherein the first substrate is provided with a common electrode, and
the second substrate is provided with a pixel electrode.

17. The liquid crystal display element according to claim 16,
wherein the alignment film which applies a charge approximately vertically to the first substrate and the second substrate and controls a liquid crystal molecule in the liquid crystal composition layer is provided between the common electrode and the pixel electrode.

18. The liquid crystal display element according to claim 14,
wherein the alignment film includes a polymer which controls the direction of alignment of the liquid crystal molecule in the liquid crystal composition layer or is formed of a cured material of a polymerizable liquid crystal compound.

19. The liquid crystal display element according to claim 18,
wherein the polymer which controls the direction of alignment of the liquid crystal molecule in the liquid crystal composition layer includes a polymer of a compound having a polymerizable group or a polymer of a polymerizable compound having a polyimide skeleton as a main chain and having a cross linking functional group as a side chain.

20. The liquid crystal display element according to claim 14,
wherein a surface of the alignment film further includes a polymer of one or more polymerizable compounds which controls and stabilizes the alignment of the liquid crystal molecule.

21. A method for producing a liquid crystal display element, the method comprising:
applying an alignment material to at least one of a first substrate and a second substrate to form an alignment film material;
then sandwiching a liquid crystal composition between the first substrate and the second substrate, at least one of which is provided with an electrode; and
applying an active energy ray with a voltage being applied to the electrode to polymerize a polymerizable group of a compound having a polymerizable group contained in the alignment film material, so that an alignment film which controls a direction of alignment of a liquid crystal molecule in a layer of the liquid crystal composition is obtained,
wherein the liquid crystal composition includes one or more compounds selected from a group of compounds represented by General Formula (N-1), General Formula (N-2), and General Formula (N-3), 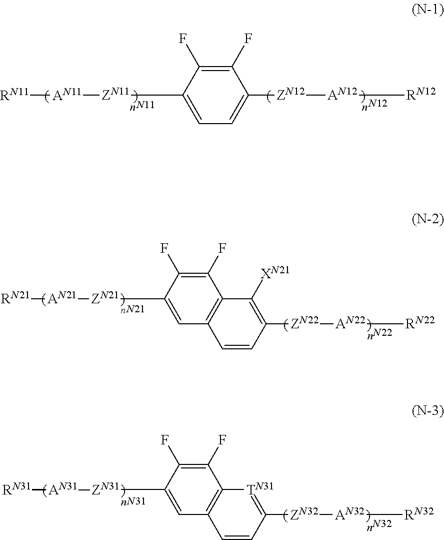
(wherein R^{N11}, R^{N12}, R^{N21}, R^{N22}, R^{N31}, and R^{N32} each independently represent an alkyl group having 1 to 8 carbon atoms, one —CH₂— or two or more —CH₂—'s not adjacent to each other in the alkyl group each may be independently substituted with —CH═CH—, —C≡C—, —O—, —CO—, —COO—, or —OCO—, A^{N11}, A^{N12}, A^{N21}, A^{N22}, A^{N31}, and A^{N32} each independently represent a group selected from the group consisting of (a) a 1,4-cyclohexylene group (wherein one —CH₂— or two or more —CH₂—'s not adjacent to each other present in this group may be substituted with —O—), (b) a 1,4-phenylene group (wherein one —CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one —CH═ or two or more —CH═'s not adjacent to each other present in the naphthalene-2,6-diyl group or the 1,2,3,4-tetrahydronaphthalene-2,6-diyl group may be substituted with —N═), the group (a), the group (b), and the group (c) each may be independently substituted with a cyano group, a fluorine atom, or a chlorine atom, Z^{N11}, Z^{N12}, Z^{N21}, Z^{N22}, Z^{N31}, and Z^{N32} each independently represent a single bond, —CH₂CH₂—, —(CH₂)₄—, —OCH—, —CH₂O—, —COO—, —OCO—, —OCF₂—, —CF₂O—, —CH═N—N═CH—, —CH═CH—, —CF═CF— or —C≡C—, X^{N11} represents a hydrogen atom or a fluorine atom, T^{N31} represents —CH₂— or —O—, n^{N11}, n^{N12}, n^{N21}, n^{N22}, n^{N31}, and n^{N32} each independently represent an integer of 0 to 3, n^{N11}+n^{N12}, n^{N21}+n^{N22}, and n^{N31}+n^{N32} each independently 1, 2, or 3, and, in a case where a plurality of A^{N11}'s to A^{N32}'s and Z^{N11}'s to Z^{N32}'s are present, these may be the same or different), and
the compound having the polymerizable group includes one or more compounds represented by General Formula (I).
P¹-Sp¹B¹—Z¹ᵣ₁B²—Z²—B³Sp²-P²)ₙ₁ (I)
(wherein P¹ and P² each independently represent a polymerizable functional group, Sp¹ and Sp² each independently represent a single bond or an alkylene group having 1 to 18 carbon atoms, a hydrogen atom in the alkylene group may be substituted with one or more halogen atoms or a CN group, one CH₂ group or two or more CH₂ groups not adjacent to each other present in the alkylene group each may be independently substituted with —O—, —COO—, —OCO—, or —OCO—O—, P¹-Sp¹ and Sp²-P² do not include a —O—O— group, n1 represents 1, 2, or 3, in a case where a plurality of Sp²'s and P²'s are present, these may be the same or different, B¹, B², and B³ each independently represent a group selected from the group consisting of (a) a 1,4-cyclohexylene group (wherein one-CH₂— or two or more —CH₂—'s not adjacent to each other present in this group may be substituted with —O—), (b) a 1,4-phenylene group (wherein one-CH═ or two or more —CH═'s not adjacent to each other present in this group may be substituted with —N═), and (c) a naphthalene-2,6-diyl group, a 1,2,3,4-tetrahydronaphthalene-2,6-diyl group, or a decahydronaphthalene-2,6-diyl group (wherein one-CH═ or two or more —CH═'s not adjacent to each other present in the naphthalene-2,6-diyl group or the 1,2,3,4-tetrahydronaphthalene-2,6-diyl group may be substituted with —N═), hydrogen atoms present in the group (a), the group (b), and the group (c) each may be independently substituted with a cyano group, a fluorine atom, a chlorine atom, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or Sp²-P², Z¹ and Z² each independently represent —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, —O(CH₂)ₘO—, an alkylene group having 2 to 10 carbon atoms which may include a halogen atom, or a single bond, m represents an integer of 1 to 8, r1 represents 1, 2, or 3, and in a case where a plurality of B¹'s and Z¹'s are present, these may be the same or different, provided that at least one of Sp¹, Sp², Z¹, and Z² represents —O(CH₂)ₘO—.).

22. The method for producing a liquid crystal display element according to claim 21,
wherein the alignment film material includes a polymer which controls the direction of alignment of the liquid crystal molecule in the liquid crystal composition layer, or the alignment film material is a cured material of a polymerizable liquid crystal compound.

23. The method for producing a liquid crystal display element according to claim 22,
wherein the polymer which controls the direction of alignment of the liquid crystal molecule in the liquid crystal composition layer includes a polymer of a compound having a polymerizable group or a polymer of a polymerizable compound having a polyimide skeleton as a main chain and having a crosslinking functional group as a side chain.

24. The method for producing a liquid crystal display element according to claim 22,
wherein a surface of the alignment film further includes a polymer of one or more polymerizable compounds which controls and stabilizes the alignment of the liquid crystal molecule.

25. The method for producing a liquid crystal display element according to claim 21, wherein the active energy ray is ultraviolet light with an intensity of 2 mW/cm² to 100 mW/cm² and a total irradiation energy amount of 10 J to 300 J.
